(19) United States
(12) Patent Application Publication
(10) Pub. No.: US 2026/0061388 A1
(43) Pub. Date: Mar. 5, 2026

(54) SYSTEM FOR PLASMA DISSOCIATION OF HYDROCARBONS

(71) Applicant: William Patrick Campbell, III, Washington D.C., DC (US)

(72) Inventor: William Patrick Campbell, III, Washington D.C., DC (US)

(21) Appl. No.: 19/317,922

(22) Filed: Sep. 3, 2025

Related U.S. Application Data
(60) Provisional application No. 63/689,910, filed on Sep. 3, 2024.

(51) Int. Cl. B01J 19/08; B01J 19/00; B01J 19/18; C01B 21/06

(52) U.S. Cl. CPC B01J 19/08; B01J 19/0013; B01J 19/18; C01B 21/0622; B01J 2219/085; B01J 2219/0869; B01J 2219/0871; B01J 2219/0875; B01J 2219/0898

(57) ABSTRACT

The system for plasma dissociation of hydrocarbons is a plasma-based system for dissociating a feed gas, such as a hydrocarbon gas, and recombining the components thereof into desired materials. The system for plasma dissociation of hydrocarbons includes a chamber having a plasma inlet and a plasma source for projecting a plasma through the plasma inlet into an interior of the chamber. A rotating member is mounted in the interior of the chamber and the rotating member is driven to rotate by a motor or the like such that the plasma impinges on a surface of the rotating member while the rotating member is rotating to form a solid material. The solid material falls from the rotating member under the force of gravity and/or centrifugal force while it is rotating and is collected on an interior floor surface of the chamber.

### CROSS-REFERENCE TO RELATED APPLICATION

This application claims the benefit of U.S. Provisional Patent Application No. 63/689,910, filed on Sep. 3, 2025.

### BACKGROUND

### Field

The disclosure of the present patent application relates to material synthesis, and particularly to a plasma-based system for dissociating a feed material, such as a hydrocarbon, and recombining the components thereof into desired materials.

### Description of Related Art

Plasma-enhanced chemical vapor deposition (PECVD) is a chemical vapor deposition process used to deposit thin films from a gas state to a solid state on a substrate. Chemical reactions are involved in the process, which occurs after creation of a plasma of the reacting gases. The plasma is typically created by radio frequency (RF) (in the form of alternating current (AC) or direct current (DC)) discharged between two electrodes, the fields emanating from magnetic fields and the ions and electrons are then attracted to the substrates. PECVD also yields some of the fastest deposition rates while maintaining film quality (such as roughness, defects/voids, etc.) when compared with sputter deposition and thermal/electron-beam evaporation, though often at the expense of uniformity.

Although PECVD is common for the creation of thin films, particularly in the field of semiconductors, it is typically not used for the creation of bulk materials (i.e., materials sized outside of the thin film range) or for the creation of new materials on the molecular level. The creation of, for example, bulk carbonaceous materials using a process similar to PECVD requires both energy levels and plasma densities which will be damaging to the deposition chamber, potentially damaging to the substrate on which deposition occurs, costly in terms of energy expenditure, and difficult to control in terms of directionality of the deposited materials. Additionally, PECVD forms films which are tightly bonded to the substrate, thus removal of the deposited material for other use would require an additional ablation process.

It would be desirable to be able to use the gas dissociation and recombination (i.e., “solidification”) of the feed material from PECVD, but for creation of new materials, such as bulk carbonaceous materials, new desired materials, and the like. Thus, a system for plasma dissociation of hydrocarbons solving the aforementioned problems is desired.

### SUMMARY

The system for plasma dissociation of hydrocarbons is a plasma-based system for dissociating a feed source, such as a hydrocarbon containing material or gas, and with the capability of also recombining the introduced components thereof into desired materials. The system for plasma dissociation of hydrocarbons includes a chamber having a plasma inlet and a plasma source for projecting a plasma through the plasma inlet into an interior of the chamber. A rotating member is mounted in the interior of the chamber and is driven to rotate by a motor or the like, such that the plasma impinges on a surface of the member to form a solid material. The condensed solid material then falls from the rotating member under the force of gravity and/or centrifugal force due to the rotation and is collected on an interior floor surface of the chamber. A majority of the solid material may also be deterred from laminating onto the moving surface due to the rapid cooling effect created by the rotation's continued presentation of renewing cooling surfaces.

As a non-limiting example, the plasma may be formed from a hydrocarbon gas, resulting in the solid material being a carbon-containing material. An additional source of a carrier gas, such as an inert gas, for example, may also be in communication with the plasma source such that the carrier gas mixes with the hydrocarbon gas. The chamber may have a gas outlet formed there for retrieval of gaseous products following formation of the solid material condensed from the plasma.

Additionally, the rotating member may be hollow and may be coupled to at least one hollow axle, which directly drives rotation of the rotating member. At least one hollow axle may be in fluid communication with an interior of the rotating member such that a heat exchange fluid selectively flows through the at least one hollow axle and the rotating member, thus cooling the surface of the rotating member upon which the solid material then forms.

In an alternative embodiment, the rotating member of the previous embodiment is replaced by first and second rotating members mounted in the interior of the chamber such that the plasma is projected in a region between respective surfaces of the first and second rotating members. The first and second rotating members are spaced apart from one another along a first direction and the plasma is projected there between along a second direction which is perpendicular to the first direction. A magnetic field is generated in the region between the respective surfaces of the first and second rotating members, such that the magnetic field is aligned along a third direction which is perpendicular to the first and second directions. The first and second rotating members are driven to rotate by motors or the like and, under the influence of the magnetic field, positive ions of the plasma impinge on the surface of the first rotating member to form the solid material, while electrons of the plasma impinge on the surface of the second rotating member which provides for an electrical recovery while producing a further rapid cooling effect on the plasma with improved protection for the exposed surfaces. Similar to the previous embodiment, the solid material falls from the first rotating member while it is rotating and is collected on an interior floor surface of the chamber; however, a potential difference is also created between the first and second rotating members. Thus, the first and second rotating members may each be electrically connected to an electrical load to generate an electrical current which may be used to power the load and/or for energy recovery. Alternatively, or in addition to the above process, by applying an electric current across the intervening plasma, the speed and energy potential of the plasma is increased, allowing for more energetic reactions to occur.

The present disclosure may also relate to a method of removing carbon from a working gas or materials using the described system. The method may include closing all valves of the chamber; turning on a vacuum pump and opening a valve to the vacuum pump to begin evacuation of the chamber; closing the valve to the vacuum pump after the chamber is fully evacuated; adding a first material into the chamber of the system; energizing the motor to spin the rotating member; energizing the plasma inlet; adding working gases into the plasma inlet using a mixing valve; generating high temperature plasma from the working gases; contacting the rotating member with the high temperature plasma, wherein the high temperature plasma is cooled on impact with the rotating member; and obtaining a solid and a gas, wherein the solid falls to a bottom of the chamber and the gas rises to the top of the chamber.

Still another embodiment may relate to a method of manufacturing iron nitride using the systems described herein. The method may include closing all valves of the chamber; turning on the vacuum pump and opening a valve to the vacuum pump to begin evacuation of the chamber; closing the valve to the vacuum pump after the chamber is fully evacuated; adding a feed gas or materials into the chamber of the system; energizing the motors of each of the first rotating member and second rotating member to spin the first and second rotating members; generating a magnetic field between each of the first rotating member and the second rotating member; energizing the plasma inlet; adding working gases into the plasma inlet using a mixing valve; generating high temperature plasma from the working gases; contacting the first rotating member with the high temperature plasma, wherein the high temperature plasma is cooled on impact with the first rotating member; and obtaining a solid and a gas, wherein the solid falls to a bottom of the chamber and the gas rises to the top of the chamber.

These and other features of the present subject matter will become readily apparent upon further review of the following specification.

### BRIEF DESCRIPTION OF DRAWINGS

FIG. 1 diagrammatically illustrates a system for plasma dissociation of hydrocarbons, comprising a plasma source and a single rotating surface.

FIG. 2A diagrammatically illustrates an alternative embodiment of the system for plasma dissociation of hydrocarbons comprising of rotating systems with magnet assemblies for the recovery of electrical energy.

FIG. 2B diagrammatically illustrates another alternative embodiment of the system for plasma dissociation of hydrocarbons consisting of two rotating surfaces with magnetic means embedded in the rotating surfaces for the generation of electrical energy for a plasma source.

FIG. 3 diagrammatically illustrates another alternative embodiment of the system for plasma dissociation of hydrocarbons consisting of two rotating members with electrode flanges utilizing interior magnetic assemblies for the recovery of electrical energy from a plasma source while being motion stimulated by linear actuators.

FIG. 4 diagrammatically illustrates another alternative embodiment of the system for plasma dissociation of hydrocarbons presented at a different angle than FIG. 3.

FIG. 5 diagrammatically illustrates another alternative embodiment of the system for plasma dissociation of hydrocarbons consisting of the linear actuator rotating means and chamber assembly.

FIG. 6 diagrammatically illustrates another alternative embodiment of the system for plasma dissociation of hydrocarbons consisting of a method of recovering atomic hydrogen and other atomic species.

FIG. 7 diagrammatically illustrates another alternative embodiment of the system for plasma dissociation of hydrocarbons consisting of a tunable microwave waveguide.

FIG. 8 diagrammatically illustrates another alternative embodiment of the system for plasma dissociation of hydrocarbons consisting of a system that can use bulk powdered materials and can form new compounds and alloys.

FIG. 9A diagrammatically illustrates another alternative embodiment of the system for plasma dissociation of hydrocarbons consisting of a single rotating device capable of generating electrical energy from a plasma source with internal magnetic assemblies.

FIG. 9B diagrammatically illustrates another alternative embodiment of the system for plasma dissociation of hydrocarbons consisting of a single rotating device with exterior magnets for the generation of electrical energy from a plasma source.

FIG. 10 diagrammatically illustrates another alternative embodiment of the system for plasma dissociation of hydrocarbons consisting of multiple FIG. 9A structures configured for the protection of chamber walls while providing means for electrical extraction.

FIG. 11 diagrammatically illustrates another alternative embodiment of the system for plasma dissociation of hydrocarbons, a device similar in function to FIG. 10 but with the ability to beam energy through the gaps between the rotating surfaces to an object in the center of the chamber.

FIG. 12A diagrammatically illustrates another alternative embodiment of the system for plasma dissociation of hydrocarbons consisting of multiple rotating devices which can be configured to form an undulator assembly while providing alternative means to intensify a transiting plasma or extracting energy from it.

FIG. 12B diagrammatically illustrates another alternative embodiment of the system for plasma dissociation of hydrocarbons consisting of two or more rotating means as described with parabolic energy focusing impressions on the surface of the rotating means for the intensification of energy at the focal point of the plasma stream.

FIG. 12C diagrammatically illustrates another alternative embodiment of the system for plasma dissociation of hydrocarbons consisting of a system where additional energies can be beamed into the center of the rotating means adding additional energy to a focal point in the plasma.

FIG. 13 consists of a multistage harmonic plasma intensification system.

FIG. 14A diagrammatically illustrates another alternative embodiment of the system for plasma dissociation of hydrocarbons consisting of two plasma generators connected to two inductive intensifiers introducing plasma into a common recovery chamber assembly and optionally including undulator assemblies.

FIG. 14B diagrammatically illustrates another alternative embodiment of the system for plasma dissociation of hydrocarbons consisting of the rotating systems arranged in a column of multiple rotating recovery units for the recovery of larger amounts of energy or protection of the chamber wall.

FIG. 14C diagrammatically illustrates another alternative embodiment of the system for plasma dissociation of hydrocarbons consisting of two opposing laser enhanced systems that can produce the Wakefield effect.

FIG. 14D diagrammatically illustrates another alternative embodiment of the system for plasma dissociation of hydrocarbons capable of producing an electron, proton X-ray output.

FIG. 15A diagrammatically illustrates a rocket engine, utilizing the rotating means to form the rocket through disassembly while providing means of increasing the speed of the plasma or removing energy from it.

FIG. 15A (cont.) diagrammatically illustrates an alternative embodiment of the rocket engine that uses an inductively coupled amplifier prior to rotating throat assembly.

FIG. 15B illustrates a rocket engine design using a plasma system and a rotating means to form the throat assembly exiting into a nozzle assembly protected by the motion of transducers.

FIG. 16 diagrammatically illustrates an aerospike rocket engine consisting of plasma generators utilizing the rotating throat assembly.

FIG. 17 diagrammatically illustrates an alternative embodiment of the system for plasma dissociation of hydrocarbons consisting of linear moving surfaces forming the electrodes and magnetic areas of a MHD device.

FIG. 18 diagrammatically illustrates the system for plasma dissociation of hydrocarbons of FIG. 17.

FIG. 19 diagrammatically illustrates another alternative embodiment of the system for plasma dissociation of hydrocarbons which protects its surfaces through motion provided by transducers.

FIG. 20 diagrammatically illustrates the system for plasma dissociation of hydrocarbons of FIG. 19.

FIG. 21 diagrammatically illustrates an alternative embodiment of the system for plasma dissociation of hydrocarbons consisting of plasma generators being accelerated by a laser producing a Wakefield effect output into an inductively coupled chamber.

FIG. 22A diagrammatically illustrates another alternative embodiment of the system for plasma dissociation of hydrocarbons consisting of two Wakefield generating assemblies producing high energy collisions in the center of a chamber.

FIG. 22B diagrammatically illustrates another alternative embodiment of the system for plasma dissociation of hydrocarbons consisting of rotating magnets and an open electrode structure permitting larger electrode surface area.

FIG. 22C diagrammatically illustrates another alternative embodiment of the system for plasma dissociation of hydrocarbons consisting of a round spiraled chamber protected by rotating surfaces feeding the plasma into a central turbine.

FIG. 22D diagrammatically illustrates another alternative embodiment of the system for plasma dissociation of hydrocarbons consisting of the electrode means previously mentioned being used to protectively line the interior walls of a chamber.

FIG. 22E diagrammatically illustrates another alternative embodiment of the system for plasma dissociation of hydrocarbons showing a detailed view of the system of FIG. 22B.

FIG. 23 is an electron microscope image of carbonaceous material produced by the system for plasma dissociation of hydrocarbons which forms tubular structures.

FIG. 24 is an electron microscope image of carbonaceous material produced by the system for plasma dissociation of hydrocarbons

FIG. 25 is an electron microscope image of carbonaceous material produced by the system for plasma dissociation of hydrocarbons forming tape-like structures.

FIG. 26 is an electron microscope image of carbonaceous material produced by the system for plasma dissociation of hydrocarbons showing spherical and hexagonal carbon structures.

FIG. 27 is an electron microscope image of carbonaceous material produced by the system for plasma dissociation of hydrocarbons showing crystalline carbon output in the form of diamonds.

FIG. 28 is an electron microscope image of carbonaceous material produced by the system for plasma dissociation of hydrocarbons showing another type of tubular carbon output.

FIG. 29 is an electron microscope image of carbonaceous material produced by the system for plasma dissociation of hydrocarbons showing a carbon form consisting of multiple hollow structures.

FIG. 30 is an electron microscope image of carbonaceous material produced by the system for plasma dissociation of hydrocarbons showing roughly hexagonally shaped carbon materials.

FIG. 31A is an electron microscope image of carbonaceous material produced by the system for plasma dissociation of hydrocarbons.

FIG. 31B illustrates an iron nitride magnetic material in a spherical configuration.

FIG. 32 is a side view in section of a rotating magnetohydrodynamic generator with sacrificial assemblies.

FIG. 33 is a top view of the rotating magnetohydrodynamic generator of FIG. 32.

FIG. 34A illustrates an alternative embodiment providing improvements in turbo jet and turbine engines.

FIG. 34B further illustrates the embodiment of FIG. 34A.

FIG. 35 further illustrates the embodiment of FIG. 34A.

FIG. 36 is a further embodiment of the system described herein where a method of inducing gases and other materials into a molecular or alloy mixture may be performed in the plasma arc created between the rotating beans and conductive materials supplied in a wire.

FIG. 37 further illustrates the embodiment of FIG. 36 wherein a position of the contact area of the plasma may be changed.

FIG. 38 further illustrates the embodiment of FIG. 36 using a wire-feed direct arc device where electrical recovery can be created or the intensification of the plasma state.

Similar reference characters denote corresponding features consistently throughout the attached drawings.

### DETAILED DESCRIPTION

The following definitions are provided for the purpose of understanding the present subject matter and for construing the appended patent claims.

### Definitions

Throughout the application, where compositions are described as having, including, or comprising specific components, or where processes are described as having, including, or comprising specific process steps, it is contemplated that compositions of the present teachings can also consist essentially of, or consist of, the recited components, and that the processes of the present teachings can also consist essentially of, or consist of, the recited process steps.

It is noted that, as used in this specification and the appended claims, the singular forms “a”, “an”, and “the” include plural references unless the context clearly dictates otherwise.

In the application, where an element or component is said to be included in and/or selected from a list of recited elements or components, it should be understood that the element or component can be any one of the recited elements or components, or the element or component can be selected from a group consisting of two or more of the recited elements or components. Further, it should be understood that elements and/or features of a composition or a method described herein can be combined in a variety of ways without departing from the spirit and scope of the present teachings, whether explicit or implicit herein.

The use of the terms “include,” “includes”, “including,” “have,” “has,” or “having” should be generally understood as open-ended and non-limiting unless specifically stated otherwise.

The use of the singular herein includes the plural (and vice versa) unless specifically stated otherwise. In addition, where the use of the term “about” is before a quantitative value, the present teachings also include the specific quantitative value itself, unless specifically stated otherwise. As used herein, the term “about” refers to a ±10% variation from the nominal value unless otherwise indicated or inferred.

The term “optional” or “optionally” means that the subsequently described event or circumstance may or may not occur, and that the description includes instances where said event or circumstance occurs and instances in which it does not. For example, “optionally substituted alkyl” means either “alkyl” or “substituted alkyl,” as defined herein.

Unless defined otherwise, all technical and scientific terms used herein have the same meaning as commonly understood to one of ordinary skill in the art to which the presently described subject matter pertains.

Where a range of values is provided, for example, concentration ranges, percentage ranges, or ratio ranges, it is understood that each intervening value, to the tenth of the unit of the lower limit, unless the context clearly dictates otherwise, between the upper and lower limit of that range and any other stated or intervening value in that stated range, is encompassed within the described subject matter. The upper and lower limits of these smaller ranges may independently be included in the smaller ranges, and such embodiments are also encompassed within the described subject matter, subject to any specifically excluded limit in the stated range. Where the stated range includes one or both of the limits, ranges excluding either or both of those included limits are also included in the described subject matter.

Throughout the application, descriptions of various embodiments use “comprising” language. However, it will be understood by one of skill in the art, that in some specific instances, an embodiment can alternatively be described using the language “consisting essentially of” or “consisting of”.

For purposes of better understanding the present teachings and in no way limiting the scope of the teachings, unless otherwise indicated, all numbers expressing quantities, percentages or proportions, and other numerical values used in the specification and claims, are to be understood as being modified in all instances by the term “about”. Accordingly, unless indicated to the contrary, the numerical parameters set forth in the following specification and attached claims are approximations that may vary depending upon the desired properties sought to be obtained. At the very least, each numerical parameter should at least be construed in light of the number of reported significant digits and by applying ordinary rounding techniques.

The present subject matter relates to a system for plasma dissociation of hydrocarbons. The system is a plasma-based system for dissociating a feed gas, solid or liquid, which could be combined with other metals or elements, such as by way of non-limiting example a hydrocarbon source or gas, and recombining the components thereof into desired materials.

The system for plasma dissociation of hydrocarbons includes a chamber having a plasma inlet and a plasma source for projecting a plasma through the plasma inlet into an interior of the chamber. In other embodiments, a rotating member may be mounted in the interior of the chamber and the rotating member may be driven to rotate by a motor or the like such that the plasma impinges on a surface of the rotational member while the rotating member is providing a surface in motion on which condenses a desired solid output material. The solid material may fall from the rotating member under the force of gravity and/or centrifugal force while it is in motion and may be collected on an interior floor surface of the chamber. A majority of the solid material may also be deterred from laminating onto the moving surface due to the rapid cooling effect created by the rotation. Another method discussed herein is the use of magnetohydrodynamic power generation which may remove energy from the plasma without the plasma necessarily coming into contact with the rotating elements.

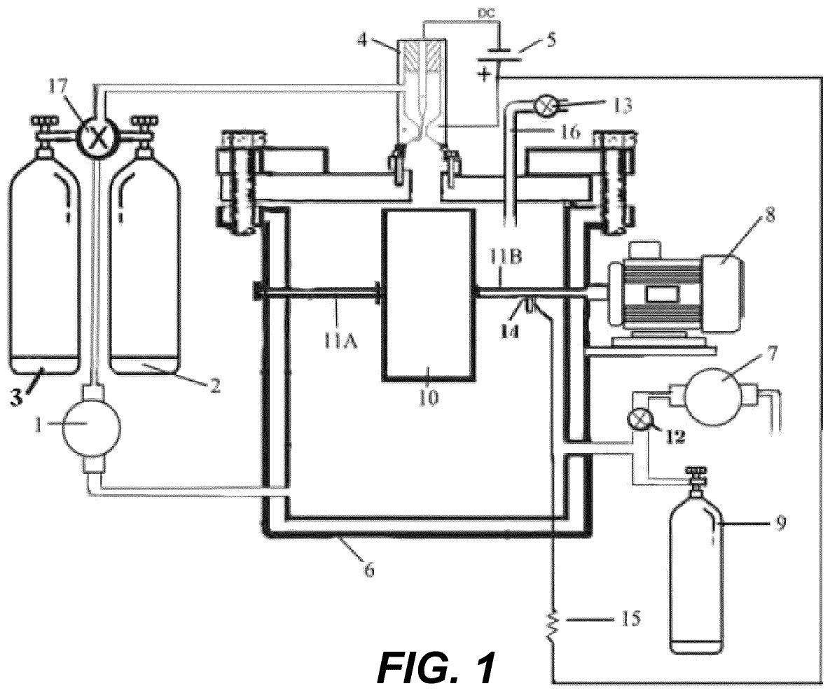

In operation, the system shown in FIG. 1 is started by first closing all valves to chamber 6. Vacuum pump 7 is turned on and valve 12 is opened to begin evacuation of chamber 6. When chamber 6 is fully evacuated, valve 12 is closed and a gas, such as, by way of non-limiting example, an inert gas (e.g., argon or nitrogen) or, alternatively, a reactive gas, such as hydrogen, is introduced into chamber 6 from tank 9. Chamber 6 can also remain in a semi-evacuated state, lower than atmospheric pressure or, alternatively, in a higher-pressure state, greater than atmospheric pressure, depending upon the desired output. The device can also entrain gases and other elements in the output material, which typically can be enhanced by an increase of pressure in chamber 6.

Alternatively, it is also possible to perform these operations with atmospheric air, primarily consisting of nitrogen and oxygen. However, this can potentially introduce contaminants into the discharge and would require better controls to prevent unplanned combustion events if hydrogen-containing feed stocks are used.

When motor 8 is energized, it starts the spinning of cylinder 10. The plasma torch can be either a transferred or non-transferred plasma torch 4 or can be any method or device used for producing a plasma output.

The illustrated plasma torch 4 may then be energized, generating an electric arc. The working gases can then be introduced via mixing valve 17. Should a hydrocarbon base gas, such as methane, be introduced to the plasma torch assembly, an inert carrier gas is often desirable to blend with the base gas to prevent the arc of a transferred or non-transferred plasma torch 4 from potentially shutting down during its dissociation due to the additional energy requirement of molecular dissociation, thus preventing evolution into the plasma state. This may also be remedied through an increase in power level or through the introduction of another gas such as nitrogen. It should be understood that the device will function with any method that can convert matter or a gas into a plasma state, as well. It should be further understood that additional energy, such as electrical energy radio frequency (RF) energy, microwave energy, laser energy, inductive heating or the like may be used to compensate for energy losses encountered during the plasma conversion process and allow these elements/gases to be converted into plasma.

Tank 3, as a non-limiting example, may contain a carbon-based gas, such as methane (CH₄), and tank 2 may contain a variety of gases such as, by way of non-limiting example, an inert gas, such as argon, nitrogen, gases containing phosphorus, phosphine (PH₃), and boron diborane (B₂H₆). When these gases are introduced to plasma torch 4, high temperature plasma is generated and as the plasma stream extends out, it contacts the rotating cylinder 10. The rotation of cylinder 10, under the power of motor 8, provides a constantly renewing thermally recovering contact surface area which protects the surface while also allowing the plasma to become rapidly super cooled. This results in additional protection from thermal and neutral particle damage. If a hydrocarbon is used in the process, the plasma torch 4 dissociates the hydrocarbon into carbon and hydrogen gas. The resulting solid carbon will fall to the bottom of chamber 6 and the hydrogen gas will rise to the top of chamber 6 and exit through tube 16 when valve 13 is opened. If it is desired to introduce a doping agent which would then become incorporated into the resulting carbon output, for either a positive or negative characteristic, then either of the boron or phosphorus containing gases can be metered in at this time along with a carbon containing gas or material.

Rotating cylinder 10 can be made of either a solid conductive metal material such as copper, or other heat conductive materials such as diamond which can be hollow. Additionally, although rotating cylinder 10 is shown as having a cylindrical shape, it should be understood that spherical, conical or planar members can also be used. A hollow rotating cylinder allows for active cooling by allowing a fluid to enter and exit the hollow interior thereof (i.e., the interior cavity of the hollow rotating cylinder), permitting the recovery of useful heat from the impinging plasma.

The cooling substance, either a gas or liquid at either room temperature, elevated temperature above room temperature or in the cryogenic region is introduced through tube 11A and exits via tube 11B. Plumbing for this operation has been omitted for clarity, but is well known to those skilled in the art. Similarly, a heat exchanger for making use of the heat extracted from the coolant exiting the rotating cylinder 10 through tube 11B has been omitted for purposes of illustration and clarity, but it should be understood that any suitable type of heat exchanger may be used. As shown in FIG. 1, tubes 11A and 11B may form the axle for rotating cylinder 10. Tubes 11A, 11B may be hollow pipes or the like, with tube 11A being driven directly by motor 8. Thus, tubes 11A, 11B form a hollow axle upon which rotating cylinder 10 is not only mounted, but whose interior passages are also in open communication with the interior of rotating cylinder 10, permitting a cooling fluid to be introduced for recovering heat from rotating cylinder 10.

During operation, some of the gas or other materials injected into the plasma stream will not be completely broken down. Compressor 1 removes cooler, heavier and/or unreacted gases from either the bottom of chamber 6 or elsewhere in the chamber depending upon the nature of the particular gases and recirculates these gases through mixing valve 17 back into the plasma torch 4 where, along with new feed stock, unreacted gases can be reintroduced to the plasma torch 4 and reprocessed.

Electrical contact brush 14 contacts and rides on the electric conducting pipe 11A or 11B, removing electrical energy absorbed by the rotating cylinder 10 from the impinging plasma which allows it to do useful work through load 15. This energy is recovered by power supply 5. Electrical power, otherwise known as grounding, can be conveyed via a magnetic coil which, with no physical contact, can make use of magnetic induction to produce electrical energy. This allows electricity to be conveyed across a non-contact gap rather than through the use of brushes. Either technique may be applied to any of the devices described herein. A transferred plasma torch, as a non-limiting example, often initially establishes an arc internally between its cathode and anode in the initial configuration of a non-transferred type torch.

Once the conductive plasma has been established, the power supply circuit then connects between the work piece (i.e., the rotating cylinder 10) which could, for example, be positively charged and the torch's plasma output would have a net negative charge. It is to be understood that the plasma could alternatively be generated by a non-transferred plasma torch or any other suitable source of plasma. It should be further understood that the system shown in FIG. 1 may operate within the confines of a vacuum chamber or otherwise fluid-tight chamber to prevent loss of plasma, interactions of the generated gases or materials with the atmosphere, in particular oxygen, and loss into the environment.

The system of FIG. 1 may be used in a method of removing carbon from a material as described above. The method may include closing all valves of the chamber. The method may then include turning on a vacuum pump connected to the chamber and opening a valve to the vacuum pump to begin evacuation of the chamber. The method may further include closing the valve to the vacuum pump after the chamber is fully evacuated and adding a feed gas, or other materials in other states such as solid or liquid into the chamber of the system. The method may then include energizing the motor to spin the rotating member and energizing the plasma inlet. The method may then include adding the material into the plasma inlet using a mixing valve and generating high temperature plasma state from the materials. The method may further include contacting the rotating member with the high temperature plasma. The high temperature plasma may be cooled on impact with the rotating member. The method then includes obtaining a solid and a gas. The solid may fall to a bottom of the chamber and the gas may rise to the top of the chamber.

In some embodiments, the method may further include combining carbon with additional materials. By non-limiting example, the additional materials may be selected from a group consisting of metals, elements, hydrocarbons, gas, and combinations thereof.

In still other embodiments, the gas may be selected from a group consisting of an inert gas, a reactive gas, and combinations thereof. In various embodiments, the inert gas may be elemental gas and the reactive gas may be elemental.

In other embodiments, the inert gas may be selected from a group consisting of argon, nitrogen, and a combination thereof. In additional embodiments, any inert gas may be used.

In various embodiments, the reactive gas may be hydrogen or a hydrocarbon.

In some embodiments, the gas may be ammonia.

In addition, to the dissociation of hydrocarbons, as described above, the system shown in FIG. 1 can also be used to produce desired products, such as, by way of non-limiting example, ammonia. As another example, various forms of iron nitride and numerous other chemicals may be manufactured through plasma chemical synthesis (PCS). As a non-limiting example, to produce ammonia, vacuum pump 7 again evacuates pressure chamber 6. Once evacuated, chamber 6 is pressurized with ammonia gas. In other embodiments, the chamber may be pressurized with, by way of non-limiting example, hydrogen, nitrogen or any combination thereof from cylinder 9 at a pressure between 0.1 MPa and 100 MPa.

As a further non-limiting example, gas tank 2 may contain nitrogen and gas tank 3 may contain hydrogen. According to this example, mixing valve 17 can be adjusted to release a mass mixture ratio of 14 mass units of nitrogen and 3 mass units of hydrogen. This is the molecular 14:3 mass ratio of ammonia NH₃. This gas mixture is then delivered to plasma torch 4 which, as a non-limiting example, may be a non-transferred (or transferred) electric plasma arc, but could be any type of plasma torch or plasma generator.

Once the rotating plasma cooling means is set in motion by motor 8, the plasma torch 4 is energized by power supply 5. The plasma, consisting of ionized nitrogen, a hydrocarbon, hydrogen, dopant gases, materials containing phosphorus, boron, or any combination thereof, stripped of electrons emerges into chamber 6, where it immediately comes into contact with rotating cylinder 10. The rotating cylinder 10 rapidly quenches the plasma, rapidly cooling it, which, in addition to a potentially elevated pressure in chamber 6, creates an environment favoring the formation of many compounds and alloys including doped carbon materials, such as by way of non-limiting example, diamonds, carbon nanotubes, and/or graphene which could play a role in semiconductor devices. Molecular ammonia has also been produced, along with, potentially, numerous other chemicals and alloys.

Cooling fluids may enter the cavity in the interior of the rotating cylinder 10 through tubes 11A and 11B, removing recoverable useful heat energy from the impacting plasma stream. Among the many materials and compounds this process can potentially produce, ammonia gas may be formed from hydrogen and nitrogen in the condensing plasma stream. Elemental hydrogen or hydrogen derived from a hydrocarbon source such as, by way of non-limiting example, methane, may be used. In this non-limiting example, at the elevated pressure present in the chamber, molecular formation of ammonia is facilitated which condenses into liquid. Ammonia gas turns into a liquid at 125 psi (862 kPa) at room temperature. At higher temperatures, higher pressures are needed to liquefy ammonia, with examples including around 7.5 bar at 20° C. and 10 bar at 25° C. The liquid ammonia can be collected from the bottom of the chamber with unreacted hydrogen and nitrogen exiting the top of the chamber through tube 16, where it can be recycled. This process for producing ammonia may allow for recoverable thermal energy and does not produce any carbon dioxide.

Further, when using a transferred plasma torch with a negative charge bias attracted to the positive charge of the rotating cylinder 10, this may further allow electrical energy to be recovered through electrical brush 14, permitting useful work to be done through load 15 which could be used to modulate the plasma. Electrical energy recovery also results in a substantial increase in the rate of the thermal cooling effect of the impinging plasma, which leads to overall greater efficiency and enhanced recovery of the ammonia product, as well as maintaining environmental temperatures within a safe range. Additionally, the produced hydrogen can be collected and used for other purposes, such as in hydrogen fuel cells, for the production of electrical energy, water, etc. Finally, a load could be used to provide additional control over the plasma energy state. It is to be understood that any of the other devices shown herein which utilize a magnetohydrodynamic effect would promote cooling and energy recovery and be able to function as a method of producing ammonia gas.

In addition to ammonia gas and many other chemical materials that this plasma-based process is capable of forming are carbon-based materials of considerable interest in the electronics industry, amongst these are diamonds doped with either phosphorus or boron to create PN junctions. Diamonds, created using the systems and methods described herein, could have significant characteristic advantages over silicon, such as for example greater heat tolerance reducing the need of cooling and allowing for the recoverable higher temperature heat to perform useful work while also having potentially faster operational speeds. Current methods have experienced difficulty in adding the necessary dopants to the materials. The presently disclosed devices provide a method of easy incorporation of dopants, as well as for large-scale production of these crystalline carbon materials. Phosphorus in particular has been difficult to incorporate into the diamond crystal lattice.

Phosphorus can be introduced into the diamond lattice during its growth traditionally via the chemical vapor deposition (CVD) process. While the CVD process is well understood and workable with traditional silicone base semiconductors, it has not to date proven to be an effective method for the production of diamond semiconductors and can introduce defects when trying to insert phosphorus atoms. Plasma based devices and processes described herein can, by adding phosphine gas or other phosphorus containing sources to hydrocarbons, methane, or other gases including hydrogen in a mixture, in a manner that allows them to be introduced and incorporated as precursors during the plasma condensing and crystalline formation process relieve carbon lattice stresses while also increasing electron mobility.

The phosphorus atoms may more easily be integrated during processes and substitute for some of the carbon atoms, creating an n-type semiconductor diamond crystalline material using the systems and methods described herein. Previously, this has been a significant challenge, due to the large size of the phosphorus atom compared to the carbon atom. Carbon and elemental phosphorus or phosphine (PH₃), elemental boron, or diborane (B₂H₆) gas can be introduced and energized into a plasma state as described herein. This plasma state may then immediately be thermally quenched back into a solid state with the different materials incorporated with variable parameter adjustments surprisingly allowing for a more crystalline state or amorphous state to be favored. In an embodiment, the present methods and systems appear to form the crystalline state in the presence of phosphorous, potentially allowing for easier integration and fewer defects being generated. Amorphous or polycrystalline carbon, which these devices can produce in abundance, is also of interest with regards to semiconductors.

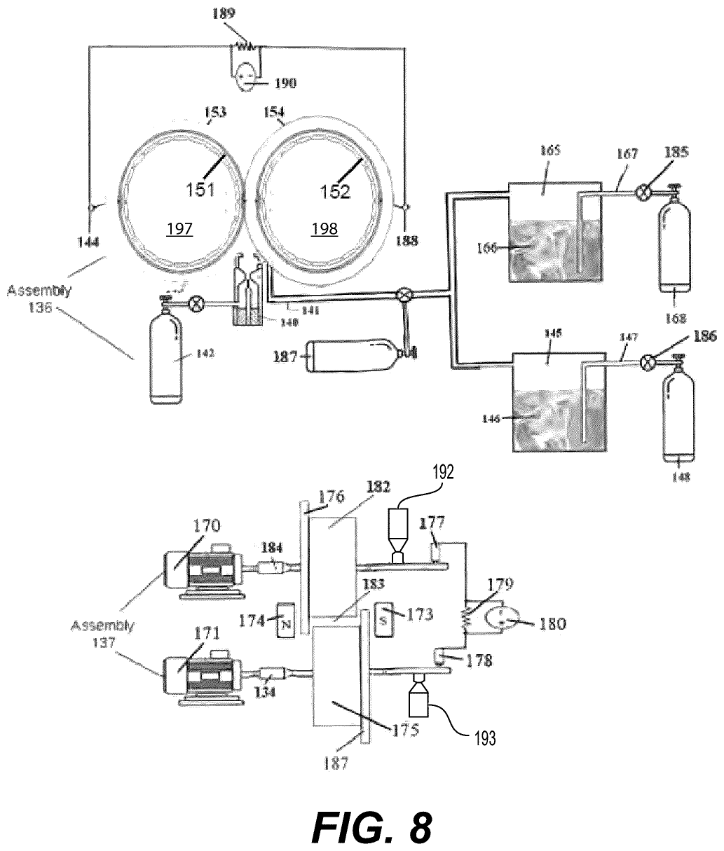

The device shown in FIG. 8 describes a method where these elements may be introduced into the plasma in a powdered elemental form. Other described devices can introduce the gaseous form of these elements from their corresponding gas inlets either individually or blended with other gases. Through these methods, either phosphorus or boron can be incorporated at precisely controlled ratios into the diamond lattice efficiently and in large quantities.

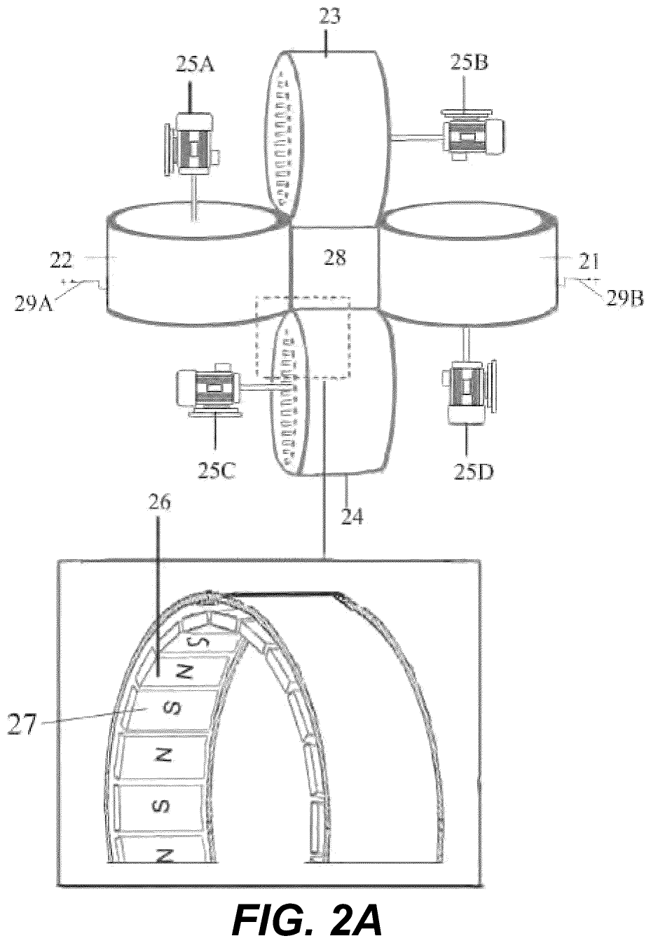

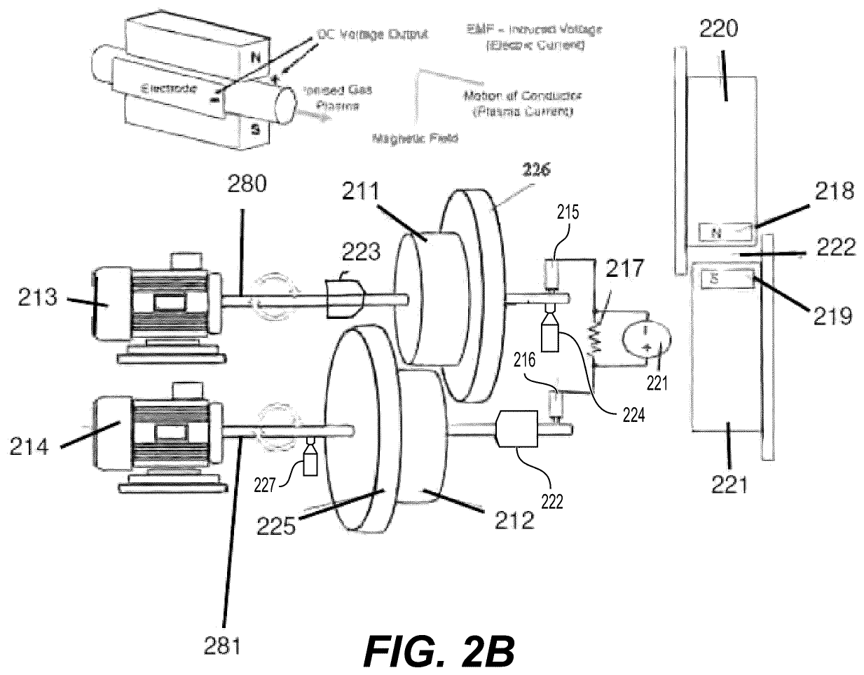

The device shown in FIG. 2A may be used to capture otherwise lost electrical energy from the condensing plasma. In this configuration, plasma from torch 4 (omitted for clarity) is directed between four rotating cylinders 21, 22, 23 and 24. During operation, motors 25A, 25B, 25C and 25D rotate the cylinders 21, 22, 23 and 24, respectively, in a synchronous aligned manner. It is further contemplated that the magnetic attraction between the moving elements may reduce the need for the number of motors involved. In operation, plasma enters the opening 28 between the four rotating cylinders 21, 22, 23 and 24. As shown in the inset of FIG. 2A, the inner surface of each of the cylinders 23, 24 has magnets of alternating polarities mounted thereon. The ionic plasma energy is deflected by the opposing magnetic fields of magnets 26, 27 towards rotating electrodes 21 and 22. The magnets 26, 27 which line the inner faces of cylinders 23 and 24 can be electromagnets, superconducting magnets or permanent magnets.

At right angles to the two rotating cylinders 23, 24 are the rotating electrodes 21 and 22. These elements do not contain magnets. This entire assembly creates a rotating magnetohydrodynamic generator (RMHD) and allows for the recovery of substantial electrical energy via electrical contacts 29A and 29B. During operation, the magnets and electrodes are rotated by motors 25A, 25B, 25C and 25D before the plasma stream enters aperture 28. The opposing magnetic fields from the magnets in cylinders 23 and 24 apply a perpendicular force to the plasma that separates the ionic plasma, forcing it to electrically contact cylinders 21 and 22, creating an electrical potential which can be withdrawn by electric brushes 29A, 29B. Alternatively, this electrical energy can be be employed with a wire coil to produce a magnetic field which can interact with other magnetic coils or permanent magnets on a stationary surface, allowing electrical energy to be transferred over a gap instead of through the use of brushes. The electrical energy can then be transferred from the rotating cylinder through the process of induction. If the magnets 26 and 27 alternate in a north-south manner, then the resulting electrical output may be an alternating current due to the rotating cylinders' continuous presentation of alternating magnetic polar alignments. If the magnets of cylinder 23 are arranged in a single polarity orientation, such as, for example, north, and with the opposing cylinder's magnets all having a south orientation, then the electrical output would be direct current.

The use of rotating electrodes 21, 22 and magnetic assemblies 23, 24 prevents the thermal and neutral particle damage found in conventional magnetohydrodynamic generators, allowing the magnets of cylinders 23, 24 to be positioned closer together, thus increasing their effective magnetic field strength while decreasing the power requirements of electromagnets if they are used. This may allow the rotating magnetohydrodynamic generator (RMHG) to operate at extreme temperatures far in excess of current methods which must operate at lower temperatures to prevent damage to its surfaces. This also significantly limits their potential efficiency. This The ability to operate at extreme temperatures may serve to enhance the ionic densification of the plasma without damage to the device's surfaces, increasing the overall net efficiency of the device and eliminating the need for corrosive elements, which are often employed to increase the conductivity of the lower temperature plasmas used by conventional MHD systems which require lower temperature plasmas. By rotating the cylinders 21, 22, 23, 24, the exposure of any one surface to the plasma's impact may be minimized, reducing nucleation site formation where thermal damage starts despite the intense energy from the plasma's contact. Through the rotary action, any one area has a full rotation before it may be exposed again, which allows for the surface area's recovery and cooling, thereby further increasing its survival.

Further, the rotating arrangement of cylinders 23, 24 allows for the production of AC current, as opposed to conventional MHGs, which produce only DC current. Alternatively, additional energy can be added to the plasma, as well as a forward directed thrust may be produced if the electrodes, instead of removing ions from a plasma, apply an electric current which conducts through the ionized plasma. This may produce a magnetohydrodynamic drive (sometimes called an “MHD accelerator”), as is well known in the art. Also, with the application of an electric current, the temperature and energy level of the plasma may be increased.

As discussed above, all of the cylinders in the embodiment of FIG. 2 rotate and may be cooled by a liquid or gas. Nucleation sites may be disrupted by the physical rotation of the cylinders, which may serve to disrupt boundary layers, thus preventing significant damage to the electrodes and magnets that would otherwise occur. The use of a vibratory frequency transducer (sonic, ultrasonic, RF, sub-millimeter or microwave), which is not shown in FIG. 2 for purposes of clarity, but is shown in subsequent figures, can also be used to vibrate the electrodes or magnets when connected to the rotating devices, resulting in a two-dimensional movement of the assembly which results in greater resistance of the surfaces to thermal erosion from the plasma. A second set of transducers connected to the axles at 900 angles will produce a three-dimensional motion (relative to the transiting plasma) when combined with the rotation of the cylinder. This motion also prevents single areas of the rotating cylinder from repeated exposure to the plasma. It also serves to introduce an alternating pressure wave in the plasma capable of producing minute areas of intensified thermal energy, and these additional movements provide increased resistance to the formation of nucleation sites, thus reducing friction, while also allowing more efficient, stronger magnetic fields to be safely located closer together, where they can react more forcefully with the transiting plasma. These transducers may apply linear motion to the rotating means. When rapidly reversed, it creates what is termed vibration, but the same linear action can present different surface areas of the rotating means providing a repositioning of the surface of the rotating means to any area exposed to the plasma, where it also could continue the protective back and forth vibratory action extending the overall lifetime of the rotating means rather than just the vibratory movement alone.

These alternating pressure waves, vibrations created by the motion of the transducers, may, under the correct conditions, produce an effect called plasma luminescence (PL), which is analogous to the sonoluminescent effect which occurs within a liquid stimulated by an ultrasonic transducer. The PL effect occurs over a greater range of frequencies than sonoluminescence, which can serve to elevate the already extremely intense thermal environment of the plasma into a region of amplified energies in a discrete minute area. The amplified plasma effect, while present in only a small area of the plasma, can serve to catalyze reactions in the surrounding relatively cooler plasma. The motion of the surfaces, caused by a second set of vibratory transducers, if used, moves the rotating means together, thereby reducing the distance between the two rotating means and then alternately increasing the distance producing a zone of lower pressure followed by, with the zone's collapse, a rapid pressure increase within a small area of the transiting plasma. This zone's subsequent pressure increase results in an amplification of thermal energy at the point of the pressure wave's collapse. This is analogous to thermal increases which occur when gases are compressed, but within an already hot plasma.

This pressure wave effect can be further enhanced by pulsing the electromagnets of the rotating MHG by itself or in conjunction with the physical movement of the transducers, if used, at a frequency consistent with, as a non-limiting example, the transducer's frequency range producing an additive impulse effect. The effect can be additionally enhanced using electromagnets of any type. These electromagnets, along with the ultrasonic (or higher frequency) stimulation, could be electrically pulsed to occur at the same frequency corresponding to the frequency of the transducer. The pressure wave-induced plasma luminescent bubble's collapse, previously described, occurs in the trough of the wave's impulse, creating a moment of intense thermal energy amplification in the small focal area between the rotating disc/cylinders 60. If the thermal and ionic density is great enough, then the plasma intensification focusing effect can transit into a region where potential amplified energy, and even nuclear events, may occur, referred to here as “plasma detonation” (PD).

While less efficient and less thermally resistant, a stationary design for the electrodes and magnets assemblies of the system of FIGS. 2A-2B could be made more efficient and more thermally resistant by causing its surfaces to be rapidly moved via a vibratory method. This can be accomplished, as has already been disclosed herein, for the rotating electrodes and magnetic assemblies, through a method of high frequency movement of the stationary non-rotating parts with an ultrasonic or sonic transducer. This may result in the reduction of the thermal and neutral particle erosion of the exposed surfaces by discouraging the formation of damaging nucleation sites.

A rotating magneto hydrodynamic generator (RMHD) design is shown in FIG. 2B. An advantage of this design is that it uses only two rotating cylinders 211, 212 which are electrically separated from each other and include electrically conductive flanges 225 and 226, which serve as electrodes and can be electrically insulated from cylinders 211, 212, although this is not necessarily required. The outer perimeter of each of cylinders 220 and 221 can be made of one or more of metal, ceramic, graphene, diamond, etc. and may contain permanent magnets 218, 219 (in this non-limiting example). However, any magnets, such as electromagnets, superconducting magnets, etc. may be used. In this non-limiting example, the permanent magnets 218, 219 can alternate with a north and south configuration and will at all times be maintained in magnetic opposition (N to S) by the motors 213, 214 and/or by the magnetic attraction of the opposing magnet.

As the plasma stream contacts the cylinders 211, 212 through opening 222, once the cylinders are rotating, the magnetic field separates and deflects the disassociated ions and electrons which then impinge alternatively, depending on the polarity, upon the electrically conductive flanges 225 and 226, located perpendicularly to the polarized magnetic fields generated by the magnets 218 and 219 on each of the cylinders. This causes the negative and positive ions of the plasma to become separated by the magnetic fields. This force directs the ions of different polarities to either of the conductive electrode flanges 225, 226. This results in an electrical potential, allowing for the extraction of electrical energy through a load 217.

Alternatively, it is possible to produce forward thrust with the same device by applying a DC voltage or an AC voltage 221 to the conductive flanges 225, 226, as discussed above with respect to the previous embodiment. This creates a conductive path across the ionized plasma between the electrodes, producing a repulsive force in opposition to the magnetic fields which also serves to increase the thermal and energetic level of a transiting plasma. Electric power supply 221 may be a DC or an AC power supply and may be used as an alternative to the load 217; i.e., as an alternating current power source for an electromagnet. In the case of permanent magnets, the individual magnets would need to have alternating field polarity for AC power to be effective in producing a forward thrust potential. In this configuration, the polarity of the opposing magnets would need to always be in opposition and in an alternating relationship to the polarity of the other facing magnets N/S or S/N as they are rotating.

An alternative arrangement, which could be useful in some situations, would be to provide an electric input producing added thrust and on the next frequency cycle recover electricity through the MHDG process. In such a process, electrical capacitors or batteries, by way of non-limiting example, could recover and store electrical power which could then be used to increase forward thrust on the next cycle. Alternatively, when required, either a forward thrust or an electrical recovery potential could be produced for the desired period of time. Through the withdrawal of electrical energy, thermal energy is directly converted into electricity and removed, thus allowing for higher temperature operations which provides an additional cooling effect to the plasma.

The motors 213 and 214 are operated in a manner where the magnetic polarity of either magnet 218, 219 will always be of the opposite polarity to that of the opposing cylinder's magnet. It should be understood that thrust, as discussed above, does not require plasma and could be generated using any suitable type of fluid. If saltwater, as a non-limiting example, is the propulsion fluid, electrolysis would typically produce both oxygen and hydrogen bubbles on the surface areas of the electrodes (of current designs), which in addition to producing significant electrical insulation, the oxygen bubbles will also promote oxidation of the electrode surfaces. This oxidative layer, besides damaging the electrode surfaces, also increases electrical resistance, thus reducing overall efficiency. A vibrator or oscillator, as discussed with regard to the previous embodiment, would allow for a more rapid release and dissipation of such bubbles, thus increasing the overall efficiency of a given unit of surface area while reducing oxidative damage.

It should be understood that the plasma utilized by any of the rotating devices described above could also be produced by combustion, fission and/or fusion processes. The most viable method of fission produced plasma will utilize an inert gas such as helium or alternatively hydrogen. Hydrogen, with a high thermal capacity and low atomic mass, offers many advantages when heated into its plasma state.

Helium as a carrier gas has the benefit of being non-combustible, nor does it become radioactive in a fission reactor. These superheated plasma gases could be used to heat other gases or other materials into a plasma state where other reactions can occur including the disassociation of gases, such as the production of hydrogen gas from a hydrocarbon or the subtractive or additive elemental process described in FIG. 8. After this reaction has been completed, the gases can be recovered for reuse.

In order to initiate fusion, hydrogen, tritium, or deuterium gases are commonly used. The devices shown and described are able to work with currently proposed fusion generators and efficiently convert the fusion produced plasma directly into electricity while also allowing thermal energy to be harvested through heat exchanges, which can produce steam to be used in traditional turbines as well as the direct conversion of the ionic plasma into electricity with its MHD process. As has previously been discussed, due to the movement of the parts in the most thermally effected areas, these working components are able to function and survive even the extreme environment of a fusion reactor.

While the above examples discuss the use of carbon-containing hydrocarbon gases, it is also possible to use a wide variety of other substances to obtain useful outcomes. For example, dangerous substances such as dioxin (C₄H₄O₂) can be introduced into the plasma, dissociated, and cooled rapidly by the rotating thermally conductive cylinder, breaking down these molecules into harmless elements for potential reuse.

Various environmental contaminants, such as by way of non-limiting example dirty engine oil or coal, could provide a rich source of hydrogen, as could numerous contaminated solvents and pesticides. It is also envisioned that comingled contaminated landfill and plastic including single-use plastic material can be chopped up and introduced into the plasma stream, then rapidly cooled by the rotating cylinder, allowing for the constituent materials to be extracted through numerous means including, but not limited to, cyclonic and or magnetic separation methods. This can thereby create useful and reusable materials, while the direct recovery of electrical energy through the MHD function makes this method more efficient and economically viable.

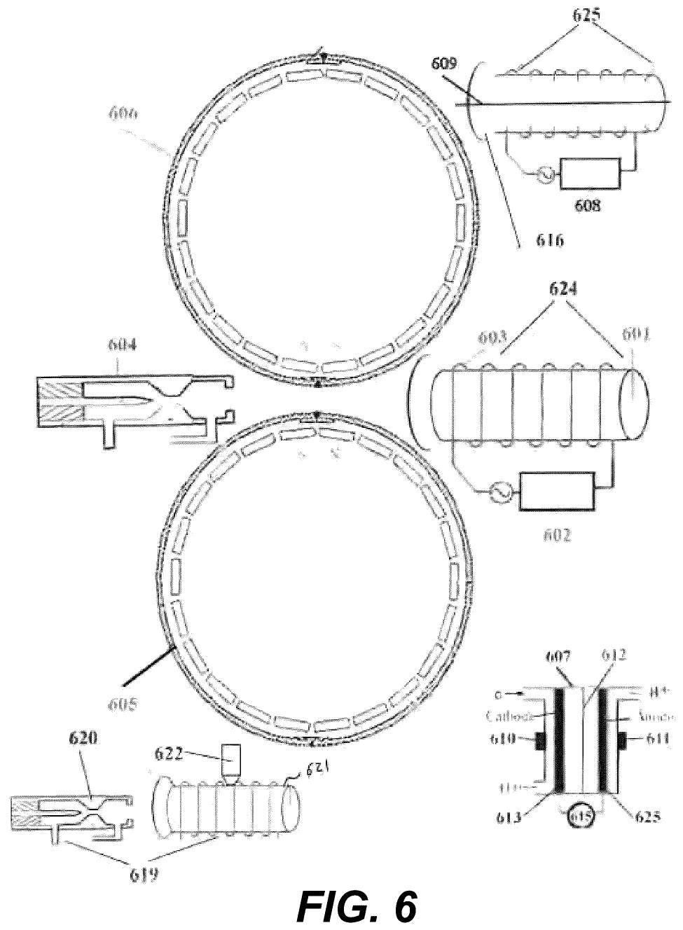

Water (H₂O) has also long been considered a potentially clean source of hydrogen gas and can be easily disassociated into a plasma state by an intersecting plasma. This combined plasma is then rapidly cooled at such a rate, by the devices disclosed herein, that the gases are prevented from reforming back into H₂O. The resulting hydrogen and oxygen removed from the device initially would be in the monatomic form of both hydrogen and oxygen. It is noted that the reaction of 2H→H₂ and the reaction of 2O→O₂ are both exothermic, and these natural reactions can be used to create thermal energy, which may be recovered by a number of different methods, as described in FIG. 6.

Further, as noted above, the recovered hydrogen can be used for a wide variety of purposes. This device also has the potential for creating a pressure wave in the transiting plasma by energizing transducers 227 and 224, which would create a two-dimensional motion relative to the transiting plasma. These pressure waves, as previously discussed, can create regions within the transiting plasma of higher and lower pressure relative to the surrounding plasma. When the wave's amplitude increases, it causes compression of the plasma raising its temperature. In its lower amplitude period, it likewise cools the plasma.

The transducers 224, 227 can move the rotating means closer rather than farther apart when alternately synchronized and produce the previously described compression effect. While two or more transducers may be used, only one is shown for clarity. This motion may be supplemented by an additional transducer pair 223, 222 located on the connecting axles 280 and 281 which, if desired, can additionally introduce a rocking motion, through the energizing of one while the other is in a deenergized state. While it should be understood that two or more transducers 224, 227 may be located on either side of the rotating means 211, 212, these additional transducers are not shown for purposes of clarity of the illustration. If required, an additional set of transducers 223 and 222 could also be employed at the same time, which would create, with the rotation, a three-dimensional movement relative to the plasma. These combined effects serve to amplify the plasma pressure wave while also providing enhanced protection from thermal and neutral particle exposure, by limiting the time that any one part of the rotating means confronts the full impact of the plasma's contact and friction.

It should be understood that the arrangements shown in FIGS. 2A and 2B may be applied to the device shown in FIG. 1 or any of the other embodiments described herein. With specific regard to FIG. 1, the rotating discs of FIG. 2B may be added to the device of FIG. 1, positioned adjacent the plasma stream, or may be used instead of the rotating body of FIG. 1, but including the remainder of the equipment described above with regard to FIG. 1, such as the gas tanks, gas release port formed through the chamber, valves, etc.

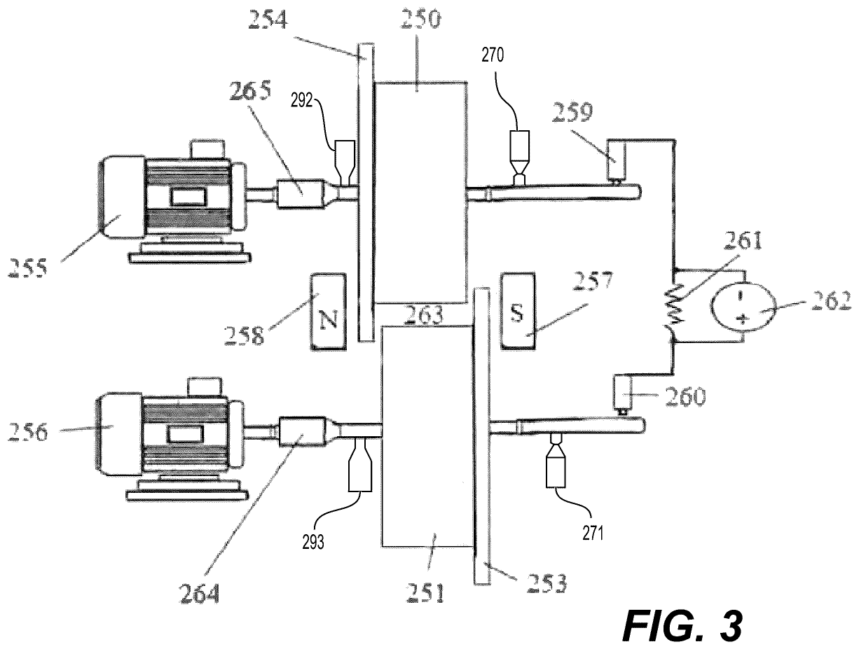

The device shown in FIG. 3 is similar to the device described above with regard to FIG. 2B. In FIG. 3, the charged ionic and electron plasma travels through aperture 263. High temperature flames, while having a lower ionic potential, can also effectively work, rather than plasma, where the flame provides a conductive material other than plasma, where the flame provides a conductive medium, along with other conductive materials often used to enhance ionic conduction at lower temperatures, allowing it to interact with the magnetic fields, allowing the ions and electrons to be separated and conducted through the spinning electrodes.

In contrast with the device of FIG. 2B, the magnets 257, 258 in FIG. 3 are mounted externally to the rotating cylinders 250, 251. These magnetic assemblies could be composed of the magnet arrangement shown or could be of a ring magnet design, with either a single solid polarity or evenly spaced sections composed of an opposite orientation, which will produce an AC output if attached to and rotated with flange 254 and 253 while synchronized to the facing magnet assembly of an opposing polar orientation. These magnetic assemblies could be configured to be attached rotating with the flange or, alternatively, could remain stationary while the spinning cylinders/discs 250, 251 serve as electrodes of the rotating magnetohydrodynamic generator.

In operation, the motors 255 and 256 start the rotation of the discs/cylinders 250, 251. Vibrating transducers 264, 265 can, at this point, be energized to cause the rotating cylinders 250, 251 to move in a two-dimensional motion combined with the rotary motion. Additionally, the transducers 270 and 271 again, as in previous embodiments, could be paired with another transducer means 293 and 292 located on the opposite side of the rotating flange, could likewise be energized, imparting a three-dimensional protective movement while introducing a series of pressure waves in the transiting plasma. These transducers, when energized in the synchronous or nonsynchronous manner with an additional pair on the other side of the axle, allows for even greater dimensional control of the cylinders 250 and 251. Rotation of the cylinders 250, 251 provides for the greatest degree of protection from the impacting thermal forces and vibrating or repositioning the cylinders by the transducers also provides significant additional protection. This allows the device to operate in higher temperature environments than similar current devices which do not make use of rotation and/or vibration.

Once this rotation is established, a plasma source emits a high temperature ionic plasma into the opening 263. The magnetic fields created by magnets 257, 258, including potentially a ring magnet, would cause the plasma to separate into electrons and positively charged ions which are directed towards the perpendicularly oriented spinning electrodes 250, 251. An electrical potential is then formed which can be withdrawn via electrical brush contacts 259, 260 (or, alternatively, through coupled induction), with useful work being performed by load 261. As in the previous embodiments, magnets 257, 258 can be any suitable type of magnets. If an alternating current is required, then the magnets, if they are electromagnets, can be powered by an alternating current, resulting in an alternating electrical output production/recovery from the plasma. If the magnets of the rotating ring magnets are composed of equally configured radial segments alternating between North and South polarity which then would be attached to and rotate with flange assemblies 253, 254 opposite polarity to the opposing ring magnet, then an AC output can also be produced. The device can also include flanges 253, 254 to provide rotating protection for the magnets 257, 258. These flanges can be made of one or more of ceramic, ferrous metal, diamond, non-ferrous metal, a thermally insulating material or the like. Although useful, it should be understood that the flanges are not strictly necessary for the device to function.

One of the advantages of the outer external placement of magnets 257, 258 configured as a non-rotating ring is that they can remain stationary rather than rotating with the cylinders. This simplifies connections needed for cooling and, in the case of electromagnets, reduces the complexity of providing electrical connections to a rotating spinning body. Generally, it also means that the size of the magnets and their magnetic flux can be far greater due to the fact that they are less hindered by size requirements necessitated by the dimensions of the rotating body described above with regard to FIGS. 2A and 2B, as well as any of the other devices described herein. The magnetic assembly, in which the magnets are positioned on the perimeter of a rotating body, will impact the effective overall size of the magnetic assembly.

This arrangement, by eliminating size restraints for the magnetic assemblies along with the ability of the magnets to be physically closer to the plasma, can allow for higher magnetic fields interacting with the transiting plasma, resulting in a higher conversion efficiency while additionally reducing the contacting surface area required for the electrodes

This also permits greater levels of electrical recovery. The use of the device shown in FIG. 3 may be used to facilitate chemical reactions, such as, for example, the solid carbon removal from a plasma hydrocarbon or any of the reactions contemplated in FIG. 8.

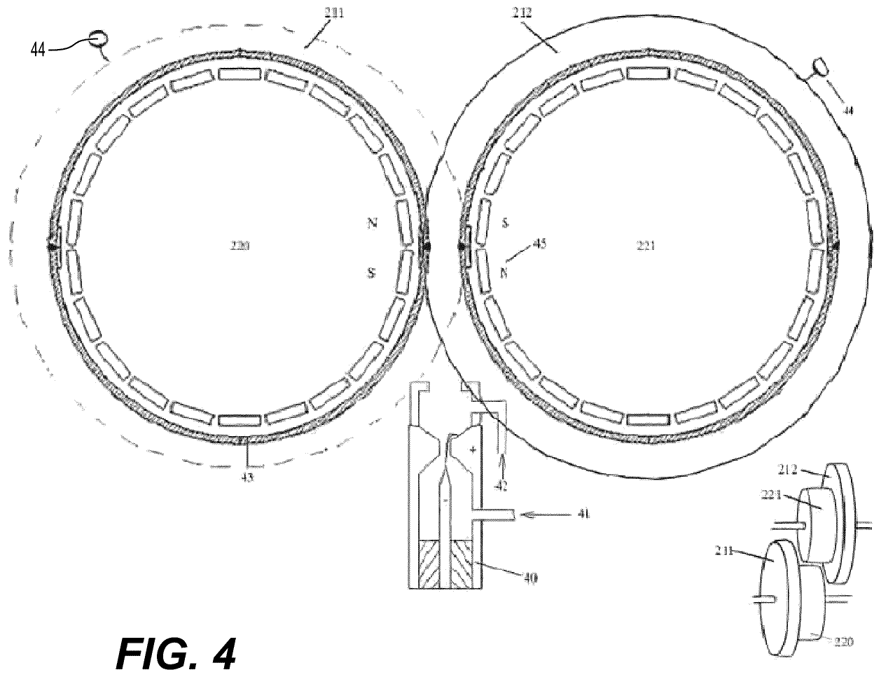

In operation, a gas (e.g., an inert gas, hydrogen, a hydrocarbon gas, gases containing the dopant Boron or phosphorus, etc.) is introduced into the plasma torch 40 through tube 41, as shown in FIG. 4. The plasma torch 40, which may be any suitable type of plasma torch, is energized to produce a plasma. This plasma can either be used alone or it can heat and convert materials introduced in front of the emerging plasma, thus causing this material to be heated into a plasma state. The plasma torch 40 shown in FIG. 4, a side view of FIG. 2b, uses materials or gases introduced by tube 42 in front of the originating plasma evolved from the gas or other materials introduced through tube 41. As described above, the plasma produced by plasma torch 40 can be used to convert other gases or materials, including hydrocarbons and water, for example, into a plasma state. These ionized plasmas are then rapidly cooled by the device's rotating thermal conducting cylinders 220, 221, as discussed above.

Using water as an example, ionized hydrogen and oxygen are produced in the plasma. Due to the extreme cooling effect of the plasma promoted by the rotating cylinders 220, 221, the combustibility of the hydrogen and the negative oxidation effects of the monatomic oxygen are greatly reduced and largely eliminated. Safe operations can be further ensured by the use of reduced temperatures of the active cooling heat transfer fluid flowing into and out of the rotating cylinders 220, 221, as discussed above.

By first purging and then maintaining chamber 6 (as seen in FIG. 1), which contains the rotating cylinders 220 221 with an inert gas (e.g., nitrogen), a safer operating environment can be obtained. A higher percentage of an inert carrier gas entering the plasma torch 40 may also be desirable for the prevention of spontaneous combustion of the hydrogen and oxygen components. However, if the rotational/cooling speed of the rotating cylinders 220, 221, in FIG. 4, is sufficient to provide a rapid cooling effect, air may serve as the plasma source gas and be used within chamber 6 and may further assist with the dissociation of the water molecule without promoting combustion.

When hydrocarbon gases are processed, it is often useful to introduce the gases as a mixture with other gases, depending upon the amount of carbon content of the gas passing through tube 42. A gas mixture of diatomic and monatomic gases or materials may assist with the initiation and help to maintain the plasma state since high carbon content gas may cause electrical shorting within the torch 40 of transferred and non-transferred torches, although this is not a concern with other plasma production methods, such as, by way of non-limiting example, RF induction heating. Additional energy is also required for the disassociation of diatomic gases. Further, if insufficient energy is present in the plasma, its temperature could fall below the point where it could remain in a plasma state due to the energy demands for the dissociation of a diatomic gas.

The introduced reaction gases composed of a hydrocarbon gas, or other hydrocarbon materials, could be mixed with an inert gas or other gases (e.g., nitrogen, argon, hydrogen, etc.). Through this mixing of a hydrocarbon with an inert or simpler gas (e.g., an elemental gas), the energy input necessary for the maintenance of the plasma I is often lowered. Likewise, increasing the energy input can also be used to maintain the plasma state.

Depending on the output requirements, the speed of the rotating cylinders 220, 221, or all the other rotating means shown herein, can be adjusted, as a non-limiting example, between 1 and 100,000 (or more) RPMs. As a general rule, a higher rotational speed results in a faster rate of cooling of the impinging plasma. This, in most cases, results in a more amorphous state of the solid material output if the reduced element exists at normal ambient pressure in a solid state. A slower rate of rotation often results in a more crystalline formation in the resulting solid material. By increasing the rate of the rotation of either cylinders 220, 221 or any of the other rotating means shown herein, gases or other elements released from the incoming material's molecular bonds as it enters into the plasma state will remain in a dissociated separated condition and will not devolve back into its former comingled state; i.e., the bonds between the atoms in the original molecules are permanently broken.

Alternatively, the device can be used to create new materials. Through an additive process, the comingled elements present in a plasma state, when rapidly cooled by the devices described herein, are able, in many cases, to form new compounds. It has been shown that for some molecular formations produced by this process it is sometimes helpful that the pressure of one or more gases inside chamber 6 is elevated above a low vacuum including above atmospheric. These gases may be combined with either the gaseous and/or solid materials introduced into the chamber in a plasma state. It should be understood that the rotating cylinders 220, 221, or any of the other rotating methods shown herein, may be constructed from any suitable type of thermally conductive material, such as, but not limited to, copper and thermally conductive diamonds that have been doped by an element, such as boron to function as electrodes. It should be further understood that plasma torch 40 may be any suitable method of raising matter into a plasma state.

It should be understood that the arrangements shown in FIG. 3 may be applied to any of the other embodiments described herein. FIG. 4 further illustrates a side, X-ray view of the device of FIG. 2B, particularly showing the relationship between the plasma torch 40 and the rotating cylinders 220, 221 connected to respective flanges 211, 212.

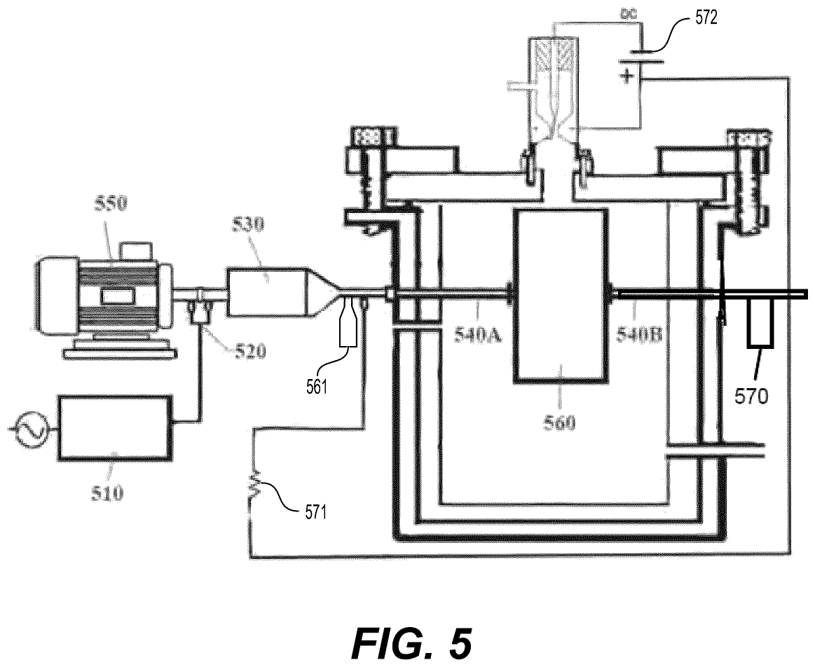

FIG. 5 shows a method for increasing thermal and neutral particle resistance of the rotating cooling cylinder 560. During operation, motor 550 rotates shafts 540A, 540B and rotating cylinder 560. Vibratory, linear back and forth movement using any suitable linear positioning devices or vibratory transducer may apply a second dimension of motion to rotating cylinder 560 in order to further limit the time any one part of the rotating means is exposed to the impacting plasma. Before the plasma torch is initiated, power supply 510 provides power through electrical contact 520 to an electromechanical positioning device, including piezoelectric electric. It can operate in any time range including between 1 Hz and 30 (or more) MHz. The vibrator 530 may be, by way of non-limiting examples, a piezoelectric vibrator (e.g., crystalline quartz), an electromagnetic vibrator, a pneumatic vibrator, a stepping motor, or a hydraulic vibrator. The actuator 530 alternately pushes and pulls shafts 540A and 540B back-and-forth (in the horizontal direction in the orientation of FIG. 5) while rotating cylinder 560 is in motion. This provides greater protection from thermal and neutral particle interactions with cylinder 560, as the cylinder is now traveling in a two-dimensional sinusoidal manner rather than in just the one degree-of-freedom (DOF) rotational direction. A second transducer means 570 may also be employed, thus creating a three-dimensional motion of the rotating means in relationship to the impacting plasma. In contact with the other side of rotating means 560 on shaft 540A, angular positioning or a balanced back-and-forth motion may be introduced to the rotating cylinder by transducer 570. Power supply 572 initiates the plasma torch and can utilize a load 571 through an unnumbered brush assembly.

The device shown in FIG. 6 is used for the collection of hydrogen in its atomic form consisting of 2H⁺ ions with its 2 associated electrons after it is condensed by the device from a plasma state. In the embodiment of FIG. 6, rotating cylinders 605, 606 are also used to generate electricity collected by two electrode flanges, not shown. As in the previous embodiments, vibration and/or linear motion of the rotating cylinders 605, 606 can decrease degradation of the surfaces through heat and other erosive effects created by the plasma twin transducers, such as those described above with regard to FIGS. 2A, 2B and 3, thereby producing higher levels of thermal protection while also exerting pressure waves which will compress the plasma three-dimensionally.

In a manner similar to that discussed above with regard to magnetohydrodynamic propulsion, applying current across the electrodes will also introduce additional energy to the plasma and can be also used for greater production of H+ while increasing the plasma's energy and ionic density, all while simultaneously preventing the combination of the H⁺ atoms into H₂. Magneto hydrodynamic generation MHG can also be employed by this device reclaiming the associated electrons, and reclaiming energy used in the process. In FIG. 6, the electrode flanges, as described above with regard to previous embodiments, have been omitted for purposes of clarity. In FIG. 6, tube 624 or tube 625 collects the gases from the reacted plasma, similar to tube 16 of FIG. 1. In FIG. 6, these gases contain the monatomic H⁺ along with any other gases produced in the process. Tube 624 or tube 625 is encircled by magnet 603, which may be a permanent magnet, an electromagnet, or a superconducting magnet. If an electromagnet or superconducting magnet is used, it is energized by power supply 602 or 608. These magnetic fields encircle the atomic hydrogen collection tube 624 or 625 or may be in the form of magnets arranged parallel on either side of the tube. These magnetic fields can prevent the monatomic hydrogen H⁺ 601 and its electrons flowing within the tube from recombining into H₂.

When a plasma of H⁺ with electrons encounters an externally applied magnetic field, the hydrogen ions are deflected in one direction and the electrons are deflected in an opposite direction. The presence of the magnetic fields prevents the monatomic H⁺ ions and the electrons from recombining into the more stable diatomic H₂ state.

The ionic H⁺ or other gases in their atomic forms, such as by way of non-limiting example, oxygen, could then be transported through tube 624 or, alternatively, tube 625, which has a gas dividing barrier 609. This allows multiple types of gases to be output separately. As an example, plasma produced from H₂O would result in the lighter H⁺ floating to the upper side of the divider 609. The resulting output would be ionic H⁺ and O⁺ with their associated electrons. As a non-limiting example, the H⁺ could be used for combustion when it is combined with an ignition source, and an oxidizer, such as O⁺ or O₂. This reaction produces higher thermal temperatures due to the exothermic recombination of H+ into H2 along with the exothermic combustion event, resulting in greater thermal production with its corresponding increased efficiencies during the combustion event.

The use of H⁺, or a mixture of H₁ to H₂, would have the thermal advantage of producing a two-stage release of energy when the twin H⁺ ions bond with their electrons. This reaction creates an energy output before the combustion event, in which the hydrogen combines with oxygen to form water in a second reaction. Should the O⁺ be used with H⁺ in a combustion reaction, the total amount of released energy can be significantly increased as the oxygen ions must first reunite with their electrons before combining with hydrogen. In this reaction, highly reactive fuel (H⁺ or H₂) collides with O⁺ or O₂ (or combinations of these feed stocks) and seeks to form new, more stable bonds, releasing additional energy during this process. The released energy produces both a thermal and optical output, making the reaction observable. The released heat and optical energy also excites adjoining hydrogen and oxygen, exciting their protons and electrons to split apart into their energized ionic form, making them react in a similar manner. This may produce a chain reaction of events that cascades through the combustion process, causing it to proceed incredibly fast.

The H⁺ and its electrons may be used by fuel cell 607, where it encounters cathode 613 before passing through the ion exchange membrane 612. Proton exchange membranes (PEMs) are the critical components enabling the function of proton exchange membrane fuel cells (PEMFCs). PEMs are fabricated from materials that exhibit high proton conductivity. This means they facilitate the rapid transport of protons (H⁺) from anode 625 to the cathode 613 of the fuel cell. PEMs must also be electronically insulating. This property prevents the direct flow of electrons through the membrane, forcing them to travel through an external circuit and generate electrical power rather than directly recombining.

A functional PEM acts as an effective barrier to reactant gases (hydrogen and oxygen). Preventing gas crossover ensures that the reactants are consumed exclusively at the catalyst sites, if required, maximizing fuel efficiency and preventing safety concerns. The harsh environment of a fuel cell demands exceptional resilience from the PEM. It must withstand acidic conditions, fluctuating temperatures, and mechanical stresses without significant degradation over time. The most commonly used materials for PEMs can typically only safely function below 100° C. At these limited temperatures, the full potential efficiency of fuel cells cannot be realized.

Some of the carbon-based materials which can be produced by the devices described above can be used as proton exchange membranes. As non-limiting examples, the device of FIG. 1 can produce various forms of carbon of various sizes, such as carbon nanotubes, graphene, buckminsterfullerene, and diamond nanoparticles. Carbon, if used as a PEM, potentially has the ability to operate at far higher temperatures, where the potential efficiencies of fuel cells can be fully realized. In order for carbon-based materials to function well as proton exchange membranes (PEMs), they need to be doped with materials that will give them an excess of holes, allowing for the efficient transport of protons. As a non-limiting example, boron can be infused into these carbon-based materials during the same process, where carbon is stripped from hydrocarbon precursor materials. Potentially, the use of boron-doped diamonds can provide a resilient, durable material for use in high temperature PEMs.

Carbon nanotubes (CNTs), with their exceptional properties, are rapidly emerging as a key player in the development of advanced microwave absorbing materials, but currently are difficult to produce in large quantities. The devices discussed herein can be used in methods for the production of large quantities of carbon nanotube materials. The large surface area and electrically conductive surfaces of CNTs provide ample sites for interactions with microwaves, while also providing excellent electrical conductivity, allowing for efficient energy dissipation of the absorbed energy in the form of thermal radiation. This combination of capabilities makes them ideal for creating highly effective microwave absorbing composite materials, including the potential for the protection of strong composite structural elements which are desirable for many uses, including for stealth technology.

The lightweight nature of CNTs allows for the fabrication of broadband microwave absorbing materials that are also lightweight and easily integratable into various applications. CNTs leverage quantum tunneling for the attenuation of a large spectrum of electromagnetic waves. CNTs cause electron tunneling through their cylindrical structures to interact with the carbon electron absorbing internal structural barriers contained within the structure. These serve to convert the incoming energy of the electromagnetic waves into other energetic forms, such as heat. These and other properties, including their large surface area, make CNT a potentially desirable candidate for PEM fuel cells.

The dielectric constant of a material determines how it interacts with an electrical field. CNTs possess a dielectric constant that is particularly well-suited for the absorption of microwaves and other lower frequencies, as well as radiation absorption of other types of electromagnetic waves, such as the high energy pressure waves created by the device's transducers on the transiting plasma, if employed by the presently described device, which induced frequency travels through the transport tubes 624 or 625. This can be adjusted for particular frequencies by the introduction of dopants, such as boron, which can provide molecular hole structures in the PEM. The process of doping introduces an atom from another element into the molecular structure of the bulk material to alter its electrical properties. The boron dopant usually has three valence electron bonds, as opposed to carbon's four, for example. This is similar to silicon's four valence electrons, making it also a promising electronic material potentially capable of semiconducting electronic functions.

Phosphorus atoms are another commonly used dopant material. Phosphorous has five valence electrons and is commonly used for the doping of n-type silicon semiconductor devices. Phosphorous has the ability to provide its fifth free electron for the creation of semiconductor barrier regions and can be used as a dopant material in carbon materials as well.

The surfaces of CNTs contain dangling bonds that overlap with valence and conductive surface states which arise in the many unique arrangements of carbon atoms. These dangling bonds can contribute to the absorption characteristics of the CNT of microwaves as well as other types of electromagnetic waves.

CNTs have unique abilities, exhibiting two distinct wavelength peaks in their frequency attenuation spectrum. This phenomenon can lead to improved wave absorption and broader bandwidth. CNTs, which can be produced by these devices in quantities can also be blended with other materials, such as, for example, epoxy resin, polyurethane foam or carbonyl iron powder, to form composites with enhanced absorption capabilities. The CNTs can act as a conductive network within the composite, facilitating the dissipation of absorbed energy and providing one method of construction of PEMs.

These properties can be additionally enhanced by the incorporation of permanent magnetic materials, including iron nitride, which can be produced in large quantities by the devices disclosed herein. CNT with associated magnetic material can produce structural cylinders in aligned stacked arrangements within a polymer or ceramic matrix corresponding to an external magnetic source. This configuration can create extremely lightweight structural materials useful in construction that can also absorb microwaves and other electromagnetic radiation across a broad frequency range. The surfaces of CNTs can be modified through coating or filling with magnetic nanoparticles, such as, as a non-limiting example, iron nitride. This can produce a precise tuning of the materials' absorption properties, tailoring them for specific applications.

Aligned carbon nanotubes (Aligned CNTs) are cylindrical molecules of carbon arranged in a highly ordered, parallel fashion, similar to the aligned bristles on a paint brush. This alignment has numerous structural and electrical benefits which may be crucial for many potential applications because it allows the individual properties of the tubes to be utilized on a larger scale, with many CNTs arranged in an aligned manner providing reinforcement, overcoming the limitations of randomly tangled nanotubes. As such, aligned CNTs are further contemplated for use herein.

The primary benefit of aligning carbon nanotubes is achieving anisotropy, meaning the material's properties are directional. The collective strength, electrical conductivity, and thermal conductivity are maximized along the direction of the nanotube alignment.

When aligned, the high tensile strength of individual CNTs can be combined. This creates materials that are significantly stronger and stiffer along the alignment axis than materials made from randomly oriented CNTs, where the forces are not distributed as efficiently. This results in composites that are incredibly lightweight yet stronger than steel.

Electrons flow with very little resistance along the length of a single CNT, a phenomenon known as ballistic transport. In a randomly tangled mesh, electrons must hop between tubes, creating high resistance at each junction. By aligning the nanotubes, it is possible to create a direct, uninterrupted pathway for electrons to travel, drastically increasing the overall conductivity and reducing heat generation from resistance.

Similar to electricity, heat (in the form of vibrations called phonons) travels much more efficiently along the length of a nanotube than across it. Aligned CNTs create a “superhighway” for heat to be channeled away from a source. This makes them far superior to randomly arranged CNTs for thermal management applications.

Such Aligned CNTs have many potential uses and applications, including the following:
The unique, directional properties of aligned CNTs open the door to a wide range of next-generation technologies.
The high strength-to-weight ratio of aligned CNTs makes them ideal for reinforcing composites.
Creating lighter and more fuel-efficient vehicle bodies, wings, and structural components without sacrificing strength means the composites which include aligned carbon nanotubes will have extremely favorable strength to weight ratios highly useful in the aerospace industry.
Body Armor: Weaving aligned CNT fibers into fabrics could produce bulletproof vests that are lighter, thinner, and more flexible than current Kevlar-based armors. (probably not my first go to use)
Manufacturing lighter and stronger tennis rackets, bicycle frames, and golf clubs.
Aligned CNTs could have properties making them highly desirable for electronics by overcoming the physical limitations of silicon. such as resistance to high heat which brings with it the potential for higher speeds than the current generation which has to make compromises between speed and operating temperature. Also semiconductors that could potentially operate at much high temperatures could provide temperatures where steam could be produced and the electricity recovered. This could make data centers less dependent on outside electrical sources.
Aligned arrays of semiconducting CNTs could be used to build computer chips that are smaller, significantly faster, and more energy-efficient than current silicon-based chips.
Transparent Conductive Films: They have been considered as a material that could be used to create flexible and durable touch screens, solar cells, and displays, providing a superior alternative to the brittle and expensive indium tin oxide (ITO) currently used.
Replacing copper wires inside microchips with aligned CNTs can reduce signal delay and heat buildup, allowing for faster processing speeds.
The ability to efficiently channel heat makes aligned CNTs perfect for cooling sensitive electronics.
Thermal Interface Materials (Aligned CNTs can act as a bridge to draw heat directly from a hot component, like a CPU, to a heat sink with greater efficiency, preventing overheating and improving performance.
Designing more compact and effective cooling systems for everything from personal computers to high-power lasers and data centers.
Aligned CNT arrays offer a massive, well-organized surface area, which is ideal for electrochemical devices, such as fuel cells, including those discussed herein.
Supercapacitors and Batteries: Using aligned CNTs as electrodes could potentially dramatically increase the power density and reduce the charging time of energy storage devices, leading to batteries that could potentially charge in seconds rather than hours.

The catalyst in traditional fuel cell designs is required to help convert the H² into 2H⁺ with two unbonded electrons before the cell can recombine it with O or O₂. The oxygen side of a fuel cell does not require conversion by a catalyst into an ionic form to function in the same way as the hydrogen side, but a fuel cell can potentially increase its overall efficiency if ionic oxygen is used. However, due to the potential of creating oxidative damage to the fuel cell, it may be desirable to use less reactive surfaces, such as a ceramic in the cell, to avoid potential damage from the ionic oxygen. The system could, on the cathodic oxygen side of cell 613, alternatively use less reactive O₂. Current designs of fuel cells require the use of significant amounts of catalytic elements, commonly consisting of platinum and ruthenium deposited on a carbon substrate.

In a standard fuel cell model, the hydrogen molecule (H₂) is divided into two hydrogen ions (H⁺) and two electrons at anode 625 by a platinum or other type of metal catalyst. The electrons produced flow through an external load 615, creating useful electrical energy, while the protons (H⁺) pass through a porous proton exchange membrane 612. While at the cathode side, oxygen (O₂) combines with electrons and protons to form the water molecule (H₂O) as a byproduct. In operation O⁺ can be generated by the device, as described above, using the divided tube 616. The H⁺, with its separated electrons, can also be conveyed by this magnetically-encircled tube to opposing sides of the fuel cell, where the potential use of magnets 610 and 611 (located on opposite sides of the cell) maintains both the hydrogen and oxygen in this monatomic ionic state.

As discussed above, the H⁺ can be produced by the above-described devices using a hydrocarbon feedstock. The H⁺, as discussed above, can realize a greater thermal potential in combustion processes as well as a higher conversion rate efficiency in a fuel cell while also reducing or eliminating the need for an expensive catalyst. Additionally, by collecting H⁺ using the magnetic tubes described above, the H⁺ and the associated electrons can be collected by a cryogenic refrigerator or other type of low-temperature cooler, allowing the hydrogen to be condensed into liquid hydrogen, where it can be maintained for long periods of time in the cryogenic state in the H⁺ form and stored for use as, for example, rocket fuel. It is noted that the produced liquid hydrogen is composed of monatomic hydrogen, rather than H₂. It should be understood that this hydrogen may be used for any desired purposes, such as, but not limited to, in reciprocating internal combustion engines, external combustion engines, gas turbines, turbo jets, and turbofan engines.

The device assembly 619 in FIG. 6 illustrates a plasma production device 620 and a magnetically encircled pipe 621. In operation, the hydrogen-containing input material is reduced to its plasma state and is projected into the opening of magnetic pipe 621. The ionic hydrogen produced from the plasma (H⁺ with two unbound electrons) is maintained in that configuration by the magnetic fields from magnetically-encircled pipe 621.

A vibration transducer 622 can be used, if required, for the disruption of the surface boundary layers of the exposed internal surfaces of pipe 621, giving it improved resistance to the erosive effects from the plasma's contact with its surfaces. It should be understood that additional actuators or vibrators (not shown) may also be used at a 90° angle or multiple other angles to the first transducer, thus causing another direction of motion for the tube 621 to create increased disturbances for any contracting plasma while further reducing the formation of damaging nucleation sites, thus allowing it to operate in more ionically dense, reactive environments without incurring damage to its surfaces. The magnetic fields can also serve to prevent molecular formation of a hydrocarbon should a hydrocarbon containing gas or other material be used. Magnetic tube 621 can be configured to operate in the manner of assembly 616, where the barrier 609 could be used for the separation of the hydrogen component from other elements, including precipitated carbon. It should be understood that the arrangements shown in FIG. 6 may be applied to the devices shown in FIGS. 1 and 5 or any of the other embodiments described herein.

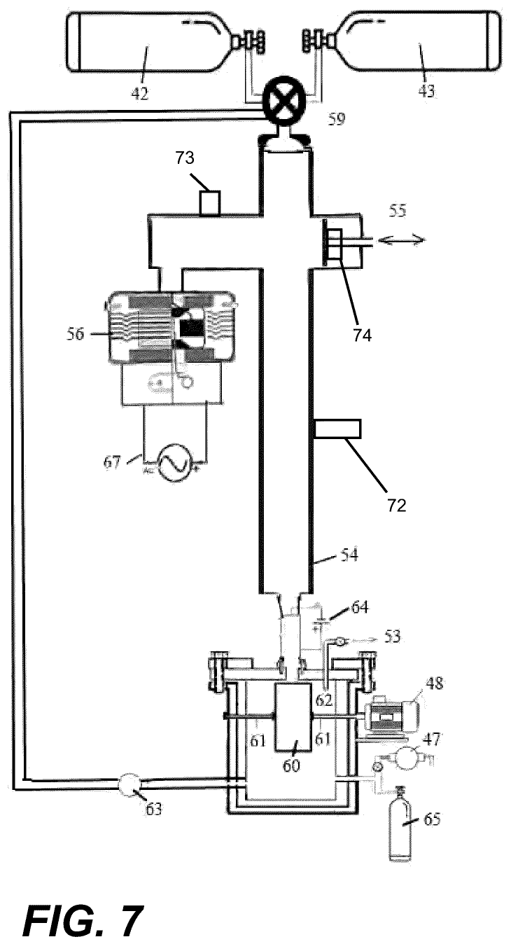

FIG. 7 shows a device for dissociating gases and other materials by using microwave energy as a source for creating the plasma discharge. Microwave plasma generators employ a high-frequency microwaves magnetron 56 to ignite and sustain a plasma discharge. This device utilizes a magnetron that converts electrical energy into microwave radiation, typically in the gigahertz frequency range. The generated microwaves are then coupled into a resonant cavity or waveguide structure 54. The intense electric field of the microwaves accelerates free electrons within the gas, leading to collisions with neutral atoms. These collisions result in further ionization, creating a cascade effect that generates a plasma, characterized by a high degree of ionization with a mixture of electrons, ions, and other excited species.

Microwave plasma generators offer several advantages over alternative plasma generation techniques. Their electrodeless nature eliminates electrode erosion and contamination issues, thus ensuring a clean plasma environment. Moreover, the efficient energy coupling of microwaves allows for rapid plasma ignition and precise control of plasma parameters, such as electron density and temperature. The ability to operate at atmospheric or reduced pressures further expands their versatility for diverse applications. Microwave plasma generators can be used in high-pressure environments as well but need careful engineering and constant active control in order to operate efficiently and maintain a sustained plasma environment. The increased pressure, when utilized by traditional high-pressure microwave designs, makes it harder to achieve the degree of ionization with a mixture of electrons, ions, and other excited species needed to maintain the plasma state.

Microwave plasma generation, even with special microwave applicators and precisely controlled gas flow, is a sensitive operation which is not typically well-suited for industrial environments.

FIG. 7 illustrates a device and method for maintaining a consistent plasma environment by employing transducer 74. Transducer 74 can perform several functions in a high-pressure plasma environment. Transducer 74 is capable of producing high frequency vibrations which actively tune the waveguide's volume which serves to maintain a robust high-pressure plasma by minimally scanning through a range of waveguide frequencies while also producing pressure pulsations within the waveguide. This stimulates the plasma's ions, electrons, and neutral particles, thus increasing interactions. These vibrations serve to both stimulate the plasma to a higher energy state and also sustain the plasma state within the waveguide. The transducer 74 can alternatively be used to move the tunable portion of the waveguide, thus allowing the tuning characteristics to be rapidly adjusted for different gases and materials, as well as being able to minutely effect the waveguide pressure environment, which allows the device to be quickly adjusted for use with different materials, gases, and compounds while maintaining the plasma state in higher pressure environments.

The transducers 72, 73 additionally assist in the maintenance of the high-pressure plasma environment within the waveguide by stimulating its walls, thus reducing the time of the plasma's thermally conductive contact with the waveguide surfaces. This allows a higher percentage to stay in a plasma state, preventing a series of plasma quenching events which would otherwise be emanating from the surface walls. This not only increases the overall efficiency of the device but also results in a more manageable system requiring less operational intervention.

In FIG. 7, a gas or a combination of gases and/or other materials is introduced from tanks 42, 43 via a mixing valve 59 and into a microwave chamber 54. Alternatively, the plasma state of these gases and/or other materials can be initially created by, as a non-limiting example, an electric arc in a plasma torch assembly, similar to the previous embodiments, before entering the microwave chamber 54. The plasma could alternatively be preheated through combustion, fission, fusion or rf induction. As a further alternative, the gas(es) can be stimulated into a plasma state through the use of lasers, electron beams, proton beams, x-rays or induction heating. As another alternative, a hydrogen rich gas or material can be combusted with air or oxygen before entering microwave chamber 54. While this produces a low-grade flame plasma, it aids in providing ionic energy for the initiation of higher plasma states by the microwave device with later recovery of the hydrogen. This allows for the gas(es) and other potential materials to enter the chamber area already in an ionized state.

Microwave chamber 54 may be a waveguide associated with magnetron 56 or may act as a waveguide in communication with magnetron 56. Microwave waveguide 54 can act as a microwave variable cavity tuned by adjustor 55 further enhanced by transducer means 74, which selectively alters the chamber's volume, thus tuning it. In operation, after the gas(es) are introduced into the microwave chamber 54, magnetron 56 produces microwaves with sufficient power and/or energy density to produce a plasma. The plasma exits microwave chamber 54 into a device similar to that shown in FIGS. 1, 2A, 2B, 3, 5, 9A, and 9B. The input plasma, as in the previous embodiments, impinges on rotating cylinder(s) 60, which is driven to rotate by motor 48, with hollow tubes 61 serving as the motor's axle and also serving to pass a cooling fluid through the interior of rotating cylinder 60, as discussed above with regard to the previous embodiments. As in the previous embodiments, hydrogen, as well as potentially other gases or materials, is extracted through tube 53. Further, as in the previous embodiments, rotating cylinder 60 also provides protection from plasma and associated high-temperature damage through the disruption of the formation of damaging nucleation sites, reducing contact time with the surfaces and other thermally induced processes.

As in the previous embodiments, vacuum pump 47 is used to evacuate the chamber, and gas tanks 42, 43 can adjust the gas mixture ratio within the chamber via mixing valve 59. An additional compressor 63 allows the unreacted process gases to flow back to the mixing valve 59 for reintroduction into the chamber.

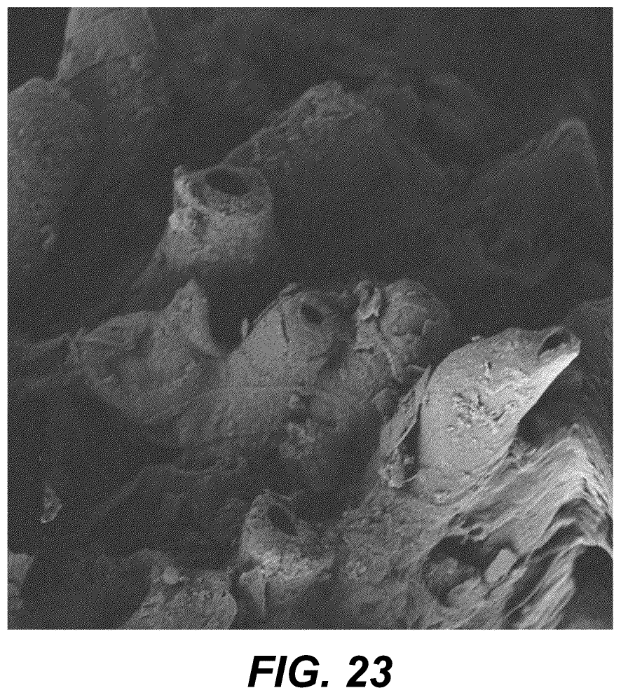

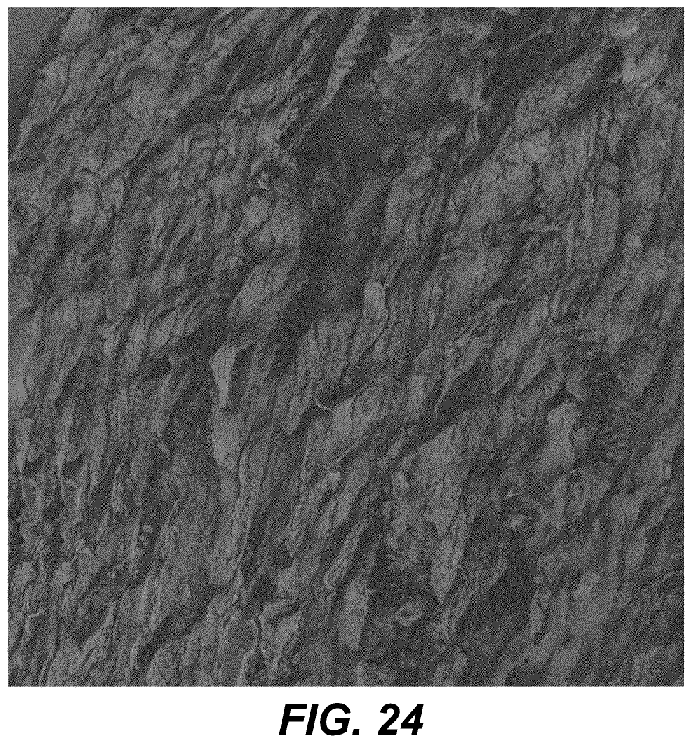

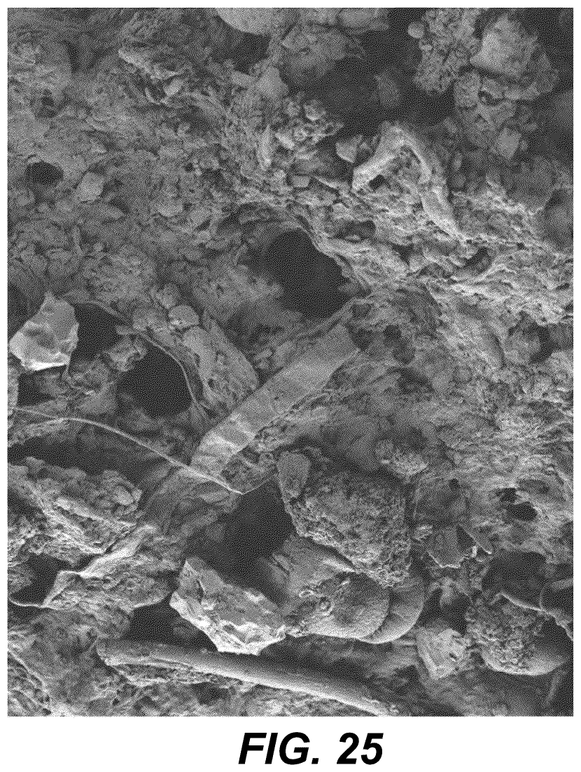

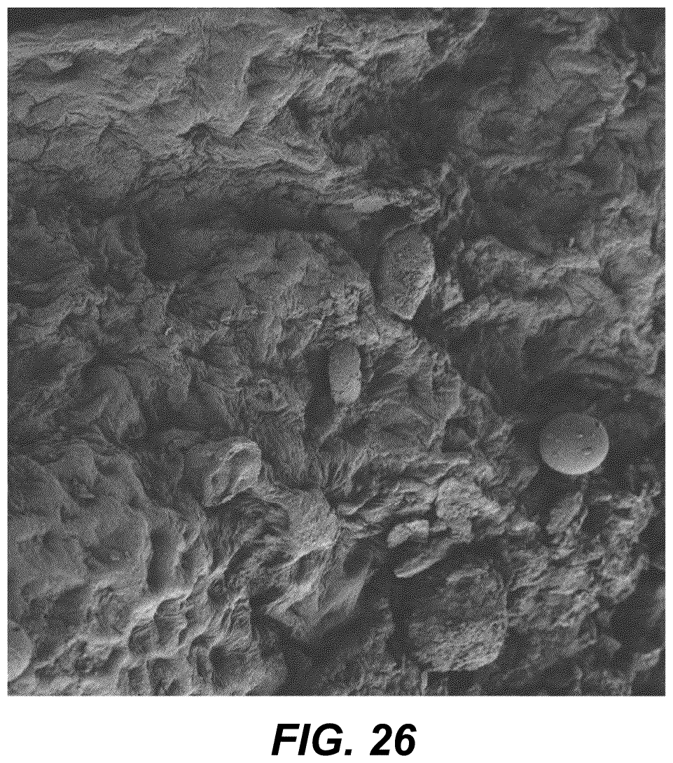

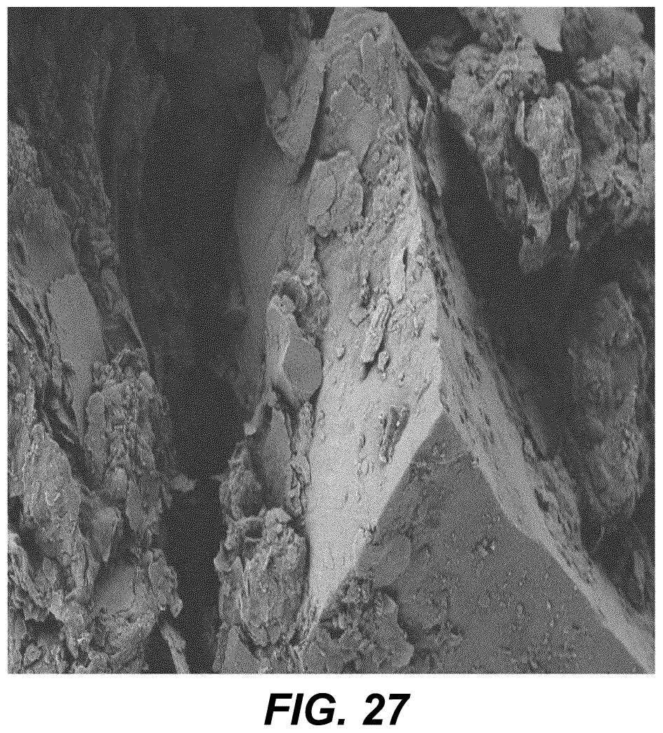

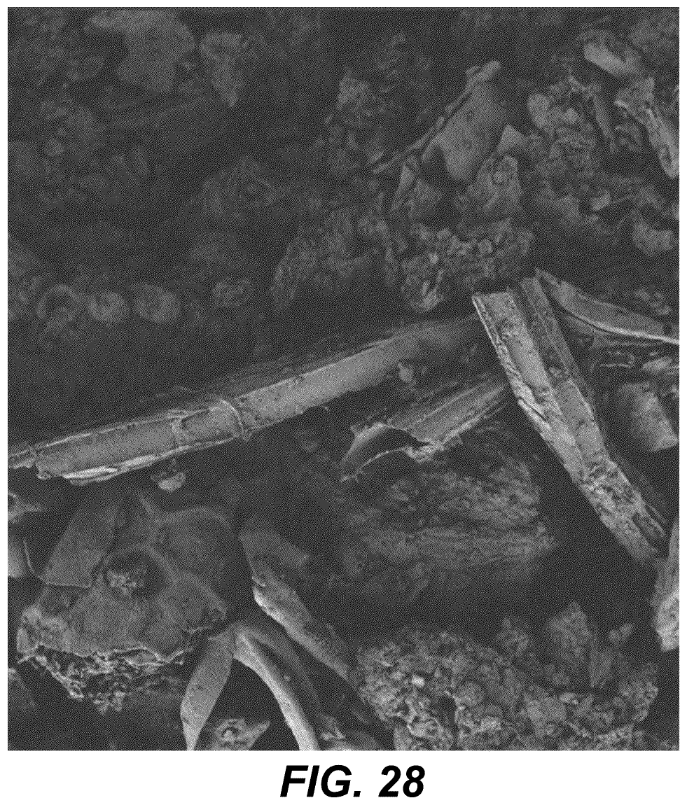

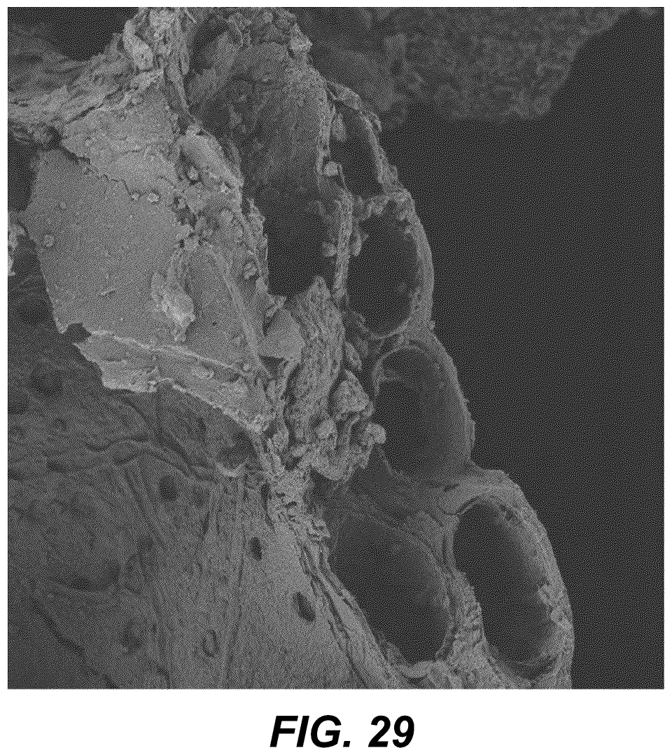

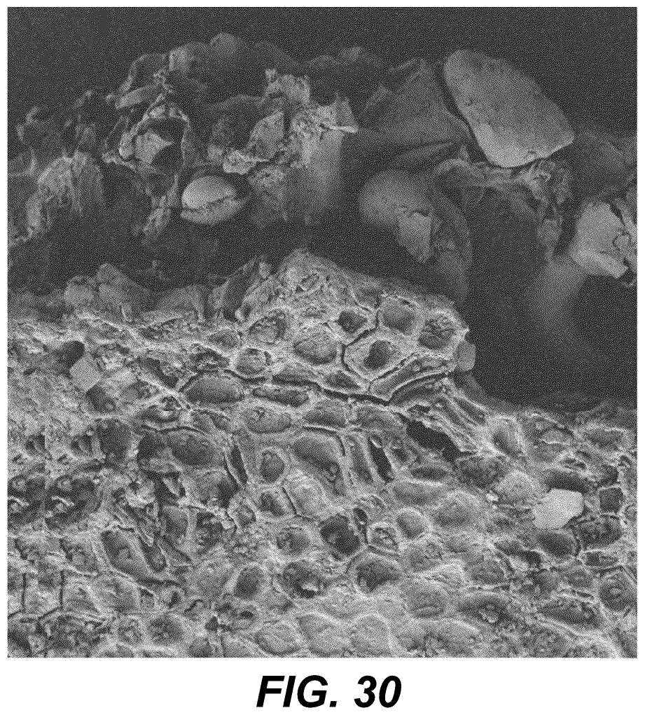

As in the previous embodiments, if methane is used, as a non-limiting example, solid carbon condenses and falls from the rotating cylinder and may be collected from the bottom of the chamber. Vibrating transducers 72 and 73 can be employed for increased protection for the waveguide 54 and can provide two degrees of motion, as well as also reducing frictional contact with the waveguide walls. Transducer 74 can vibrate or move and in doing so change the volume of the waveguide 54, allowing for a changing focal length to also increase disruption within the transiting plasma stream. FIGS. 23-31 are electron microscope images of carbon materials produced by the various devices described herein, including the device of FIG. 7. It is believed that the devices described herein, including those shown in FIGS. 1, 2A, 2B, 3, 5, 7, and other described designs can be used to produce various carbon (and other) materials, including, but not limited to, carbon nanoparticles, carbon nanotubes, fullerenes, diamond nanoparticles, graphene, and other forms of solid carbon, including other forms of solid carbon, such as carbon particles and structures ranging in size from about 3 nm to about 110 nm, by way of non-limiting example. Other sizes of the carbon particles and structures may likewise be possible, as the process can create smaller and larger structures. The larger structures are of potential interest since they mimic some carbon species that are usually much smaller, such as by way of non-limiting example carbonitudes. The illustrated device may also be used under different pressure regiments, including at higher pressures where direct additive plasma chemical synthesis can evolve and then be rapidly thermally quenched by the cylinder 60 to form new molecular arrangements without the need for traditional chemical reactions and synthesis.

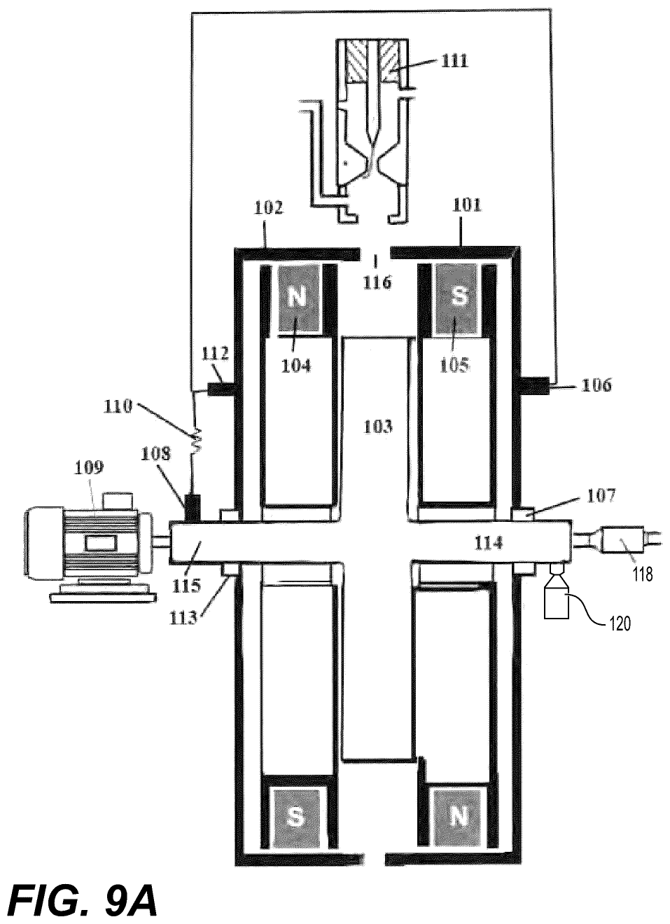

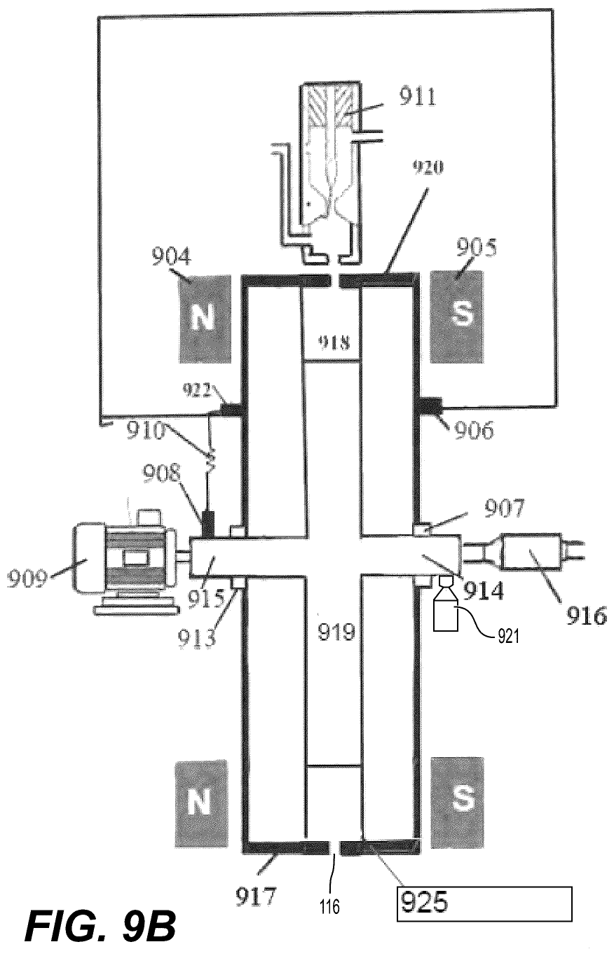

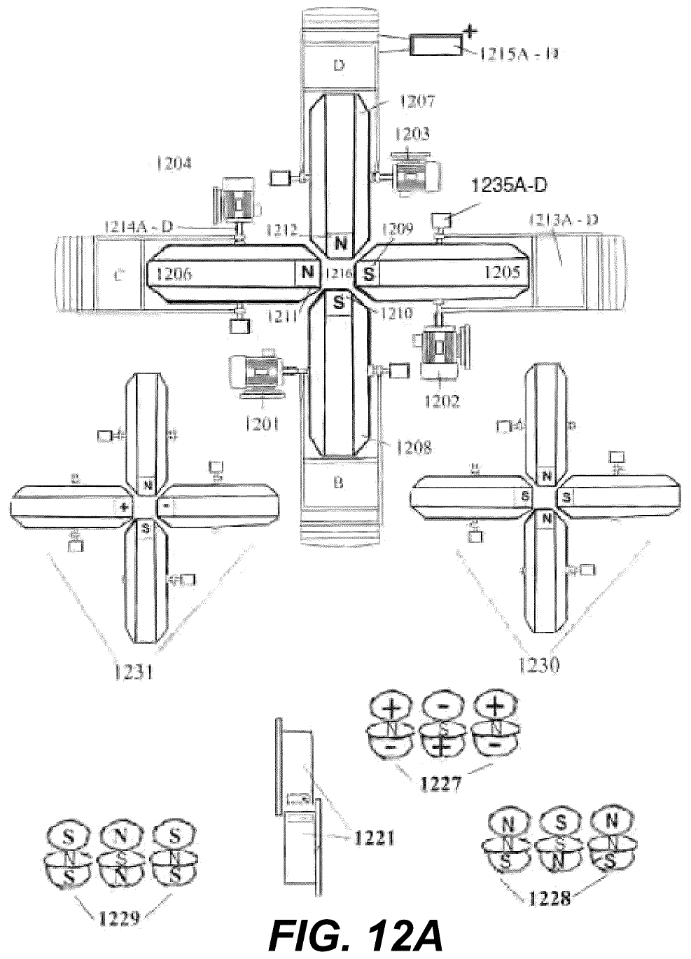

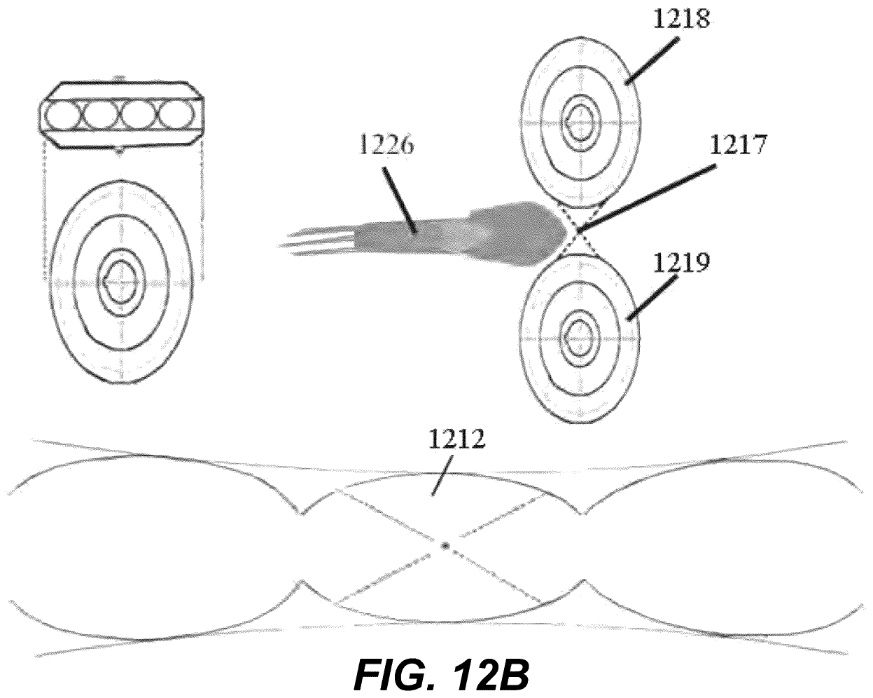

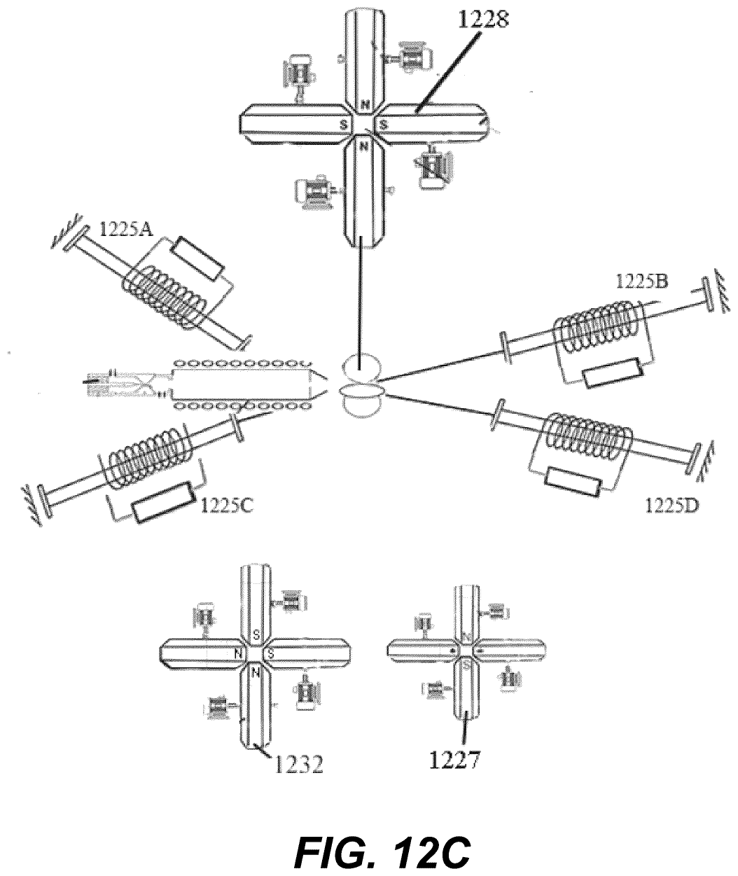

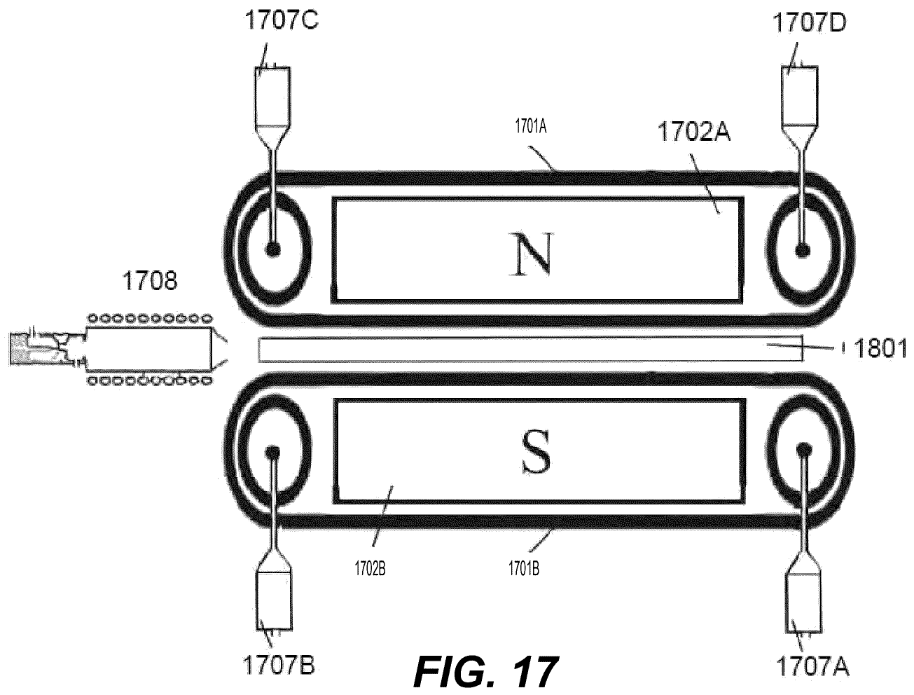

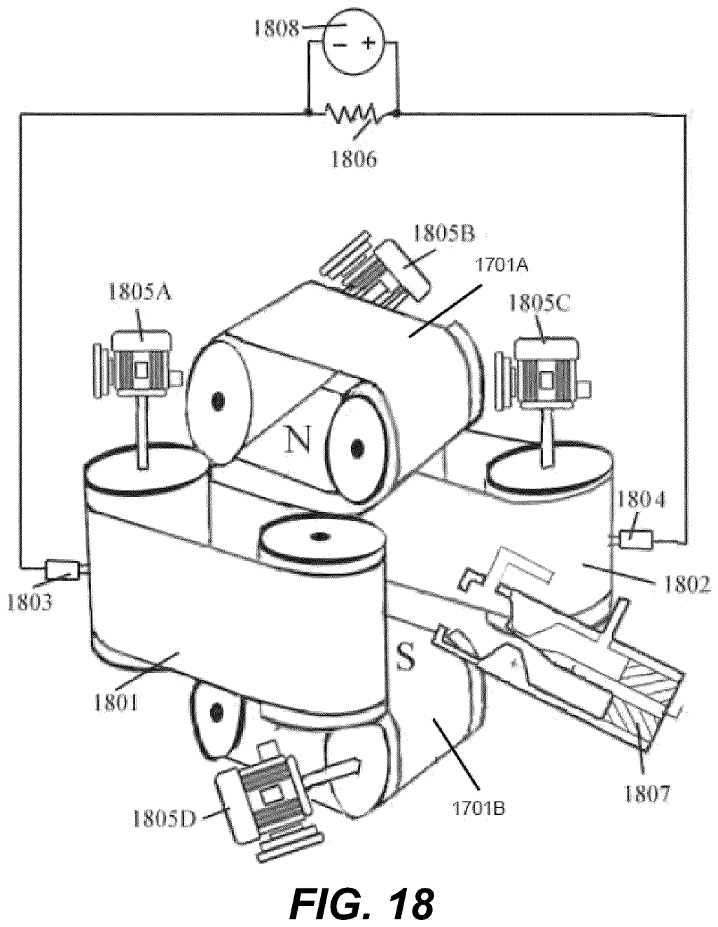

FIG. 8 illustrates a device similar in function to those shown in FIGS. 1, 2A, 2B, 3, 9A, and 9B with opposing external magnets for electrical recovery. This figure illustrates devices for internal or external magnets which may be utilized for electrical recovery or for adding electrical energy to the plasma stream as previously discussed. It should be understood that any desired number of rotating cylinders may be used, such as the two shown in FIG. 8, the four shown in FIG. 2A, 2B, 3, or the one rotator in FIGS. 9A, and 9B or even more would have utility such as in FIGS. 12A, 12B and 12C, extended to address the potential for even more such cylinders as in a hexagonal arrangement of six cylinders which could present two magnetic cylinders and four electrode means to the transiting plasma potentially allowing for more efficient shorter travel for electrons and ions seeking an electrode, an octagonal arrangement of eight cylinders or more to be configured as a multi-angular MHG Magneto Hydrodynamic device in contrast to the current arrangement used in traditional MHD generators which only present two opposing magnetic fields with two perpendicularly opposed electrodes. In such an arrangement of multiple rotating cylinders, it would allow the presentation of diagonally opposing rotating magnetic fields from different angles to the transiting plasma with a corresponding number of angled electrode means. Such an arrangement would allow the electrons and ions to more efficiently and make contact over a short distance with physically closer electrodes increasing the likelihood of a greater number of ions and electrons electrode absorptions. In addition, the belt devices shown in FIGS. 17 and 18 could alternatively function in FIG. 8 as well as the vibrating movements.

In operation, as in the previous embodiments, a motor or motors rotate the cylinders. As discussed above, additional vibration or transducer movements (from one or two directions) may be added for protection of the cylinders and for the production of pressure waves within the plasma which can create the potential for higher energy, focused temperature zones within the transiting plasma to include the potential for plasma luminescence (PL), or higher energy plasma detonation (PD) events to occur. The system of FIG. 8 can also be used in a method of forming compounds from the condensing plasma stream.

The method may include closing all valves of the chamber, turning on the vacuum pump and opening the valve to begin evacuation of the chamber. The method may then include closing the valve after the chamber is fully evacuated and adding a feed gas into the chamber of the system. The method may further include energizing the motors of each of the first rotating member and second rotating member to spin the first and second rotating members. The method may include generating a magnetic field between two of the opposing first rotating member and the second rotating member while providing rotating electrodes at right angles. The method may then include energizing the plasma inlet. The method may include adding working gases or other materials into the plasma inlet using the mixing valve. The method may further include generating high temperature plasma from the working gases or materials and contacting the first and or second rotating member with the high temperature plasma. The high temperature plasma may be cooled on impact with the first or second rotating member. The method may then include obtaining a solid and a gas, wherein the solid falls to a bottom of the chamber and the gas rises to the top of the chamber.

In various embodiments, the solid may be iron nitride.

The method described may also be used with other devices shown and described herein such as, by way of non-limiting example, the device in FIGS. 2A, 2B, 3, 9A, 9B, and FIGS. 36-38.

As discussed above with regard to the previous embodiments, the arrangement of rotating magnets in each cylinder or external ring magnets can result in either AC or DC electrical energy recovery from the plasma stream. The direct conversion of the incoming plasma stream into electricity results in its thermal potential being reduced by an equal amount. The level of thermal reduction/cooling is adjustable by varying the output to a given electrical load. This has the effect of controlling the rate of cooling, thus allowing for controllable adjustment of the characteristics and composition of the materials produced by the device; e.g., control over the production of a more amorphous glass or a more crystalline-like material. This control also allows for additive or subtractive adjustment of the molecular configurations of the output material such as the production of alloys, adding dopant materials, or forming new molecular bonds.

Adjusting various other parameters, such as, for example, the rotational speed of the condensing cylinders, the temperature and the volume rate of the cooling fluid running into and out of the rotating cylinders, adjustment of the amount of electrical recovery from the rotating cylinder as well as the temperature, pressure and volume of the incoming plasma and the chamber's environmental pressure, all have a great impact on the composition of the output material. The internal chamber pressure can also be adjusted significantly, which impacts the nature of the materials produced. In addition to controlling the properties of the solid materials produced, this level of process control also allows for adjustment of the amount of gas and other materials entrained in the resulting output material.

As a non-limiting example, a more crystalline material will be generally produced with a slower rate of rotation of the cylinders and a relatively warmer temperature of the rotating condensing cylinder. As noted above, the term “cylinder”, as used herein, is used for convenience and brevity and it should be understood that other rotating shapes may be used and may even be more functional for different processes. Non-limiting examples of other shapes which may replace the cylinder include cones, spheres, hemispheres, etc. The main requirement for the “cylinder” is that the shape selected is able to present opposing surfaces to the other “cylinder” or be able to nest together while providing perpendicularly placed and electrically insulated electrodes. If an electrical output is not desired, then the requirement for the electrode element is eliminated.

This is also greatly impacted by the increase or reduction in the rate and quantity of active cooling fluid flowing into and out of the cylinder. Crystal formation, for certain materials, can be enhanced by a reduced level of electrical energy recovery from the plasma, which allows additional time for crystalline formation processes to occur. Also, the temperature of the rotating surfaces can be increased for a more favorable environment for the development of crystalline formations. For the development of a more amorphous state material, generally a higher cooling rate of the active cooling fluids flowing into and out of the cylinders can be utilized, as well as a higher rate of electrical recovery. These methods lead to a more rapid cooling of the plasma, which does not leave time for the crystallization process to occur due to the extremely rapid temperature reduction.

In operation, after the cylinder has started rotating, the plasma generating torch 140, which may be any suitable source of plasma, as discussed above, is energized by injection of numerous potential materials, gases and/or gas combinations with solid materials (e.g., hydrogen, hydrocarbons, silicon, carbon, metals, liquids, H₂O, phosphorus, boron, gallium, gallium oxide (Ga₂O₃), aluminum nitride, aluminum oxide (Al₂O₃), inert gas(es), or any other gases or materials which may be converted into a plasma state or useful for forming semiconductors, magnets and other molecular materials, for non-limiting example).

Aluminum nitride has garnered a lot of interest as a potentially promising semiconductor due to its ability to operate in extremely high temperature environments, unlike silicon. This material is presently slowly grown using chemical vapor deposition (CVD), usually on a sapphire substrate. The plasma condensing systems discussed herein are capable of precipitating this material from a plasma in high volumes, with or without a sapphire (or other) substrate. These granular output materials produced by these methods can then be formed under pressure into a desired shape and then sintered at high temperatures to maintain the shape and join the particles together. The materials and/or gases may be introduced from tank 142 and are converted into a plasma state as it transits through the internal arc of torch 140 (or by any other suitable plasma source). If the production of oxides is desirable, then oxygen can also be utilized or blended with other gases. Alternatively, the gas contained in tank 142 can contain hydrocarbon materials, such as methane, if carbon alloyed metal or other materials is desired, as discussed above with regard to the previous embodiments. The hydrocarbon-containing content, for example, will be dissociated by the plasma torch 140 elevated into a plasma state and then rapidly thermally quenched by the rotating cylinder before the carbon can recombine with hydrogen, oxygen, or other gases and materials, resulting in the formation of carbon materials or alloying with other condensing elements. New molecular formations have also been noted to occur

This process can also be used to produce a dope carbon output with crystalline characteristics, such as diamond, The cylinder 168 can pressurize container 165 causing powdered material 166 which can include materials containing elements such as boron to become comingled with the gas entering into a plasma state by torch assembly 148 where the hydrocarbon gas in a plasma state heats the introduced boron into a commingled plasma state. The plasma is then rapidly condensed favoring either a p doped crystalline diamond material, or a more amorphous and/or polycrystalline material both of which are of interest with regards to the production of new semiconducting materials.

In order to create the phosphorus doped n type carbon material, for non-limiting example, a hydrocarbon gas, such as methane could be introduced from 142 to the plasma generator 140 simultaneously and inert gas, for non-limiting example, in cylinder 148 stirs the phosphorus material 146 in mixing chamber of 145. This combined material output exits through pipe means 141. The combined material is brought into a commingled plasma state in torch 140. This carbon rich doped plasma is rapidly condensed by either assemblies 137 or 136 into a more crystalline diamond or amorphous polycrystalline output material by methods previously described. Another method, other than by using the elements of phosphorus and boron, is through the introduction of these elements in gaseous form. Gases containing phosphorus, phosphine (PH₃), and boron diborane (B₂H₆) could be introduced by storage tank 187 and another associated tank not shown. One potential method for creating a p/n junction with these materials would be through compression of one dopant diamond material layer, for example n type and then spreading a second layer over that first layer with a p type doped diamond carbon material. Both could be compressed together into the desired shape and then sintered at high temperatures, preferably an inert gas and or a hydrocarbon containing gas, in an oven creating a p/n junction. In addition to these methods, in order to assist with the binding process, it has been considered that the non-crystalline carbon materials present in the output of the device, such as for non-limiting example, carbon-60 (Buckminsterfullerenee), could act as a carbon source that aids in bonding the doped or undoped diamond elements together into a desired shape with improvement of its electronic characteristics. It has also been considered that carbon nanotubes, graphene, and other carbon materials including unique forms found in the devices output could be used as well.

If contaminated metals or oxidized materials in chamber 145 are comingled by the gas entering through pipe 147, or introduced in other ways such as a wire feed, then the metal oxide or contaminant content is able to be separated from the oxygen component in its plasma state and rapidly quenched before the oxide layer can reform, which produces a more purified material. If a hydrocarbon or other carbon containing source is introduced into the plasma, then carbon entrainment is possible. By changing the rate of rotation of the cooling means along with the amount of cooling thermal transfer fluids removing heat from the rotating condensing cylinders, the levels of the carbon materials entrained in the output material can be adjusted and the nature of the output material modified.

For the removal of oxides from metallic compounds, a generally decreased pressure (lower than atmospheric pressure) is sometimes desirable. The described device can also be used for the incorporation or alloying of gases or other materials into an output. By changing the rate of cooling through adjustment of the percentage of electrical energy recovery, control is gained over removal or introduction of gases, such as oxides, into the metals or other materials. Increasing the chamber pressure to above sea level atmospheric pressure will generally serve to help entrain gases into the output materials.

In operation, after the device has started rotating, valve 186 of gas cylinder 148 is opened, introducing gas to the bottom of container 145. This container is filled with a powdered material including contaminated materials, which could comprise or consist of any of a number of oxidized metals, such as, but not limited to, titanium dioxide or ferrous oxide. As the gas from pipe 147 enters, it stirs powder 146, mixing it with the carrier gas. The powder and gas are then transported by pipe 141 into the plasma stream exiting torch 140, where they are heated and converted into the plasma state after which they are then rapidly cooled by the rotating means 197, 198, or 182, 175.

Alternatively, pipe 141 can transport a preheated or liquid metal feedstock to the plasma torch 140. A wire or wires, composed of metal or other solid materials, for example, could be used as a method to feed materials into contact with the torch's plasma stream. This provides precise control of the delivery mechanism and can result in precise ratios of introduced elements fed into the plasma stream. Such wires, which could be produced from different metals or other materials, allow for the metal compound ratios to be controlled through regulation of the speed of the different wire spools which would then introduce the wires into the plasma torch's output. These wires could also be preheated by passing the wire through an induction coil or other heating methods. The metal powder, metallic wire, molten metal, or other materials could also be heated by thermal energy recovered by the device. By heating the metal or other materials, less energy would be required by the plasma torch to elevate the metal or other materials into a plasma state. Two or more wire feed mechanisms could be used to introduce different metals or other elements, which allow for different alloy combinations to be created.

As discussed above with regard to the previous embodiments, the plasma stream enters the space between the one, two, or more rotating cylinders, where the ions in the plasma are alternatively attracted or repelled by the magnetic fields emanating from magnets 152, 151 of assembly 136 or 173, 174 of assembly 137. The ions and electrons are then attracted to one or the other of the rotating electrodes. As they contact the rotating surfaces, they are rapidly thermally quenched. The electrically produced MHG current is picked up by brush electrical contacts 144, 188 in assembly 136 or 177, 178 in assembly 137 contacting the cylinders' electrode surfaces, allowing for the electrical potential to be passed through a load 189 or 179 for useful work. Alternatively, the embedded magnets could convey electricity to a coil by induction.

A second powder containment vessel 165 can allow for the introduction of other metallic or nonmetallic elements. This allows for the alloying of more than two different metals, chemical elements, or other materials. When a gas from tank 168 is metered through valve 185 via line 167, it causes a stirring motion and entrainment of the powdered metal (or other materials) into the introduced gas. By way of non-limiting examples, the gas may be one or more of nitrogen, argon, hydrogen or a hydrocarbon-containing gas, although it should be understood that any suitable type of gas may be used.

This mixture of gas and powdered, granulated, molten, and wire metal (or other materials) then moves into conduit 141 and enters the plasma projecting from torch 140, where the plasma produced from the torch elevates the inflow of powder and other gases into a plasma state. This commingled plasma moves to the opening between the rotating cylinders, where the plasma is rapidly cooled, energy is recovered, and the metal alloy or other molecular mixture falls to the bottom of the chamber with the separated unreacted gases being extracted for reuse.

Electrical energy which is collected by electrode flanges 153 and 154 (on assembly 136) or by electrodes 175 and 182 (on assembly 137) can be withdrawn via contact brushes 144 and 188 (on assembly 136) or 177 and 178 (on assembly 137) or through an inductive process conducting through an adjustable load 189 (on assembly 136) or 179 (on assembly 137).

Alternatively, electric power could also be applied to electrodes 153, 154 (on assembly 136) and 182, 175 (on assembly 137). The electric current supplied by either power supply 180 or 190 conducts through the ionized plasma where it interacts with the magnetic fields of the rotating magnets. This accelerates and heats the plasma into a higher energy state where additional reactions and other material recombinations can occur, as discussed above. This is also another adjustable parameter which allows a significant level of control over the high energy reactions.

In operation, the motors 170 and 171 (in assembly 137) start the cylinders 175 and 182 rotating. Magnets 173, 174 may be any suitable type of magnets, as discussed above with regard to the previous embodiments, including alternating AC electromagnets or segmented polar rotating permanent ring magnets capable of inducing an AC output recovery from the plasma stream.

If the supply current for electromagnets, 174 and 173 in assembly 137, can be modulated to the same frequency as the linear motion of transducers 134, 184 and or 192, 193 with ring magnets attached to the flanges or stationary, then the variable magnetic flux impacting the plasma can be further augmented and will reinforce the development of plasma and magnetic void zones and their subsequent collapse producing more intense compression energy point zones within the transiting plasma as previously described. Additionally, if the transducers 192 and 193 are energized at the same time as transducers 184 and 134, the variations in the magnetic flux will follow a three-dimensional motion causing its field lines to sweep across, even doing so without magnetic field modulation with respect to the transiting plasma. It should be understood that only two of the transducers 193, 192 are shown for purposes of clarity, however, two or more transducers could be put onto the same axle on the motor side as well. This could allow for the rotating cylinders to present adjustable angled surfaces to the transiting plasma or produce a back-and-forth compressive force.

Once rotation of the cylinders has commenced, the plasma torch is then initiated to produce a plasma stream output which impinges on the two electrically isolated rotating cylinders 175 and 182 of assembly 137. The flanges 176 and 187 are not required for this embodiment to operate but can provide protection to the magnets from stray thermal radiation. However, they may also reduce the magnetic field flux due to the added distance from the plasma created by the flanges' thicknesses, leading to potentially slightly lower efficiency. When the plasma encounters the magnetic fields, plasma ions and electrons are separated and sorted through polarized interactions with the magnetic fields to either of the perpendicularly positioned cylinders 175 and 182. If electrical recovery is desired, then the electrical potential is picked up by brushes 177 and 178 (or through an inductive process) and passes through a load 179.

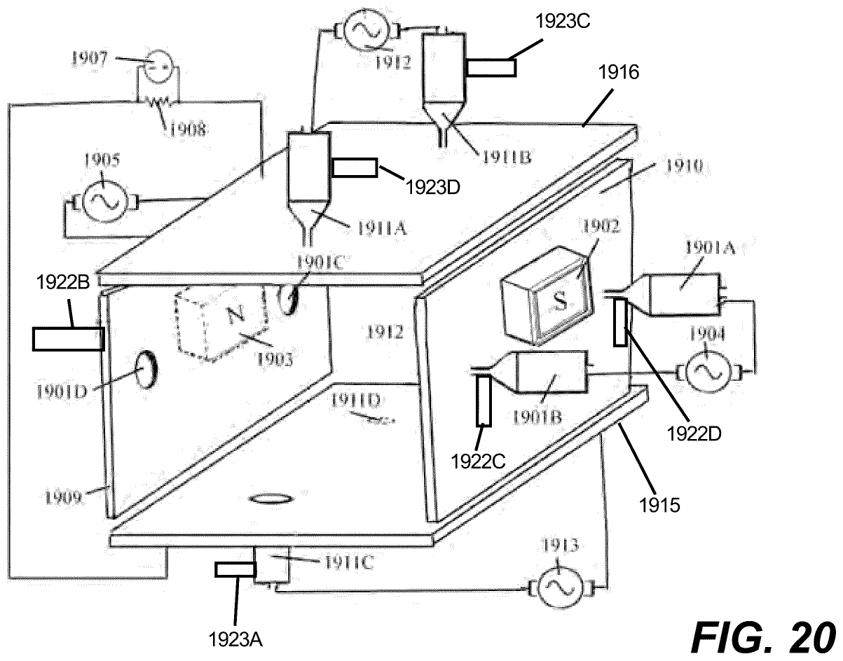

As discussed above with regard to the previous embodiments, a high velocity thrust potential can be created by the same device through the use of an electrical power supply 180 instead of the load 179. This applies to an electric current across the ionized plasma from the rotating cylinder/disc electrode. The electrical reaction with the magnetic field increases the speed of the plasma traveling through the intersecting gap 183 located between the two rotating cylinders, providing thrust, while also increasing the plasma's energy and thermal state, allowing for an even greater level of process control. This potentially allows for high energy reactions and creates the conditions for the formation of difficult to form materials. The accelerated plasma can also be condensed by a rotating magnetohydrodynamic generator or a non-rotating vibrational magnetohydrodynamic generator (VMHG) as will be discussed in greater detail below with regard to FIG. 20.

Alternatively, the plasma could be accelerated with resulting increases of the plasma's energy state by these devices when they are configured to act as rotating magneto hydrodynamic propulsion units or by the vibratory magnetohydrodynamic of device shown in FIG. 20. Both systems enter this mode of operation through the conduction of an electrical current through its electrode surfaces.

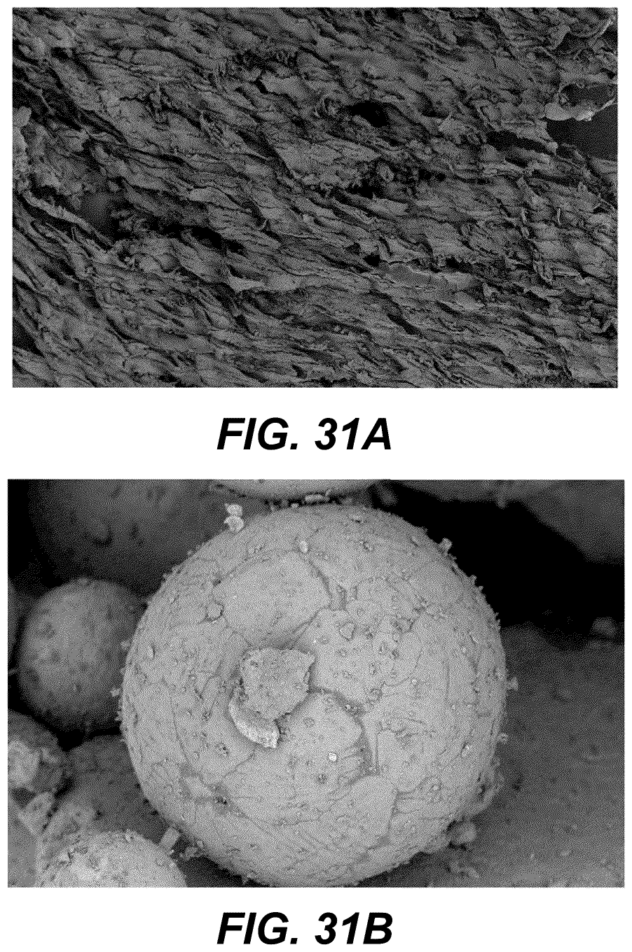

As a non-limiting example, the device of FIG. 8 may be used to produce Fe₁₆N₂, Fe₄N, and other iron nitride compounds, which show great promise as potentially inexpensive, powerful permanent magnetic material capable of operating at high temperatures and are made from abundantly available elements. Shown in FIG. 31A is a novel spherical iron nitride material created by these devices. Existing methods of manufacturing these magnets are slow, energy intensive and generally only can produce small quantities. The presently described device is able to produce large quantities of these materials efficiently. As in FIG. 1, the device is enclosed within a pressure vessel, where this process may be conducted at above or below surface level atmospheric pressures, as non-limiting examples. In general, an increased pressure inside the chamber can result in a larger percentage of entrainment of nitrogen (or, potentially, other gases, such as those containing or mixtures of boron, for example) within the iron compound. The rotating cylinders are driven to rotate and gas tank 142 is opened to introduce nitrogen gas to torch 140. The gas tank 148 is then opened to deliver gas into pipe 147, which stirs and mixes powdered iron 146 inside of chamber 145. The powdered nitrogen gas-iron mixture is then transported via pipe 141 into direct contact with the hot plasma emitted by torch 140 elevating this mixture into a plasma state.

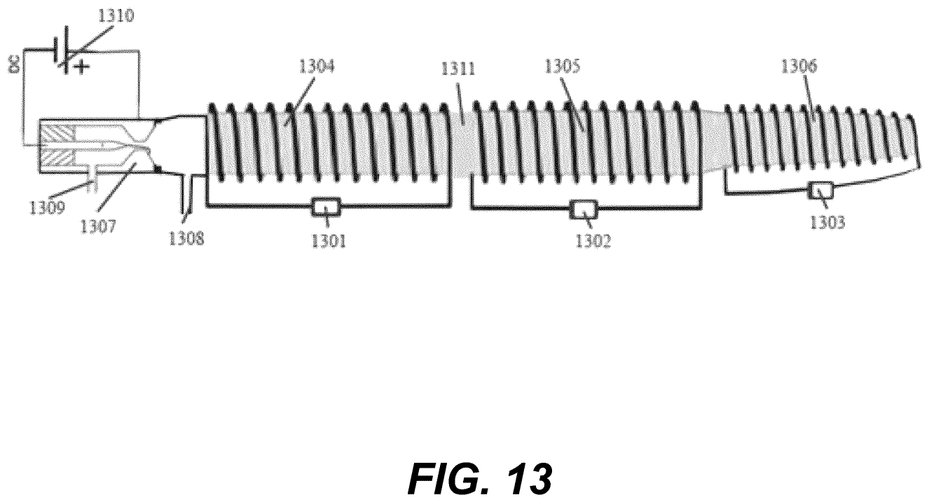

As previously discussed, the iron or iron mixture could be metered and delivered to the plasma in the form of a wire or in the form of molten metal. The plasma heats and converts the iron into a plasma state while allowing it to mix with the nitrogen in a co-mingled plasma. This mixture can be further heated through induction coils, such as those illustrated in FIG. 13. The plasma then enters the area between, and in contact with, the two rotating cylinders of either assembly 137 or 136 or, alternatively, the single rotating devices shown in FIGS. 9A and/or 9B, which rapidly condense the plasma by super cooling the resulting mixture, entraining nitrogen into the iron, forming iron nitride. Such a process could also be performed using any of the previous embodiments. As discussed above, by varying any of the above parameters, the resultant iron nitride, and the properties associated therewith, can be controlled. It is also possible to create this output by applying a voltage to the rotating electrodes, thus increasing the available energy level for the reaction.

Iron nitride (Fe—N) magnetic materials have a variety of properties useful in magnets, including high saturation magnetization, mechanical hardness, and superior corrosion resistance. This, added to their manufacture from abundantly available, low-cost materials while maintaining strong magnetic field structures at high temperature resistance, make Fe—N compounds promising for a range of applications, from magnetic recording media, generators and motors to high-frequency power devices. However, the widespread adoption of Fe—N materials has been stalled by currently available Fe—N materials' susceptibility to demagnetization. Demagnetization (i.e., the loss of magnetic order within a material) is an issue in Fe—N compounds, particularly under elevated temperatures or in the presence of external magnetic fields. This susceptibility stems from the inherent nature of Fe—N crystal structures, which often exhibit a high degree of magnetocrystalline anisotropy, a property that dictates the preferred direction of magnetization within the material. High anisotropy can lead to the formation of magnetic domains with opposing magnetizations, increasing the risk of demagnetization.

Researchers have been exploring various mitigating strategies with dopants and amorphous iron nitride, which can be produced by these disclosed devices in large quantities, emerging as promising avenues of production. The introduction of dopant atoms into the Fe—N lattice has shown potential in enhancing the magnetic stability of these materials. Dopants, such as cobalt (Co), nickel (Ni), neodymium, samarium, boron (B), have been found to modify the magnetocrystalline anisotropy of Fe—N, reducing the tendency for domain formation, thus enhancing its resistance to demagnetization events. Dopants can also influence other crucial parameters, such as the Curie temperature and the coercivity, further improving the overall magnetic performance of Fe—N compounds. Unlike crystalline materials, amorphous iron nitride lacks long-range atomic order. This lack of regular structure can suppress the formation of magnetic domains, leading to a significantly lower susceptibility to demagnetization.

Amorphous Fe—N films have demonstrated thermal stability and resistance to external magnetic fields, making them attractive candidates for high-temperature and high-field applications. The optimal choice of dopants and their concentrations require careful consideration to achieve the desired balance between magnetic stability and other performance parameters. Use of traditional methods for the synthesis of high-quality amorphous Fe—N with controlled compositions and thicknesses can be challenging. The device shown in FIG. 8 provides a method of manufacturing Fe—N materials in high quantities. It also allows for large parameter adjustability and can vary the nature of the resulting material to either favor a crystalline or more amorphous state. It also allows for the introduction of numerous dopant materials in precise ratios to improve the overall magnetic characteristics and to prevent demagnetization events from occurring. When this compound is produced by the processes described herein, it quickly evolves into the small spherical magnetic structures shown in FIG. 31A which appear to introduce increased resistance to demagnetization.

As in the previous embodiments, additional heating of the plasma can be induced by, as non-limiting examples, combustion, an induction device, a sub-millimeter, x-ray, microwave, RF or laser source, a proton beam, fission, fusion or by any other suitable type of non-contact heating. For the production of metal alloys, powdered metal 146 can consist of metals in numerous proportional ratios which are desired to be alloyed together. The metal alloy output could allow for the production of finished parts directly by metal powder for high pressure molding or forming with sintering technology.

The device shown in FIG. 8, in addition to producing alloys of various metals and other materials, can also efficiently manufacture a wide variety of different chemical substances through a process herein referred to as Plasma Chemical Synthesis (PCS). Plasma chemical synthesis refers to production of numerous chemicals through a direct additive method. This is accomplished by combining different elements in their plasma state together directly and then cooling them rapidly at sufficiently high rates so that the new molecular configuration is maintained.

In operation, the element or materials 166, having been pressurized by tank 168, are introduced into pipe 141 at the same moment gas tank 148 provides pressure to the element 146, causing it to be introduced into pipe 141 where it combines with the other element or materials. The ratio of the two or more elements/materials are determined through adjustments of valves 185, 186. Only two pressure pots are shown here, however more could be added for more complex material production. These elements are then introduced into the plasma created by plasma torch 140, which heats the elements into a commingled plasma state where any of the devices of FIG. 8 or the previous embodiments, including the devices shown in FIGS. 9A, 9B, 17, 18, 19, 20 and 12A then rapidly cool the elements condensing the materials into the desired molecular output materials.

The rotating magnetohydrodynamic generating device (RMHD) of FIG. 9A operates in a manner similar to the previous embodiments but requires only a single moving part. During operation, plasma torch 111, which may be any suitable type of plasma source, is energized to form a plasma. The plasma enters through a slit 116 formed between electrically conductive shells 101 and 102. This allows plasma to enter the space created between ring magnets 104 and 105. These magnets can either be two rings of similar magnetic polarity or can be composed of circular polar magnetic segments composed from elements containing a series of alternating polarity alignments which together form a ring shape. If a series of alternating polarity magnets formed of equally spaced radial segments of ring magnets 104, 105 are used, an alternating current can be produced, as discussed with regard to the previous embodiments. If the rings consist of single polarity magnets with opposing magnetic polarity to that of the other facing ring, a DC current potential can be produced. As in the previous embodiments, it should be understood that any suitable types of magnets may be used.

When plasma enters slit 116, the plasma's ions and electrons are alternatively attracted or repelled by the magnetic fields generated by magnets 104, 105 and conduct through the shells 101, 102 and the electrically conductive electrode 103. The magnetic field separates the ions and electrons, allowing an electrical potential to be created between the shells and electrodes, with current being withdrawn via electrical contact brushes 106, 108 and 112, allowing work to be done via load 110. As shown, motor 109 drives rotation of the single rotating MHD assembly of FIG. 9A.

As a non-limiting example, if a hydrocarbon is fed to plasma torch 111, the resultant plasma's ions and electrons are directed alternatively to shells' 102, 101 and means electrode 103, which is rotating, resulting in the rapid cooling of the plasma, freeing hydrogen, and condensing a solid carbonaceous material or other materials envisioned in FIG. 8. The carbonaceous, or other materials are centrifugally expelled. It is noted that the carbonaceous material (or other materials) may be “flung” from the rotating electrode 103 under centrifugal force.

It should be understood that the various materials previously discussed may also be produced by the device of FIG. 9A. Similarly, linear motion, vibrator 118 (and/or 120), such as that described above with regard to the previous embodiments, may also be employed. A second vibrator “twin” to vibrator 120 can also be connected to the motor side of shaft 115 to permit an angular motion to the rotating device, thus decreasing the contact area with the plasma.

Coolant can be pumped into pipe shaft 115, and exit through pipe shaft 114, where the pipe shafts 114, 115 serve as the axle of electrode 103 which is driven by motor 109. Electrical Insulators 107 and 113 allow for cooling fluid to enter and be heated by the plasma while maintaining electrical separation between the electrodes. The cooling fluid flows through the interior of hollow electrode/conductor 103 while operation is underway. The insulators prevent electrical interaction between the shells 101, 102 and the shafts 114, 115.

The device of FIG. 9B is similar to that of FIG. 9A. However, the internal ring magnets of FIG. 9A have been replaced by external magnets 904, 905, which may be any suitable type of magnets (including ring-type magnets) mounted external to the rotating chamber defined by conductive shells 917, 920. In operation, once the rotating electrode/conductor 919 and the rest of the connected rotating elements has reached optimal rotational speed (driven by motor 909), providing thermal protection of the electrode/conductor 919, 920, 917 from the plasma's contact, the plasma torch 911 can be energized to emit a plasma between the opening formed between the conductive electrode shells 917, 920.

As the plasma enters through the slit into chamber 918, the magnetic assemblies 904 and 905, which may have opposite polarities, N—S direct the ions and the electrons of the plasma to contact either shell 917, 920, or 925, or to contact electrode 919. This creates the magnetohydrodynamic generation effect MHD. The electrical insulators 907, 913 prevent the three conductive sections from electrically contacting one another. An electrical potential is created, which may be used to transfer a current via electrical contact brushes 906, 908 and 922, allowing useful work to be done through load 910.

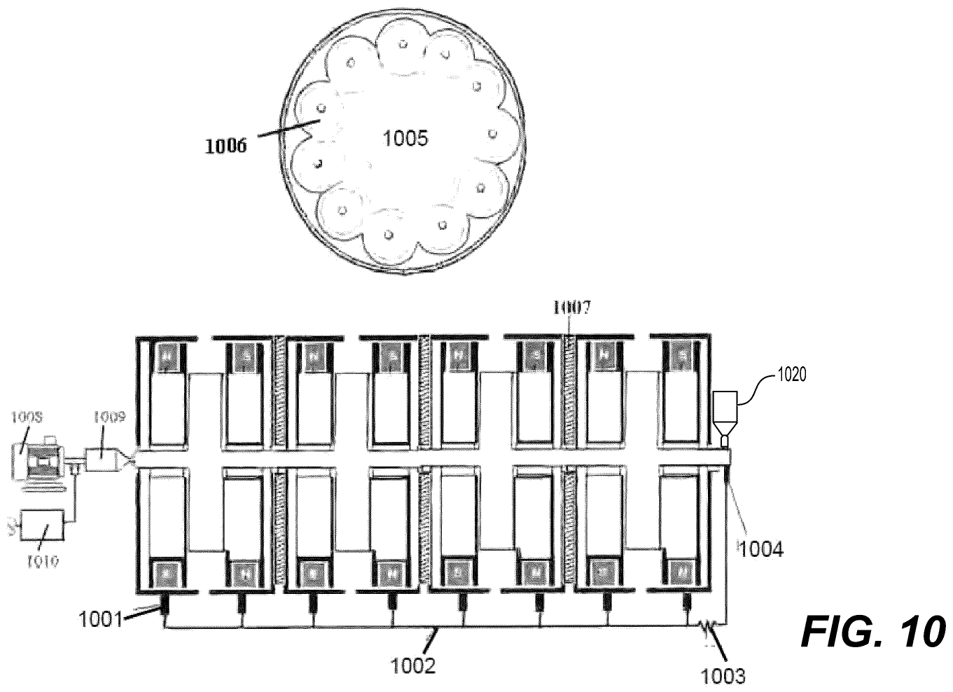

Cooling fluid may be introduced through hollow shaft 915 and may be withdrawn through hollow shaft 914. Under the influence of centrifugal force, the coolest cooling fluid (which will be the densest) will be driven to the interior surface of rotating conductor 919, putting it into contact with the hottest region of area 918, optimizing heat transfer from rotating conductor 919 to the cooling fluid. As in the previous embodiments, the device may also include linear actuators, vibrators 916 and/or 921, which provides motion in a different dimension when added to the device's rotation. The vibrating transducer 921 of FIG. 10 can also be paired with a similar transducer connecting with shaft 915 on the motor side of the shaft, allowing for angular adjustment of the rotating device so that its surfaces can cover larger areas with respect to the plasma's impact.

The device of FIG. 10 provides significant protection for large areas of the inner chamber surfaces from the plasma's intense thermal and neutral particle bombardment which otherwise would be impacting the walls, which can thermally degrade the chamber's structural integrity while also contaminating any output materials created.

The researchers have tried numerous methods of protecting a plasma chamber's walls from thermal and neutron damage caused by hot plasma entering the chamber's interior spaces. This can be a serious concern with thermonuclear fusion producing devices. Even if the chamber is partially evacuated and the density of the plasma greatly reduced, its immense thermal and neutral particle energy will aggressively impact the walls of the chamber and can produce damage even during short periods of operation. Many methods utilize high temperature resistant metals which are expensive and hard to machine, and in addition to the use of sacrificial thermal claddings, are generally required to increase survival of its components, but none have been shown to be able to withstand the full damaging environmental effects for the extended periods of operation that a practical commercial fusion reactor would require.

The quantity of plasma produced in current fusion reactors requires the shutdown and refurbishment of the chamber's interior on a regular basis which includes the added complication for the handling of radioactive materials, functionally making the use of current technology economically impractical as well. The use of the methods discussed greatly reduces damage. potentially even in these extreme environments. A series of devices, such as those shown in FIGS. 9A and 9B, could, when joined together, stand to serve as a barrier between the plasma and the chamber's interior components, providing protection over larger areas of the chamber and its components. Such protection may also be provided by stacking a series of the devices of FIG. 9A, 9B or 10. This arrangement also provides a method of withdrawing additional electrical energy while also allowing for the recovery of thermal energy through the device's internal heat exchanges, thus providing protection to the interior components while also helping the internal elements survive for extended periods of time in the hostile environment, reducing the need for regular maintenance. As with the previously discussed methods of mitigating the damaging effects from plasma contact, by arranging these multiple rotating surfaces to effectively create thermally renewing walls between the plasma and the inner chamber. Rotation provides for massive reduction in the formation of nucleation sites on the rotating surfaces and also allows the heat exchange fluids 1 to contact the exposed surfaces on a 360° basis, where traditional embedded heat exchange pipes would experience a hot side and a cold side making them less efficient for absorbing thermal energy and his temperature differences also creates thermal stresses within their structure.

The rotating magnetohydrodynamic generator of FIG. 10 is similar to the device of FIGS. 9A, 9B, but includes multiple rotating cylinders, each similar in construction to the single rotating electrode/conductor of FIGS. 9A, 9B. Due to the protection afforded from the cylinders' rotation with a rotating heat exchange and the device's direct electrical conversion ability, which also provides an additional cooling effect, this configuration serves to greatly decrease the formation of thermally induced nucleation sites where thermal damage originates. This allows the device to be able to withstand significantly higher exposure from the intense environment for long periods of operation.

The multiple rotating cylinders of FIG. 10 may be either electrically connected in parallel, electrically isolated from one another, or electrically connected in series, while also being mechanically joined to one another (as shown), thus permitting the rotation of all cylinders, serving to shield the chamber walls behind them. If the electrical insulators 1007 are removed, the device of FIG. 10 will form a series connection between the cylinders, thus boosting output voltage. By having an electric insulator between the adjacent cylinders, the device can operate in parallel.

The use of the insulators 1007, along with appropriate electrical connections, could also allow the device's cylinders to operate independently. Additional thermal protection can also be achieved by using multiple layers of the rotating cylinders, each positioned in front of the other. Preferably, in such an arrangement, the rotating cylinders would be axially offset from one another to afford protection to the gap areas between each of the inner fronting cylinders. This also allows for greater electrical energy production potential due to the multiplication of the aligned rotating cylinders.

The rotating hydrodynamic or magnetohydrodynamic generator's (RHG's) circular motion, in addition to preventing thermal damage created by nucleation sites, is constantly presenting new, multiple, hard atomic nuclei tangentially to the impacting plasma's reactive ions, electrons and neutral species. This greatly increases the probability of the neutral particles being deflected rather than absorbed, which reduces potential damage to its surface and internal components. Due to its rotary motion and the fact that it is entirely within the containment chamber, it also serves to greatly improve its heat exchanging function since the device is able to absorb heat from 3600 rather than from just a single surface direction that a heat exchanger embedded in the chamber's walls would. The rotation continuously allows for fresh surfaces to be presented to the intense thermal energy of the plasma and allows all the surfaces to evenly absorb the thermal flux.

In operation, when the motor 1008 is powered on, a column consisting of a stack of energy absorbing RMHGs starts rotating. If high heat and neutral particle impact warrants its use, a vibrator 1009 (and/or 102, 1020) may be energized. If two linear actuators, vibrators are used, this will produce a three-dimensional movement of the cylinder when combined with the rotation of the cylinder, reducing exposure. As discussed above with regard to the previous embodiments, any suitable type of actuator may be used.

As discussed above with regard to the previous embodiments, electrical contact brushes 1001, connected through wire 1002, allow current to be generated in a similar manner to the previous embodiments, which may be connected across load 1003. When the plasma 1005 has been created inside the interior of chamber 1006, the rotating cylinders protect the chamber walls while also recovering useful electrical current.

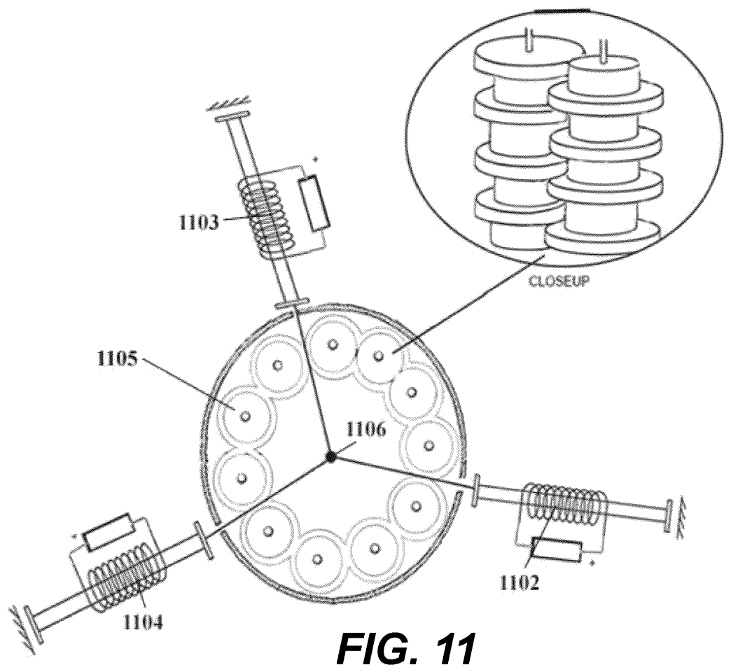

FIG. 11 illustrates protection of the inner chamber surfaces of any high temperature generation system, such as, but not limited to, a combustion-based system, a plasma-based system, a fission reaction chamber, or a fusion reaction chamber, such as, as a non-limiting example, the reaction chamber of an inertial confinement fusion reactor (i.e., laser-induced fusion). The walls of the chamber are lined and protected by a series of rotating cylinders 1105, such as those discussed above with regard to FIG. 10 or any other suitable one(s) of the embodiments disclosed herein. These high temperature rotating protective assemblies are composed of multiple layers of interconnecting devices, such as those described above with regard to FIGS. 2A, 3, 9A, and 9B. Multiple sections of, as a non-limiting example, the device shown in FIG. 2A, join together to make a column, such as shown in the inset of FIG. 11, where all of the segments move in unison to protect large areas of the chamber. As discussed above with regard to the previous embodiments, such an arrangement allows for conversion of the plasma impact into electrical energy, as well as providing protection to the chamber walls from thermal and/or plasma damage.

Additionally, as discussed above with regard to the previous embodiments, thermal energy is also recovered by the heat exchange fluid flowing through the interior of the rotating system. Since the exposed surfaces are in motion (i.e., rotating), the heat exchanger properties function at higher efficiency than an embedded stationary heat exchanger. This is due to the outer facing “hot” surface being able to absorb thermal energy from a full 360°, rather than the 180° or less that a traditional embedded heat exchanger would be able to accomplish. This reduces thermal stress which occurs when extremely high temperatures are on one side of a heat exchanger and ambient temperatures are on the other.

The rotation also provides uniform temperature distribution over the surface. Additional vibration (as discussed above with regard to the previous embodiments) and/or the rotation discussed above, increases the rate of heat transfer due to disruptions of the boundary layers and limits the time any one point is exposed to the thermal impact, thus preventing formation of thermal nucleation sites.

In the non-limiting example of FIG. 11, which illustrates a method applying energy to an object or a region in the center of a high temperature reaction chamber. Through the gaps between the rotating protective members affords a method of a directed energy beam to enter the space and intensify focused energy into the interior of the chamber. An inertial confinement fusion reactor could be one method where this capability and the need of protecting the chamber could find utility. In an inertial confinement fusion device, a rounded pellet 1106 containing hydrogen or hydrogen, deuterium and/or tritium, is placed at the center of the chamber where multiple laser beams (produced by lasers 1102, 1103 and 1104) intersect. Uniform compression of the pellet results in a fusion reaction.

In the embodiment of FIG. 12A, the cavity space 1216 positioned between four or more intersecting rotating discs 1206, 1207, 1205 and 1208 is designed to compress a plasma, proton or electron stream emitted from a plasma or from a combustion process into the area 1216. This system can be used with any one of the suitable embodiments described above. It can also serve as an element in a device called an “undulator”. Undulator magnetic assemblies are used to amplify and modulate the electron beam used in x-ray free electron lasers (FELs). Undulators consist of multiple magnetic assemblies of opposite magnetic polarity facing each other and arranged perpendicularly to the electron or plasma beam passing through the center opening 1216 between the alternate polarity magnet assemblies.

The undulator of FIG. 12A includes multiple aligned arrays of the magnets 1227, 1228 and 1229. As the beam transits through the cavity areas 1216 of the undulator assembly, the first group of, as a non-limiting example, north/south magnetic assemblies, the beam will then project into another in-line magnetic undulator assembly where the magnetic poles are reversed into an opposite (e.g., south/north) configuration, resulting in the alternating attraction and repulsion of the electron beam. This action by the undulator increases the speed of the beam while also promoting the formation of x-rays.

The undulator assembly 1227 shows a method to both wiggle the plasma, proton or electron beam, producing x-rays, but also allows for an electric current to be conducted across the plasma, which increases its speed, temperature and particle interactions, and also allows for increased generation of the x-ray output. As an alternative, it could also connect its electrodes to a load forming a multiple MHD undulator system which could provide increased electric recovery from a high energy plasma.

The undulator configuration 1228 of FIG. 12A presents north-to-south and then south-to-north magnetic alignments to the transiting plasma stream. This is somewhat similar to traditional undulators; however, the configuration of FIG. 12A applies north-south magnetic fields from four angles instead of the standard two. This causes the plasma, proton or electron beam to wiggle in an extra dimension, as well as introducing rotational motion to the electrons and the resulting x-ray output. This potentially increases the x-ray energy when it contacts a surface. Also, due to the protection afforded by the rotating means allows the magnets to be placed in much closer proximity to the transiting plasma, proton, electron or x-ray source.

The undulator configuration 1229 has opposing north-to-north and south-to-south magnetic alignments. This introduces a repulsive force to the plasma, proton or electron beam, thus compressing it. As a beam moves into the next series of magnetic assemblies in the undulator, the magnetic poles are reversed, thus introducing a wiggle to the electron beam, promoting the output of x-rays while continuing the repulsive compressive action.

The intensified electron beam is mechanically and magnetically compressed by the rotating magnetic assembly. The beam, while being mostly composed of high-speed electrons, may also include associated plasma ions as it enters into the intersection cavity 1216 where the rotating cylinders reach their apogee point in relationship to the other discs, resulting in the Monroe effect. As is well-known in the field of explosives, the Monroe effect occurs when an explosive shock wave is concentrated by a funnel-shaped structure which serves to greatly enhance the energy level, temperature and relative speed of the explosive wave front. This same process is produced by the four or more rotating magnetic assemblies shown in FIG. 12A. This process can also be accomplished by the twin discs 1221 where the electron or proton beam, plasma, or other transiting energies are concentrated by the funnel-like shape formed by the multiple discs' combined shape, which focuses the wave front at the closest approach at the gap between the rotating discs. Two or more of the dual rotating assemblies in 1221 can be configured to produce an undulator array for imparting a wiggle to the transiting proton, plasma or electron beam.

This multiple disc-focusing structure consists of a system of rotating discs with an alternative magnetic repulsive configuration, consisting of aligned poles where the facing rotating magnets are of the same polarity, such as, for example, north-to-north or south-to-south, which increases the magnetic compressive forces. In a north-north plasma interaction, the magnetic repulsion creates an area of elevated magnetic pressure. This pressure significantly confines the intervening plasma, restricting the movement of its charged particles. Additionally, opposing magnetic field lines undergo a process called magnetic reconnection where they break and then reconfigure their alignment. This event unleashes large amounts of energy stored in the tensioned magnetic fields. Energy release of the magnetic fields contains compressed potential energy under extensive internal pressure. During the reconnection event, this tension is released, accelerating the plasma particles outward at high speeds and transforming a significant portion of the magnetic field energy into kinetic and thermal energy. This same process in the other MHD systems is discussed here. This process (on a much larger scale) is the same driving force seen in solar flares.

In FIG. 12A, the polarities of 1229 share common magnetic orientations of that of the opposing magnet's surfaces (north-to-north and south-to-south), serving to compress and intensify the energies of a plasma stream, but could also be used to elevate the energy level of an electron or proton beam. Since the beam's electrons or ions are polarized, in order to prevent possible undesirable bending of the beam by the magnetic fields, such magnetic assemblies should be used in pairs with alternating magnetic polarization in order to remove the bending force, if so desired.

In this embodiment, each magnetic assembly arrangement would be configured differently as in 1230 and would have the facing magnet disc surfaces 1205 and 1206 oriented north-to-north, while discs 1207 and 1208 could be configured to present a south-to-south repulsive polarity. It is noted that the charged plasma particles would experience forces when they move within a north-to-south magnetic field, such as would be provided by the main central magnet configuration of FIG. 12A.

The force from a magnetic field causes the charged particles to spiral around the magnetic field lines and causes electrons and ions to rapidly spiral in opposite directions. If this magnetic field is strong enough, it can confine the plasma, restricting its motion and preventing it from spreading out, thus creating additional potential energy.

In a configuration with opposing magnetic fields, an attractive force is created. The magnetic field lines in this configuration will curve and connect between the opposing poles. Plasma which is introduced into the region between the facing magnets experiences a compressive effect. During this reaction, the plasma particles are accelerated to high speeds, forming jets and causing the plasma to rapidly heat up far in excess of its previous high temperature, resulting in a denser level of ionization. Bursts of light and other forms of electromagnetic radiation can also be emitted. The result is a pinch-like effect which causes the plasma to rapidly densify, creating conditions where nuclear reactions (potentially including fusion) may occur.

As discussed with regard to the previous embodiments, the rapid rotation of the discs also disrupts the formation of thermally induced nucleation sites and reduces damage from neutral particles. This allows the magnetic assembly to be located in closer physical proximity to the potentially damaging energies of the plasma, proton or electron beam. By allowing the magnets to be able to function in closer proximity to the beam, it has the added benefit of higher magnetic flux interactions with the transiting plasma. This results in superior beam confinement, acceleration and efficiency. The repulsive magnetic force largely prevents any physical contact from most particles of the beam with the discs' surfaces, which further reduces parasitic thermal losses and preserves the beam's energy levels.

An infrared (IR) reflective coating, such as, for example, gold, may be applied to the rotating cylinders, allowing IR energy to be reflected back to the plasma, thus reducing radiant energy loss from the beam. Such a system could make use of the parabolic reflector system of FIG. 12A. This system can, in addition to reflecting IR, focus ultrasonic, RF, microwave and/or submillimeter radiation onto the plasma stream. The high spin rate of the rotating elements of the device would allow such a coating to remain in a high temperature environment without damage for a considerable amount of time.

To increase the speed, energy and level of ionization of the ion/electron plasma flow (or other conductive fluids), two of the opposing discs 1230 and 1231 can be configured to act as electrodes with a DC potential, applying a current across the conductive plasma to the other rotating electrode, thus producing a force in response to the magnetic fields, as discussed above with regard to the previous embodiments.

The transducer's linear motion can induce a back-and-forth vibration or position the rotating means to expose different areas of its surface as discussed above with regard to the previous embodiments may also be applied to the assembly of FIG. 12A. In the non-limiting example of FIG. 12A, ultrasound transducers 1213A-1213D move the discs (as they are rotated with additional transducers moving in different directions, producing 2D or 3D motion) backwards and forwards at the same time, creating a sinusoidal movement in the flowing plasma. While an assembly consisting of four discs is shown, it should be understood that six, eight or more discs could also be used.

The linear transducers can include ultrasonic types. 1213A-1213D and/or 1235A-1235D connected to the rotating discs, through the combined movement of the discs, alter the plasma or electron flow, changing it into a three-dimensional sinusoidal wave formed in response to the movement of the magnets and the combined shapes of the round disc surfaces. This serves to both physically compress and magnetically pinch the ion and/or electron stream created by rapidly closing and then opening the distance in relationship to the magnetic fields of the opposing rotating magnetic assembly in a synchronized manner. This movement serves to alternately increase and decrease the magnetic field strength impinging on the intervening electron/plasma as it transits aperture 1216. In addition to, or independent of this movement, should electromagnets or superconducting magnets be used, then a similar or enhanced sinusoidal effect would be produced in the ionic stream when a pulsing electrical frequency is applied to the magnetic coils. This could be performed independently, or in addition to, and coordinated with the physical movement of the magnetic assemblies which produce greater reactive energies impinging on the plasma stream. As discussed above, this rapid linear vibrational movement of the discs causes both expansion and compression of the transcending plasma. During the pinch phase, the plasma compression increases its heat potential in these new areas significantly and if the forces are great enough may produce plasma luminescence, similar to the previously discussed Sonoluminescent effect and/or plasma detonation at high energies.

FIG. 12B illustrates the use of parabolic reflectors to intensify infrared, RF, microwaves, sub-millimeter waves and ultrasound, focused on a small area of the transiting plasma. This increases overall efficiency by reflecting back onto the plasma various wavelengths being emitted by the transiting plasma stream through the use of parabolic impressions 1212. Such reflectors may be used for intensifying the plasma energy and temperature in any of the previous embodiments. This permits a portion of the energy emanating from the energized plasma stream 1226 to be focused back, creating a point of intense concentration in the center area 1217 of the transiting plasma as parabolic reflectors 1218 and 1219 can be adjusted to focus on common point 1217, creating amplified energy at this intersection point. The resulting focal point of these energies is located between the rotating discs to improve the device's overall efficiency. If the discs are stimulated with an ultrasonic transducer, then an intensified sonic wave will converge onto the same common focal point at the center 1217 of the plasma stream, allowing for enhanced reactions to occur in this zone. These reactions include sonoluminescent-like effects to further intensify the plasma into a higher amplified state.

Additionally, RF, microwaves, or sub-millimeter waves may also be focused by the parabolic reflectors on the rotating cylinders, helping to focus and amplify these energies onto a common focal point at the center of the transiting plasma stream. As a non-limiting example, the parabolic reflectors may be coated with gold, which is very efficient at reflecting energies in the infrared region.

The point in time when the focal points from the two rotating discs are in alignment can be coordinated with an energy pulse from a laser, proton beam source, X-ray source, sub-millimeter wave source, or electron beam pumping additional energies into this minute area, as shown in FIG. 12B. This can further be synchronized to coincide with a PL (plasma luminescent) cavitation bubble's collapse, where additional energy is generated by the compression of the plasma. If these parabolic rotating elements are configured into the rotating MHD devices described here, this pulse of energy would serve to greatly increase levels of ionization while also producing greater ionization in the surrounding plasma as well, due to particle interactions emanating from the central focused cavitation area. This serves to greatly increase the efficiency and energy recovery abilities of the MHD device.

The device of FIG. 12C can be used to further intensify the thermal and ionic energy created at the plasma bubble's PD (plasma detonation) event site during the moment of the bubble's cavity subsequent rapid collapse. A high energy laser, proton beam, x-ray beam or electron pulse is focused on the area of the PL bubble's formation. The beam is timed to arrive at the moment of its highest thermal and ionic energy, which is approximately the moment of the bubble's collapse. Beams emitted from a laser, x-ray source, proton beam source, electron beam source, microwave source and/or sub-millimeter wave source 1225A, 1225B, 1225C and 1225D are focused on the approximate site of the PL cavitation bubble's collapse. Although only four sources are shown, it should be understood that any number of sources may be used, such as, for example, any number of sources between one and sixty.

As the hot plasma's ion and electron streams transit the opening between the rotary discs, consisting of either of the assemblies 1227, 1228 or 1232, the plasma's thermal temperature increases. This temperature increase is produced by the mechanical and magnetic compression effects exerted on the plasma stream as it enters the center aperture between the rotating discs. The device favors production of a single plasma bubble PL effect, but a multi-bubble event could be produced depending upon numerous factors. These include the speed of rotation of the rotating discs, the inlet plasma temperature, and the ionic density.

The magnetic assembly 1232 is shown with opposing polarity of the magnets in an attractive arrangement. In magnetic assembly 1232, the opposing magnetic fields create attractive forces. The magnetic field lines will curve and connect between the opposing poles. Plasma that is introduced into the region between the opposing magnets experiences a compressive effect. Charged particles will spiral tightly along the converging magnetic field lines pulled inwards by the magnetic attraction. Under a strong enough magnetic field, the compression can be acute. This is called the “pinch effect,” where the plasma is squeezed into a highly dense filament-like structure along with the axis connections between the magnetic poles. As the plasma stream exits this area of magnetic field influence and as it passes through the rotating discs, a large amount of energy is released. This results in the process of magnetic reconnection, which is considered an extreme process where the stored energy in the magnetic fields is suddenly released to produce kinetic energy. During this reaction, the plasma particles are accelerated to high speeds, forming jets and causing the plasma to rapidly heat up far in excess of its previous high temperature, resulting in a denser ionization condition. Bursts of light and other forms of electromagnetic radiation can also be emitted.

The rotating system 1232 projects attractive magnetic forces across the plasma, coinciding with the intersecting high energy beams, creating an energetic environment where the potential for nuclear reactions could occur. The assembly 1228 shows a similar constructed device, but with opposing magnetic fields of similar magnetic polarity producing repulsively interacting magnetic fields. In a N—N and S—S plasma interaction, the magnetic repulsion creates an area of elevated magnetic pressure. This pressure can confine the intervening plasma restricting the movement of its charged particles. Additionally, opposing magnetic field lines undergo a process called magnetic reconnection where they break and then reconfigure their alignment. This event unleashes large amounts of energy stored in the tensioned magnetic fields. The resulting energy release of magnetic fields contains compressed potential energy under extensive internal pressure. During the reconnection event, this tension is released accelerating the plasma particles outward at speeds potentially approaching relativistic and transforming a significant portion of the magnetic field energy into kinetic and thermal energy. This process on a larger scale is the same driving force seen in solar flares.

The assembly 1227 can be configured to operate as a magnetohydrodynamic propulsion device which can be used to increase the intervening plasma's velocity and energy This is accomplished by providing an electric current across two of the rotating electrode assemblies. The system can also be configured to recover electrical energy from the intervening plasma through the same electrodes, if the electrodes are connected to a load, which would allow for the recovery of electrical energy from the ionic plasma.

The rapid rotation of the magnetic fields emanating from the discs serves to disrupt boundary layer formation and reduces contact time with the plasma, providing additional thermal protection. This allows its surfaces to be in closer vicinity to the extremely energetic plasma stream without being damaged, producing increased efficiency because less energy would be required by either an electromagnet or a superconducting magnet. Permanent magnets could also be utilized and operate far closer to the plasma than would otherwise be possible due to the thermal protection provided by the rapid rotation and would have the effect of increasing the magnetic field strength applied to the plasma stream. The highly magnetic fields compress the plasma, increasing its density, creating conditions favorable for induced plasma detonation.

While a four-disc arrangement is shown, it should be understood that any suitable number of discs may be used, such as six, eight or twelve-disc configurations. All the devices described here in FIG. 12C can also be configured to produce and recover atomic hydrogen, transporting it in a similar manner to that described above with respect to FIG. 6. The devices can also function in a liquefied environment, such as, as a non-limiting example, liquid hydrogen. Liquid hydrogen is approximately 853 times denser than gaseous hydrogen. This is a far denser environment which compacts significantly higher concentrations of hydrogen nuclei at the point of the sonic, ultrasonic, magnetic, RF cavitation PL site as described previously. This area could be the region where amplified energy evolves at the intersecting focal points of the parabolic impressions on the rotating surfaces, as shown in FIG. 12A, from the focused ultrasound, x-ray beam, laser beam, microwave beam, RF, sub-millimeter beam, proton beam, neutron beam or electron beam. This energetic injection can be focused to occur at the same area and time to coincide with the ultrasound cavitation bubble's collapse, increasing the area's energetic amplification exponentially.

A liquid cryogenic element, such as, as a non-limiting example, hydrogen, which is largely non-compressible, produces conditions favorable for enhanced sonic or ultrasonic energy delivery. This allows for the more efficient creation of a sonoluminescent-like PL effect which allows for extreme temperature swings to occur during the bubble's formation and/or subsequent collapse. During the bubble's collapse, rapid thermal energy amplification occurs, creating a hot, reactive ionized zone for a short interval of time, creating the potential for plasma detonation (PD).

Hydrogen gas (H₂), in a non-plasma state, has a limited response to magnetic fields. It has been considered that monatomic hydrogen, including gas recovered by the device described above with respect to FIG. 6, could be collected and used. The magnet encircling the collection tube serves to prevent the atomic hydrogen (H⁺) (and 2 electrons) from recombining into H₂. After collection, it could pass through a cryogenic refrigerator where the H₁, being maintained by magnetic fields, will be condensed into its concentrated cryogenic liquid state. As discussed above, the H₁ in a cryogenic state is resistant to conversion back into its H₂ form if it is not unduly agitated, thus allowing for long term storage.

Monatomic hydrogen is generally more responsive to magnetic fields, thus, in this state, it can be utilized in most of the above-described embodiments. In this configuration with a liquid medium, the rotating sonically stimulated magnetic assemblies result in a somewhat greater speed of collapse of the induced bubble, producing a potentially higher level of thermal energy during the collapse event where PD may occur. By non-limiting example, other gases mentioned in this document could be used as well in a cryogenic liquid state.

Returning to FIG. 12A, the device begins by the rotation of the discs by motors 1201, 1202, 1203 and 1204. When the discs are spinning, sonic, ultrasonic, RF, sub-millimeter, or microwave transducers 1213A-1213D and/or 1235A-1235D are energized by power supplies 1215A-1215D, respectively. The interaction of the various transducers not only permits a sonoluminescent-like effect, PL, encouraging a PD event to occur in the plasma stream entering aperture 1216, but these small movements have the additional benefit of averaging out and centering the magnetic field lines. Magnetic field lines will normally wander, but under high energy and thermal stress conditions can do so even more. This causes plasma leakage around the magnetic field lines, but such leakage is largely prevented by the relatively minimal sonic or ultrasonic-induced movement caused by the transducers 1235A-1235D. This is further enhanced by the rotation of the magnetic discs, which tends to average and center the field lines, preventing magnetic field leakage

These transducers also have the ability to keep the extremely hot plasma from causing thermal damage to the rotating discs and magnets by introducing additional degrees of motion to the discs, now each moving in two dimensions, and if the two sets of transducers are used together along with the rotation, this movement will be in three dimensions, thus further enhancing resistance of the surfaces to damaging impacts of the plasma. This reduces the time the plasma can be in contact with any single area of the rotating cylinder to an even greater degree, allowing the spinning discs to be able to withstand thermal and neutral particle degradation from the impacting plasma to a greater extent. The device of FIG. 12A produces four intersecting sonic or ultrasonic waves which can be arranged to produce constructive interference to increase the intensity while creating areas of alternating increased and then decreased plasma density. Magnetic compression produced by magnets 1210, 1211, 1212 and 1209 apply additional densification force, when in the arrangement described in 1230, 1231 to the center point of the plasma stream.

The arrangement of FIG. 12B enhances the rate and density of the output in the plasma stream exiting the aperture 1216 created by the rotating plasma compression assembly. In this configuration, the energetic beam(s) are timed to produce beams of amplified energy which enter and intersect with the collapsing sonoluminescent, PL plasma bubble, with sufficient energy may produce the PD event. This adds additional energy to the already energetic plasma stream at the moment of a potential plasma detonation event resulting from the bubble's compressive collapse, which multiplies its energy state dramatically. If the laser (shown in FIG. 12C) is sufficiently energetic and in the UV part of the spectrum, then powerful x-rays can be produced as the photon produces interactions with the rapidly moving surfaces. Infrared lasers can also be utilized.

Lasers properly timed to occur at the moment of the cavitation plasma bubble's collapse can also add considerable compressive force which increases the resulting energy levels at the focal point.

Referring to FIG. 13, inductively coupled plasma (ICP) is a type of plasma produced by radio waves in the 2 kHz to 75 GHz frequency range (as a non-limiting example). Further, more focused frequency ranges are achievable, in the alternative. Electromagnetic induction, which is normally coupled to an inert gas, can work with many other types of gases and materials, including those which have already been converted into a plasma state. In operation, the magnetic field induces an electric current within the gas, which creates the plasma or can add or boost an existing plasma stream's energy state. This inductively coupled gas can easily produce plasma with temperatures up to and exceeding 10,000 K before any additional potential RF or sub-millimeter boosting. Energetic elevation or boosting achieved by this method has the additional benefit of not introducing contaminants from an arc and does not have the associated wear issues.

The device shown in FIG. 13 is a Resonant Plasma Amplifier (RPA). The device includes inductively coupled coils 1304, 1305 and 1306, which are connected to power supplies 1301, 1302 and 1303, respectively. Although FIG. 13 illustrates a three-step amplifier, it should be understood that any suitable number of coils may be used. When the plasma torch 1307 (or any other suitable plasma source if used) is energized by power supply 1310, the gases are introduced via pipes 1308, 1309 and are stimulated into their plasma state.

The power supply 1301, which may be an RF power supply, as a non-limiting example, is turned on and any of the MHD devices of the previous embodiments with electrical recovery placed in front of the output of the tube 1311 will produce an electric output in relation to the ionic energy of the incoming plasma stream. Alternatively, the velocity of the plasma can be increased through the use of any of the magnetohydrodynamic propulsion systems discussed above.

When plasma encounters an inductive magnetic field, energy is initially lost as it matches the frequency of the field. Energy is also lost as it leaves the field, but as plasma of one frequency encounters a second or third field at the harmonic of the first, these energy losses are greatly reduced. Instead of one continuous inductively coupled single stage, the system of FIG. 13 increases the plasma's energy through a series of multiple interactions, increasing the frequency one octave at a time, or a fraction thereof, at each stage. This allows for a greater increase in efficiency for the process. As a non-limiting example, the plasma torch 1307 can be set to a frequency of approximately 85.5 kHz by the power supply 1310. The plasma then moves down the tube 1311, encountering the coil 1304 with its frequency produced by power generating unit 1301. This frequency could initially be set around 181 kHz.

The frequency of coil 1304 is finely adjusted to an exact frequency where the greatest amount of electrical recovery is produced by the MHD electrical generating device, not shown. As the plasma passes this coil moving down tube 1311, it then enters the fields of coil 1305, which are initially set to a frequency of approximately 271.5 kHz, creating a third harmonic which is one octave above that of coil 1304. As the plasma enters the induction fields of coil 1305, its frequency is adjusted to the frequency producing the greatest level of electrical recovery. The transiting plasma next encounters the inductive fields of coil 1306, which is initially adjusted to a frequency of approximately 362 kHz, and its frequency is then finely adjusted where the highest amount of electrical recovery is produced by the rotary MHDG cylinder, such as that described above with regard to FIG. 2A or any of the other MHD Generating devices described herein.

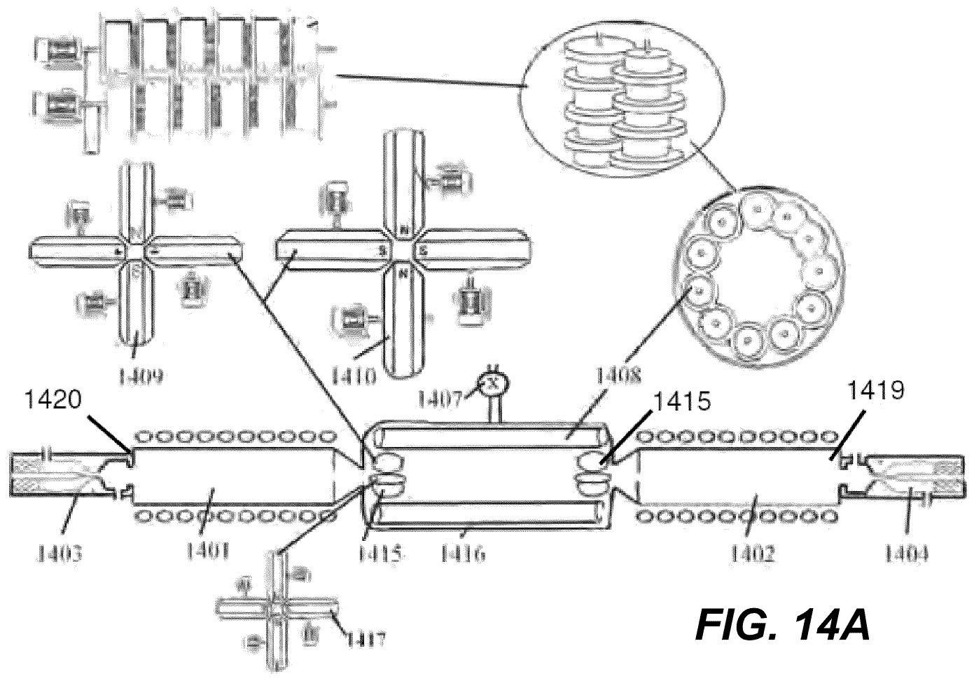

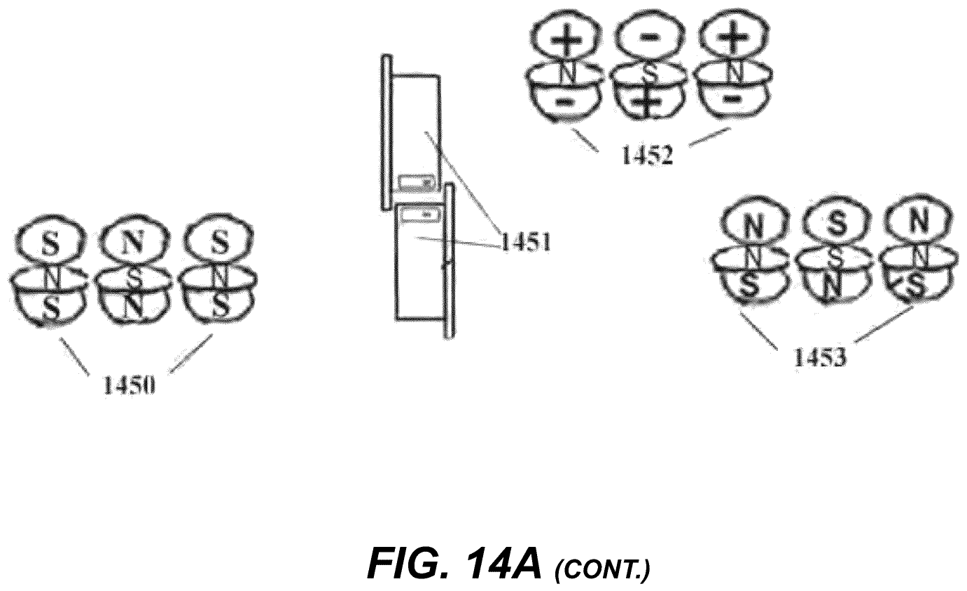

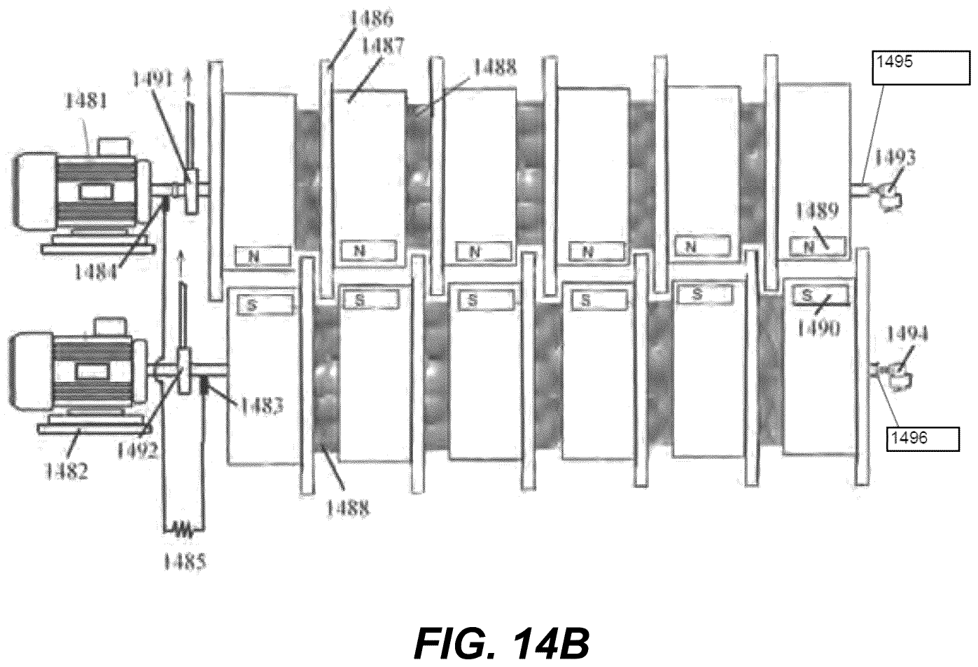

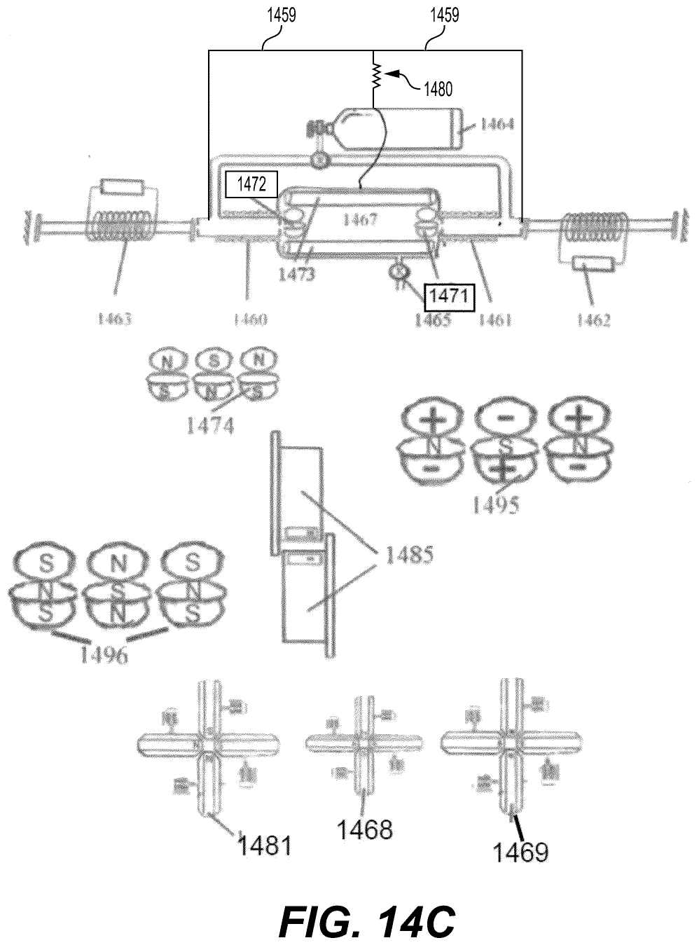

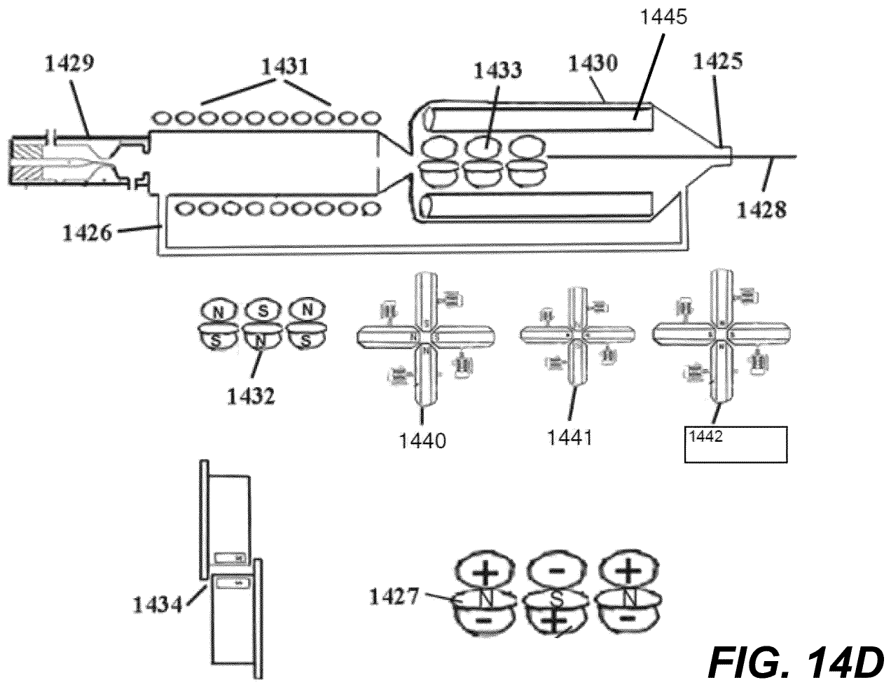

The device shown in FIG. 14A produces intense interactions between two intersecting streams of plasma. It also allows for the management of larger quantities of plasma where a single plasma recovery converter, such as that described above, would be insufficient for its greater electrical recovery demands. A larger chamber also has added requirements for the protection of its wall area and greater needs for electrical and thermal recovery. In FIG. 14A, the cylinder 1408, similar to that shown in FIG. 10, as described above, or FIG. 14B, as described below, or a rotating non-electric recovery cylinder are arranged to line the walls of chamber 1416. The cylinders 1408 are positioned between the interior of the chamber and the chamber's outer wall. These elements can be arranged to provide one or more layers of the rotating column system, depending on the level of its operational requirements for both thermal protection and electrical recovery. Due to their location, cylinders 1408 provide protection to the chamber while, at the same time, providing for the direct conversion of the ionic plasma into electricity and also providing a significant recovery of thermal energy, as discussed above with regard to the previous embodiments.

In FIG. 14A, plasma is generated by two plasma torches 1403, 1404, or any other suitable sources of plasma, and may additionally be amplified by inductive amplifiers 1401 and 1402. It is contemplated that this design could be scaled up to include four or more intersecting plasma streams all converging upon a central area. The induction amplifiers 1401, 1402 may operate, as a non-limiting example, in a similar manner to the multi-stage induction amplification design discussed above with regard to FIG. 13. An additional coil magnet may also surround the induction coils 1401 and 1402, serving to compress the plasma and limit the interactions of the plasma with the inductive coil's cylinders 1419 and 1420.

As the plasma flows beyond the inductive field area, it becomes compressed physically and magnetically by rotating discs 1415 which could consist of a magnetic electrode arrangement of either 1409, 1410 or 1417. These assemblies may be similar to any of the previous embodiments, such as, but not limited to, those discussed above with respect to FIG. 12A. The compression of the plasma as it transits through the rotating cavity into chamber 1416, as discussed above, both raises temperature and increases the ionic density. Any of assemblies 1409, 1410, 1417 or 1451 may be used, which are similar to those in the differing embodiments discussed above.

It is also contemplated that the single magnetic assembly 1409, 1410, 1417 or 1451 may be replaced by multiple magnetic undulator assemblies 1450, 1451, 1453 or 1452 in FIG. 14A, (cont.), which allows for magnetically creating a wiggle-like motion in the plasma (or proton/electron beam), thus producing x-rays. Conducting an electric current across the ionized plasma enhances its energy level, increasing its speed, particle interactions and production of x-rays. The alternative undulator assembly 1453 has a north-to-south attractive magnetic alignment before the next group of south-to-north magnets. This is somewhat similar to traditional undulator designs, however, undulator 1453, besides allowing for a closer, more intense magnetic flux to interact with the plasma, also applies magnetic fields originating from four directions instead of the standard two due to the significant protection provided by its rotation and/or vibration. This causes the plasma electron beam to wiggle in an extra dimension, introducing a rotational motion to the plasma, protons or electrons and the resulting x-ray output. This can potentially increase the x-rays' energy's impact when it contacts a surface, intensifying the plasma's interactions and increasing the rate of its effective penetration.

Undulator assembly 1450 has opposing north-to-north and south-to-south magnetic alignments. This introduces a repulsive force to the plasma, proton or electron beam, compressing it. As the beam moves to the next group of magnets in the undulator assembly, the magnetic poles are reversed, which introduces a wiggle motion to the beam, thus promoting the output of x-rays while causing powerful plasma interactions. The magnetic fields transferred between the assemblies maintain the magnetic repulsive compressive force on the plasma stream while adding a rotational motion to the transiting plasma stream. This application of alternating compression serves to intensify the plasma. The device shown in FIG. 12A or the parabolic focusing system of FIG. 12B may be used to create a hot focal point area in the center of the plasma stream, as discussed above with regard to the previous embodiments.

After transiting through the intersecting disc's aperture, the plasma is then allowed to expand as it enters chamber 1416. The chamber's walls could be protected by multiple rotary cylinders 1408 which could also allow the direct recovery of electric energy. The physical rotation of these chamber perimeter cylinders provides a high degree of protection from the impacting thermal energy, evening out the thermal stresses through its full 360° rotation rather than the single direction of a standard heat exchanger. As discussed above, vibration may also be introduced (in one, two or more directions) to provide added protection. Thermal energy can be convectively recovered from the heat exchange fluids flowing into the disc/cylinder assembly and then exiting its hollow interior as a hot fluid via rotary seal connections 1491, 1492, 1493 and 1494, as shown in FIG. 14B.

The addition of a second plasma torch 1404 and induction coil 1402 provides for intersecting plasma streams which collide at extremely high speeds near the center of chamber 1416. The second plasma source 1404 causes an increase of collisions between the two plasma streams to occur. This produces enhanced thermal reactions while additionally increasing the ionic density of the plasma, thus allowing for a higher and a more efficient conversion of the plasma's potential energy.

Should spinning disc arrangement 1409 be used, then two of the spinning disks (represented by +/−polarity designations) introduce a current potential, either DC or AC (while alternating magnetic fields are used) across the ionized plasma. This electric current reacts with the plasma as it transits between the magnetic fields and the rotating electrode disc to produce a rotary magnetohydrodynamic propulsion process, as discussed above with regard to the previous embodiments. This effect serves to increase the speed and energy of the plasma's ions, electrons and neutral particles, which causes a percentage of the plasma ions to collide at high speed. The effect serves to create even higher energies and temperatures near the center of chamber 1416 due in part to the additional energies generated by the intersecting collisions of the plasma beams. It has been contemplated that if the intersecting collisions are powerful enough and sufficiently high temperatures are present then conditions may exist where fusion of atomic nuclei may occur. The protection for the chamber walls discussed above will provide similar protection in the event of a fusion reaction and it should be understood that similar protective measures may be adapted for use in conventional fusion reactors.

In use, induction coil assemblies 1401 and 1402 can provide single step frequency induction or can be similar to that shown in FIG. 13, for example. The device of FIG. 13 increases the energy and frequency of the transiting plasma in a stepped manner before entering chamber 1416 in a multi-step process. The induction coil assemblies 1401 and 1402 may constitute a multi-octave frequency step system, such as that discussed above with regard to FIG. 13.

The electrode element of spinning disc 1409 could be powered by a frequency generator power supply which could be adjusted to induce another and higher harmonic resonance to the plasma stream. An ultrasonic, RF, sub-millimeter wave or microwave transducer, such as that shown in FIG. 12A, may be used to induce a plasma bubble formation of lower pressure plasma cavity between the spinning discs 1409 or 1410, as discussed above, which could have a frequency of, for example, 35 kHz. It would be possible to induce a beat frequency by adjusting the frequency of two of the RF induction coils to correspond with the transducer's wavelength and the point in time of the PD event resulting from the collapse of the plasma bubble generating a point energy zone of compression heat amplification.

Beat frequencies are created when, for example, two acoustic frequencies 200 Hz and 205 Hz intersect, resulting in a constructive beat to be generated at 5 Hz. Since the plasma heating devices possibly stimulate plasma in the megahertz or gigahertz range, when this plasma stream enters the area between the ultrasonically stimulated rotating discs, which may run at, for example, 35 kHz, by having two of the induction coils be adjusted to have a frequency difference of 35,000 Hz (e.g., 1 MHz and 1.00035 MHz), a beat frequency of 35 kHz could be adjusted to occur in coordination with the timing of the collapse of the magnetic plasma bubble, where it would apply an amplified constructive beat pulse. This applies an enhanced beat pulse at the moment of the plasma's highest temperature due to the compression of plasma and the plasma detonation PD event. Thus, the beat frequency applies an additional constructive, complimentary amplitude pulse, resulting in significant momentary amplification of energy to a focused, discreet area where the potential for nuclear events could occur.

This event could be further enhanced through the use of laser beams focused on the point of the collapse site of the sonic bubble, thereby further increasing the resulting energy level at a small point within the plasma stream. This method could be applied to most of the devices of the previous embodiments.

The use of stationary expendable electrodes and magnets contacting the plasma, instead of, but performing similar functions to the rotating devices, would also be able to increase the intensity and speed of the resulting plasma beam through the mechanism of magnetohydrodynamic propulsion if a stationary arrangement is used. A stationary, non-rotating arrangement similar in function to the device shown in FIG. 12A would also function for the compression of the plasma and could likewise utilize a method producing rapid vibrational movement with an ultrasonic, sonic, RF, sub-millimeter, or microwave transducer for the reduction of erosion to the exposed surfaces.

The plasma stream, when it encounters the magnetohydrodynamic generator or propulsion unit, whether stationary or rotating, can apply a magnetic or electric current influence onto the transiting plasma. These assemblies could additionally be sonically stimulated by an electro-mechanical or piezoelectric actuator. This further enhances the thermal energy of the plasma while also forming a sonoluminescent-like bubble PL area within the center cavity created at the intersection point of the rotating disc assemblies. When these bubbles collapse in the trough of the sonic wave, large amplification of heat, electron and ionic energy of the plasma is created in a small area. This effect further serves to increase the interactions and speed of the plasma.

The device shown in FIG. 14B is a stacked configuration of the device shown in FIG. 2A. Although similar to a multiple aligned arrangement of the device of FIG. 2B the device of FIG. 14B includes an electric insulator 1488 providing space for the rotating flange 1486. The shafts 1495 and 1496 are hollow to allow thermal heat recovery fluids to flow through the interior of the stacked energy recovery device. Magnets 1489 and 1490 alternatively attract or repel the plasma's ion and electron stream, forcing it to electrically contact the electrode flange 1486. The introduced fluid, passing through the rotary fluid seals 1491, 1492 is heated by the plasma's contact, and is then extracted at the other side of the column, through rotary seals 1493 and 1494. A series electric conductive pathway from the individual column elements to the brushes 1484 and 1483 allows for an increase in voltage.

It is further contemplated that these columns can be electrically isolated by electrical insulator 1488. In this configuration, power could be removed with separate brushes or induction coils. This allows for the potential of a combination of both parallel and series electrical configuration for different voltage and current requirements. The column consisting of the integral element of FIG. 10 could operate in a similar manner, providing the chamber with protection, while producing electrical and thermal energy recovery. An alternative approach could consist of multiple aligned devices of the type discussed above with regard to FIG. 3, consisting of ring magnets.

The device shown in FIG. 14C is similar to that of FIG. 14A, but makes use of the Wakefield effect, which allows for higher potential temperatures to be achieved efficiently, while also allowing for increased atomic collisions in the densified plasma. It also has the capability of generating or utilizing an electron and/or proton beam with the production of associated x-ray and ultraviolet-to-visible light emissions. This is accomplished by employing lasers 1462, 1463 or a proton beam, such as that produced by an accelerator, injected into the center of the plasma cloud and the aperture of the rotating magnetic devices 1471 and 1472. In addition to laser photons, the Wakefield effect can be initiated by a proton beam, offering a potential method for particle acceleration. This method utilizes a high-energy proton beam which displaces electrons in a plasma, creating a region of positive charge. The displaced electrons subsequently return, generating a strong electric field known as a Wakefield. Charged particles injected into the plasma at the appropriate time can be accelerated by this Wakefield. Proton-driven plasma Wakefield acceleration offers advantages, including higher energy potential and longer acceleration distances compared to electron-driven methods. This approach is supported by ongoing research, notably the AWAKE experiment at CERN. It should be understood that lasers 1462, 1463 may be continuous lasers or pulse lasers, and may operate at any suitable wavelength.

Wakefield acceleration is a technique for accelerating charged particles using an intense laser pulse propagating through a plasma. The laser pulse creates a Wakefield effect, which is a plasma wave that can trap and accelerate electrons to high energies over short distances. The specific type of laser spectrum used in Wakefield acceleration is not as crucial as the overall properties of the laser pulse, such as its intensity, pulse duration and wavelength. However, some laser characteristics are more favorable for efficient acceleration. Powerful electric and or magnetic fields are required for the creation of sufficiently large Wakefield events capable of eliciting strong electron acceleration. Shorter laser pulses create more defined, steeper Wakefield events, producing a higher acceleration gradient over shorter distances. Lasers in the infrared (IR) region are commonly used because they provide a good balance between all the necessary properties.

In operation, the laser beam projects through the cavity centers of induction chambers 1460, 1461 where the inductor coils, which could use the principles of stepped harmonic amplification, as shown in FIG. 13, have previously converted the gases or other materials present into their plasma state. The speed of the laser or proton beam's accelerated electrons and other associated ions can be further amplified by the interaction from the inductors 1460 and 1461. For example, a device such as that of FIG. 13, in addition to introducing a harmonic effect, can be utilized to increase its ionic charge state and speed by alternatingly attracting and then repelling the plasma ions, electrons or protons by use of high frequency harmonic stimulation alternating the polarity of the inductor coils. These properties are utilized and exploited by traditional cyclotrons and linear accelerators.

In a laser generated Wakefield accelerator (LWFA), extremely short laser pulses with a potential frequency greater than the general collective frequencies of the surrounding plasma are introduced. As the laser's photons travel through the plasma, electrons become separated and accelerated. This results in the creation of a wake of plasma oscillations, owing to the ponderomotive force. A ponderomotive force consists of a nonlinear force that affects charged particles in an inhomogeneous oscillating electromagnetic field. It causes the particles to move towards the area of the weaker field strength. The plasma wave is not a resonantly driven beat wave; thus, these waves do not have to have uniformity in order to produce large-amplitude waves.

In order to produce the laser Wakefield effect, plasma is introduced into a space in front of the laser or proton beam. An intense, extremely short laser pulse introduces high energy photons into the plasma. As this pulse propagates through the under dense plasma, the relativistic ponderomotive force associated with the laser envelope removes and accelerates electrons from the region which follow in the wake of the photons of the laser pulse, while other less excited electron and plasma ion waves form the bulk of the resulting wake. These waves are generated as a result of the electrons becoming separated by the leading edge of the laser.

In use, a plasma torch, RF induction, microwave and/or laser can be used for the establishment of the plasma from the gases or other materials introduced into container 1464. As the twin (or more) beams generated by lasers 1462 and 1463 pass through the induction chamber 1460 and 1461, the beams then move between the cavity opening created at the intersection point of the rotating discs 1471 and 1472. The purpose of the rotating discs is to compress the plasma dimensionally and/or magnetically, as discussed above with regard to previous embodiments.

If an arrangement similar to that indicated generally as 1468 is employed, then additional heat will be removed due to the rotating hydrodynamic generation effects (i.e., magnetic fields and charged particle redirection), which instantly converts the transiting ions' and electrons' thermal energies into electricity, thus removing a significant portion of the impacting thermal energy. While a four-disc arrangement 1471 and 1472 (as discussed above with regard to FIG. 12A) has also been described above with regard to FIGS. 14A and 14B, a two-disc rotor system 1485 (such as that of FIGS. 2B and 3) would function as well. It has been considered that six and eight rotating cylinder disc devices could also function in a desired manner.

The undulator designs 1495, 1496 and 1474 may also be employed, as discussed above with respect to the previous embodiments. The device may also use non-rotating discs and/or expendable stationary magnets and electrodes instead of the rotating devices indicated generally as 1468, 1469 and 1481. While using a stationary electrode or magnets instead of a rotating device would decrease the complexity of the device at the cost of overall efficiency, its resistance to thermal and neutral particle erosion could be increased by the use of sonic, ultrasonic or higher frequency stimulation of the electrode and/or magnets, such as in the device shown in FIG. 20. In this type of device, a series of transducers could move the non-rotating surface back-and-forth rapidly, limiting contact time with the plasma, thus significantly reducing the amount of damage to its surfaces. It is contemplated that a second set of transducers, as previously discussed, could additionally move the rotating assemblies at 90° angles, with regard to the other transducer, moving them closer together and then increasing the distance apart. This serves to compress and then expand the plasma, helping to form a plasma void zone. This motion, along with the rotation, introduces a three-dimensional movement, further protecting the rotating or stationary surfaces while also serving to enhance the formation of nucleation sites, thus significantly reducing the amount of damage to its surfaces.

While only a single rotating assembly 1471, 1472 is shown, it should be understood that multiple disc assemblies could also be stacked to form a multiple array 1495, which is capable of electrical recovery from the transiting plasma, serving to also produce a magnetic undulator-like effect. The assembly indicated generally as 1495 could also add energy added to the beam and produces a propulsion, conducting an electric current across the intervening plasma, causing an increase in its energy state and interactions with the tangential magnetic fields, creating acceleration of the plasma and electrons. The magnetic influence of the undulator causes the beam to develop a wiggle, resulting in the production of x-rays. The device indicated generally as 1485 has an alternative two-disc configuration, such as that discussed above with regard to previous embodiments. Since the acceleration of primarily negatively charged electrons streaming into the chamber creates an unbalanced electrical condition, wire 1459 connects between the induction chamber 1460, 1461 and the inner chamber 1467. This creates an electrical pathway having the ability to directly recover additional electrical energy through a load 1480.

The device of FIG. 14D provides for high-efficiency x-ray output. In operation, an optional plasma source 1429, a laser, a microwave source, an RF source, or a submillimeter source, is initiated to generate plasma, which then transits through the rotating disc undulator assembly 1433 directly into the chamber 1430. Amplified thermal temperatures with a greater level of plasma, proton and/or electron density can be generated by the optional induction coil 1431 amplifying it before the beam is magnetically and physically compressed by the undulator assembly. The high frequency induction coil 1431 increases the speed of the transiting plasma to an extent where the electrons are accelerated at a faster rate than the positively charged ions, in a manner similar to that used in linear accelerators, causing charge separation with a buildup of electrons present inside of the chamber 1430. These electrons experience additional acceleration in the undulator assembly. The electrons attracted to the positive ions are conducted back via 1426 to the region located before the induction coil with a higher positive ion density.

The returning electrons can then pass through a load for recovering energy before entering into the positively charged region prior to the induction coil 1431. This allows for a positive attractive charge to build up in the area behind the rotating undulator 1434 and the induction coil 1431. The rotating assemblies could be alternatively configured as indicated generally as 1432 and 1427 in the form of multiple undulator assemblies.

The rotating magnetic assembly 1427 consists of multiple elements such as that indicated generally as 1409. When these elements are fashioned together to form an undulator assembly, they have the ability to magnetically wriggle the intervening, mostly electron beam, generating x-rays, as discussed above with regard to the previous embodiments. This configuration is also capable of further accelerating the charged carriers by introducing an electric current across the ionic, plasma or electron beam in the presence of a magnetic field. This rotating MHDP process increases the energy and speed of the transiting beam.

Each of the undulator assemblies use an inverse magnetic and electric polarity to that of the previous assembly. This serves to increase charge separation to alternately modulate the mostly electron beam to “wiggle”, thus emitting x-rays. The x-rays 1428 then exit through the x-ray transparent cover 1425 to various stations.

The undulator assembly 1433 induces the magnetic “wiggle” of the plasma, proton or electron beam, producing x-rays, while an electric current is conducted across the plasma to increase its speed, particle interactions and increased production of x-rays output. Undulator assemblies 1427 and 1432 are similar to those described above with regard to previous embodiments.

After transiting through the intersecting disc's aperture, the plasma begins expanding upon entering chamber 1430 after emerging from the cavity created by the four intersecting rotating cylinders/discs 1442, 1441 or 1440 (similar to those described above with respect to detailed in FIG. 12A). The chamber's walls may be protected by multiple rotary cylinders 1445, allowing for the RHDG electric recovery described above, or could alternatively consist of either thermally conductive metal or ceramic materials should electrical recovery not be required.

Other devices, such as those shown in FIG. 10 and FIG. 14B allow for the direct recovery of electrical energy from the plasma. These rotating cylinders provide protection for the chamber walls 1430 and also provide for the direct conversion of the plasma ions and electrons into electrical energy by the rotating magnetohydrodynamic generator.

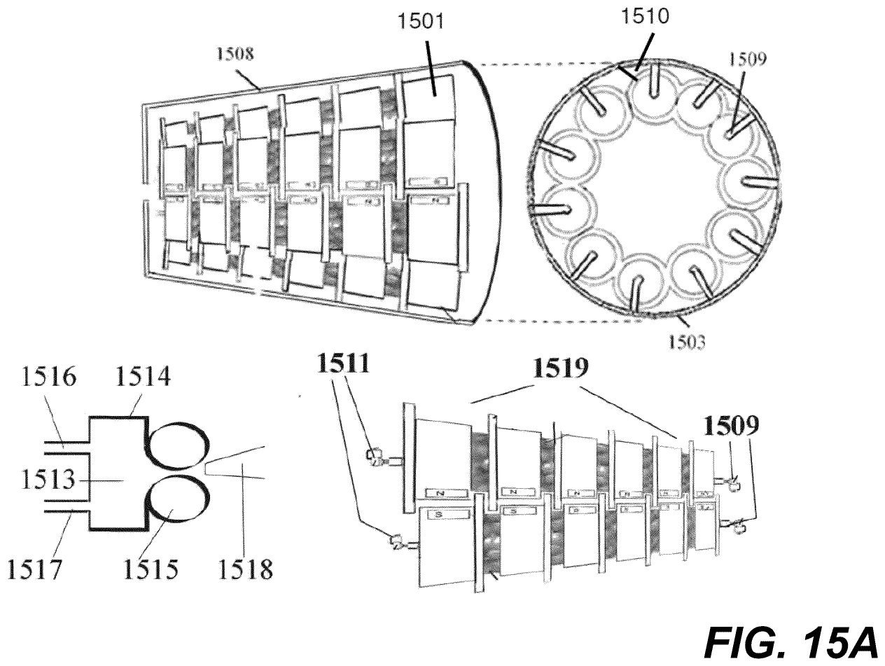

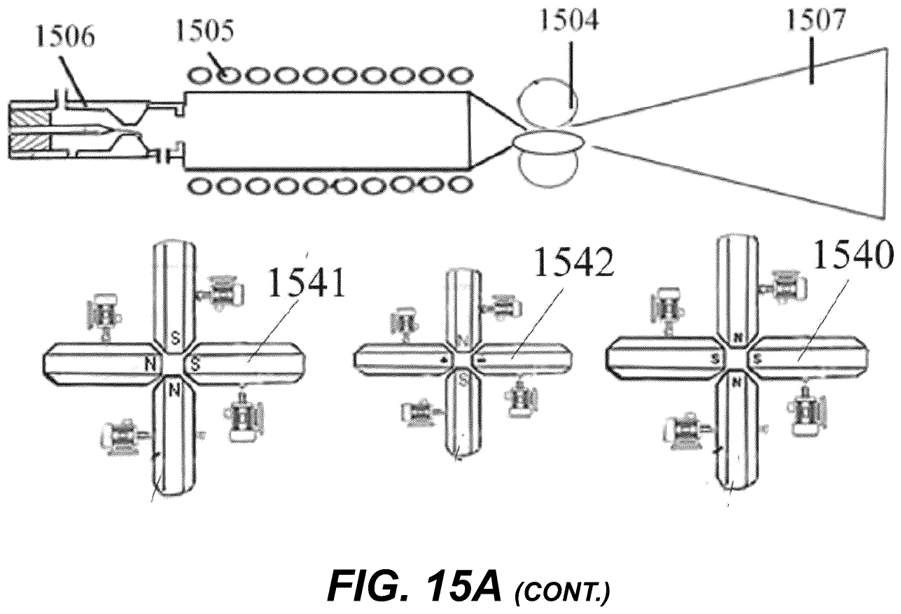

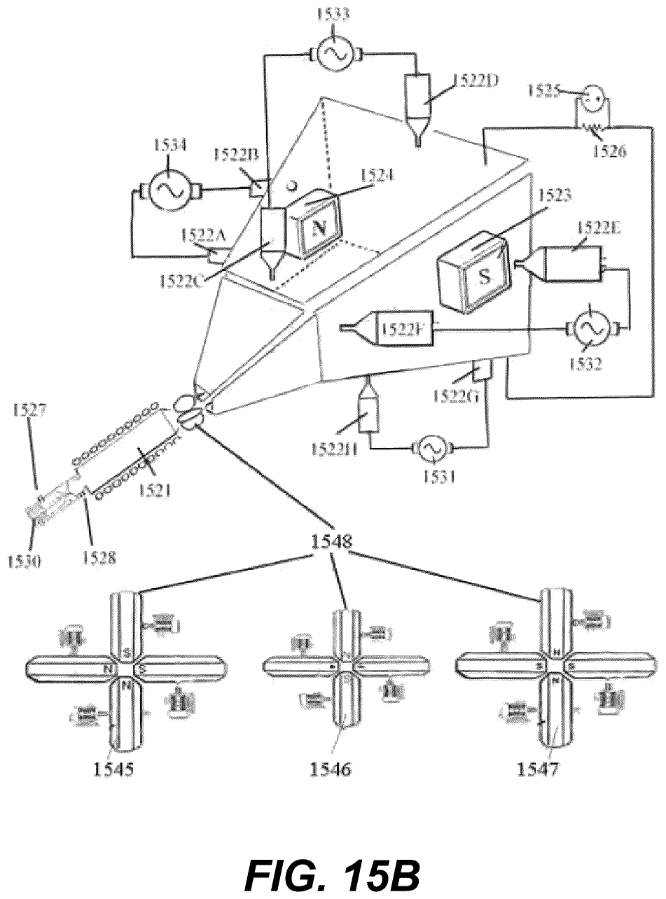

The device shown in FIG. 15A is capable of generating large amounts of thrust from high temperature plasma/gases using a bell-shaped rocket engine. This system could be used by numerous rocket propelled systems or airplanes. The device of FIG. 15A incorporates rotating cylinders, such as those described above with regard to the previous embodiments, in order to prevent plasma damage to the rocket engine nozzle's internal surfaces. Additionally, a MHDG system 1504 can be used to further enhance the thermal protective effect through the direct conversion of the impacting thermal energy into an electrical output. This recovery offers the potential of providing recovered energy which could be utilized by other parts of the engine. In addition to the nozzle area, the system can also use a variety of rotating systems, such as that described above with regard to FIG. 12A to operate and form the throat of the rocket engine.

The shape of the rotating throat assembly, formed by one or more of the rotating discs, mimics the design and function of a traditional rocket throat area, where one side of the throat faces the combustor area to compress the gasses. The downside area after the disc throat assembly allows for the gasses'-controlled expansion into the bell area 1508. Due to its rapid rotation, far higher temperatures can be tolerated without significant thermal damage, as would be the case with materials normally used in traditional throat designs.

The rotating nozzle assemblies 1507 can produce electrical power through the same MHDG effect described above, which also serves to rapidly reduce the impacting potential thermal energy before it is absorbed, thus protecting its surfaces. For the purposes of creating a more energetic and faster thrust potential, the throat assembly 1504 in 15A (cont.) could also be configured to generate an electric current at its electrodes, which could be conducted across the ionized plasma, as discussed above with regard to the MHDP effect (magneto hydrodynamic propulsion), creating a higher exhaust speed and thrust potential from the same amount of mass available in the fuel.

It has also been contemplated that the same thrust produced by this engine could additionally produce rotary motion from a bladed turbine placed in the exhaust stream. The use of a turbine fan could allow for increased energy recovery through two mechanisms, namely, direct electrical recovery from the throat area's MHDG effect and rotary energy produced by the turbine. This serves to boost the overall potential efficiency of the system.

This system allows for the recovery of electrical energy directly from the ionized plasma via the rotating RHMD systems located in the throat area of the engine. It also recovers energy from the rotating nozzle protective system and recovery device through the use of heat exchangers. The rotating nozzle assembly shown in FIG. 15A permits heat recovery fluids to flow through the interior cavities for additional heat recovery.

The devices shown in FIG. 15A are similar in operation and construction to those of FIG. 14B, however, to form the conical shape needed for a rocket bell nozzle, the rotating recovery means 1519 vary in diameter from a smaller diameter at the base to a larger diameter near the nozzle's exhaust exit area, forming a conical shape. Multiple such conical devices 1501 positioned along a common axis form the interior of the rocket outlet nozzle 1507.

The rotating cylinders provide significant thermal and neutral particle protection for the outer nozzle 1507 while also having the ability of preheating the reaction gases flowing through their cores through the rotary union/manifold means 1509 and 1511 located on either side of the conical device, which connects with a union/manifold 1509 located on either end of the nozzle.

In operation, once the rotating MHDG throat assembly 1504 and the rotating nozzle assembly 1501 start rotating, the plasma can be initiated by plasma generator 1506, 15A (cont.). The throat 1504 rotary disc and either side view 1515 can consist of any of the rotating devices described above. For example, while the device illustrates a device similar to that of FIG. 12A any of the other devices previously describe, including rotating devices 1540, 1541 and 1542, in FIG. 15A (cont.), which are similar to those described above with respect to the previous embodiments.

As an alternative to a plasma torch, a combustion system 1514, 15A is also shown which allows for fuel to enter through port 1516 and an oxidizer or air to enter through port 1517, where it mixes with the fuel in chamber 1513. Should this mixture be exposed to the ignition temperatures in the chamber, a combustion event will ensue with the lower temperature flame plasma entering the cavity between the rotating means 1515. A further alternative could have a plasma generator inject a plasma stream into the middle of the combustion chamber helping to establish an ionized zone within the combustion event which could assist in ionizing the surrounding gases making it more reactive to the rotating 1515 MHD system without the energy requirements of converting the complete gas flow to a plasma state. The rotating means 1515 may be any of the devices described in the previous embodiments, such as those shown in FIG. 2A, 2B, 3, 9A, 9B, 10, 12A, or 17.

The hot flame plasma is further intensified through the magnetic and physical compression exerted by rotating means 1515, as described above, which increases the plasma's ionization as it transits through its opening cavity. This allows for recovery of electrical energy through the magnetohydrodynamic generation process. The system may alternatively be configured to increase the physical speed of the plasma through the magnetohydrodynamic propulsion force, which could also be produced through the application of an electric current and a magnetic field across the transiting plasma before it enters the exit nozzle assembly 1518, thus producing an additional forward thrust.

The rotating devices all include the potential of producing a vibrational stimulation to the rotating discs, as discussed above with regard to the previous embodiments, including the plasma detonation effect. Relatively lower temperature detonation events have been studied for use in rocket engines and, although previously difficult to produce, reliably show potential for increases in efficiency. A detonation rocket engine is a type of propulsion technology that uses the shock waves formed by continuous detonation events of a combusted fuel and oxidizer. This allows for more of the potential energy in the fuel to be utilized to create forward thrust when compared with traditional rocket engines and has several other advantages. Since the detonation impulses produce higher energy, eliciting a greater amount of the potential energy contained in the fuel, the engine's size and weight can be significantly reduced through use of a more compact combustion zone which reduces overall size and weight of the engine. The detonation engine requires lower propellant injection pressures resulting in the gas generator and drive pumps having lower pressure requirements. This serves to make them smaller and far less complex while reducing their energy requirements.

The use of detonation events releases more propulsive energy from a given amount of propellant than deflagration. This produces more thrust with less fuel, allowing for higher weight loads to be projected over greater ranges. Detonation-driven compression produced in these engines increases the chamber pressures, resulting in greater propulsive thrust when compared with conventional rocket engines. The system of FIG. 15A reliably creates the detonation events through the use of the external wave compression method introduced by vibrational compression of the transiting combustion/plasma, described above. The highly energetic and fast-moving plasma begins expanding in nozzle 1507 which creates a forward thrust potential. Oxidizing the fuel to create a combustion event is also contemplated, rather than requiring higher energy plasmas to be produced. This will also allow for the use of monatomic forms of hydrogen cryogenically stored and maintained, as discussed above, thus producing a higher thrust potential than the use of diatomic hydrogen (H₂).

Further, the system of FIG. 15A-15B allows for electrical recovery via magnetohydrodynamic generation through brush 1510, allowing electrical energy recovery, along with additional thermal energy recovery, which can be withdrawn through rotary fluid interconnect 1509 located on the end of rotating nozzle 1501, where heated fluid is withdrawn by manifold 1509. Rotary fluid union 1511 provides a cooling fluid connection. The rotating means 1501, when set in motion, provides further thermal and neutral particle protection for the outer containment nozzle 1503.

If greater velocity is sought, the rotating electrodes 1542 can be configured to allow for electrical potential to be conducted across the plasma to produce MHD acceleration of the ionic plasma mass, thus increasing the plasma's velocity as it interacts with the magnetic fields of the adjoining magnetic energized rotating discs. This, in turn, greatly increases the forward thrust potential while reducing thermal and neutral particle damage. Should a hydrocarbon containing fuel be used, then a percentage of the contained carbon in its solid form can be precipitated out as solid carbon rather than creating carbon dioxide (CO₂), as previously described.

The system of FIG. 15A allows for the production of rocket propulsion or thrust which may also be absorbed by a turbine generator. While serving a thermally protective function similar to the device of FIG. 15A, the embodiment of FIG. 15B includes four or more flexibly joined plates or arched members (collectively forming the exhaust nozzle or, alternatively, being formed as a single one-piece nozzle) that receive vibration from a series of vibrational transducers. While not as effective at preventing thermal damage as the rotating devices of FIG. 15A, the system of FIG. 15B provides far greater thermal protection from the formation of damaging thermally induced nucleation sites. In operation, vibratory transducers or generators 1522A, 1522B, 1522E, 1522F, 1522C, 1522D, 1522H and 1522G are all energized by power supplies 1534, 1533, 1532 and 1531. When the surfaces have started vibrating, the plasma generator 1530 (or a combustion system) can be energized to emit a stream of expanding plasma into the throat assembly located after the combustor and optional induction heater 1521.

A high temperature rotating throat assembly 1548 could include any of the configurations indicated generally as 1545, 1546 and 1547, which are similar to those described above with regard to the previous embodiments. The disc assemblies may be any of the devices described herein, such as, for example, those of FIGS. 2A, 2B, 3, 5, 9A, 9B, 17, which could be stimulated by an ultrasonic transducer, such as transducers 1213A-1213D of FIG. 12A. This applies a pressure wave to the already physically compressed plasma stream. If the rotating cylinders contain magnets, then the same rotating cylinders can apply a magnetic compression effect to the transiting plasma stream to increase its density and temperature. Thus, detonation events can be generated as described above.

Should recovery of electrical energy be required, the rotating disc electrodes 1548 may be connected through a load 1526 to perform useful work, such as for example, recharging batteries. If increased speed through enhanced thrust is required, then power supply 1525 can be energized to allow an electrical current to flow between the rotating electrodes 1548, conducting across the ionized plasma in the throat area which allows it to be ejected at a higher speed through the plasma's interactions with the magnetic fields from rotating disc electrodes 1548.

Gas supply ports 1527 and 1528 can introduce various gases, such as, as a non-limiting example, hydrogen and oxygen. If these gases are utilized, then combustion will occur when the gases contact the plasma formed in plasma torch 1530. The plasma flows out through inductor 1521 to the rotating means 1548 serving as a rocket nozzle which then compresses it and stimulates it with transducer means described previously producing plasma detonation events which sends a detonation shockwave out through the nozzle assembly. As discussed above, a monatomic hydrogen gas could be supplied in its cryogenic form and be maintained by suitable magnets along its connecting pipes until recovered heat converts it into its monatomic gaseous form prior to an oxidizing combustion event or alternatively encountering the plasma generator 1530.

If the recharging of batteries or a capacitor bank with electrical energy is desired, the nozzle can be configured to operate as a magnetohydrodynamic generator and is able to recover electrical energy from the transiting plasma as it passes through the nozzle into the load 1526. This allows the engine to produce thrust while recovering electrical energy.

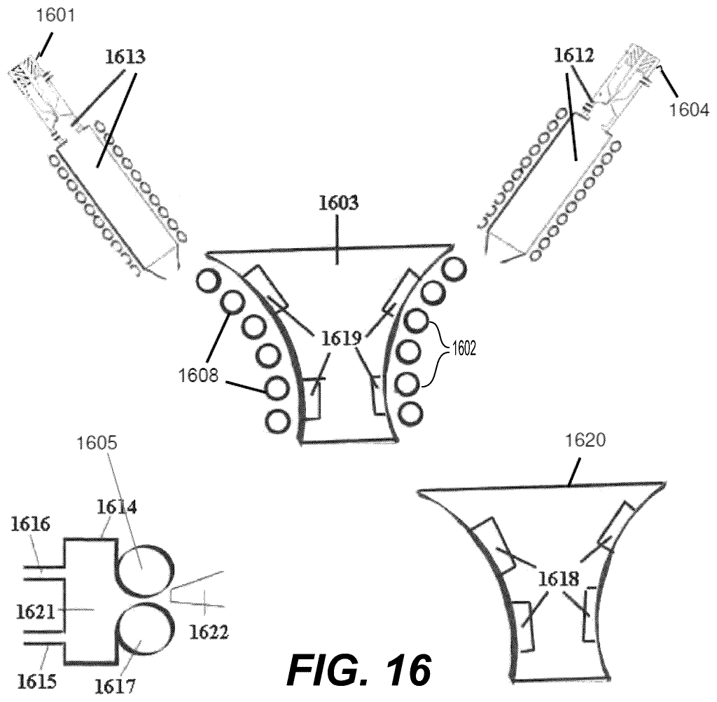

FIG. 16 illustrates an aerospike engine configured to make use of plasma, including a combustion zone, a throat and an outlet nozzle that expands and accelerates combustion products to high supersonic velocities. As in the previous embodiments, rotating cylinders line the nozzle's internal surfaces 1603. As discussed above with regard to the previous embodiments, the rotation of the rotating cylinders prevents formation of thermally-induced nucleation sites and allows the rotating cylinders to come close to the plasma flow. In addition, the reason the rotating cylinders can withstand being in close proximity to the plasma is due to numerous factors, including the disruption of the boundary layer on the exposed engine surfaces. When the boundary layer is disrupted, this layer of stagnant fluid(s) is broken up, thus reducing efficient contact between the hot fluid and the surface. This hinders conduction, which is the dominant mode of heat transfer. As further discussed above, the use of rapidly vibrating and/or rotating surfaces serves to disrupt the boundary layer. Additionally, centrifugal forces contribute to increasing the velocity gradient within the boundary layer, thus significantly contributing to the conditions for shear-induced turbulence and vortex formation. These vortices are the dominant mechanism for disruption of the boundary layer, thus reducing heat transfer.

When considering an environment where a superheated fluid contacts a surface, the boundary layer is the zone most intimately in contact with the surface. This clinging layer conducts large amounts of damaging thermal energy directly to the surface. Through the use of rotation, as discussed above with regard to the previous embodiments, large centrifugal forces can act on the boundary layer, thus causing it to become disrupted. It should be understood that this disruption to the boundary layer is an advantage shared by each of the embodiments described herein which take advantage of the plasma contacting the rotating surface.

Returning to the aerospike engine, in addition to the nozzle area, the engine may use the rotating system of FIG. 12A to form the throat of the rocket engine. The shape of the rotating throat assembly, formed by the four or more rotating discs, mimics the design and function of a traditional rocket throat area, where one side of the throat faces the combustor area and serves to compress the gasses, while the downside area of the disc assembly allows for the gas's-controlled expansion into the nozzle area 1603. The rotating nozzle assemblies 1602 and 1608 can produce electrical power through the same MHDG effect described above, which also serves to rapidly reduce damage from the impacting thermal energy through conversion of thermal energy directly into an electrical output before it is absorbed into the surfaces.

For the purposes of creating a more energetic, faster thrust potential, the throat assembly could also be configured to generate an electric current conducted across the ionized plasma. The current would interact with the magnetic fields emanating from the other rotating discs magnets. This would produce an MHDP effect, as described above, creating a higher exhaust speed and thrust potential from the same amount of mass available in the fuel. While combustion-based thrusters have been discussed above, it should be understood that these systems will also function with pure hydrogen or, preferably, hydrogen in its monatomic form. Pure hydrogen, if used by these devices, can achieve higher exiting speeds than would a combusted fuel. Moreover, monatomic hydrogen could potentially produce an even higher thrust potential due to the fact that its recombination into the diatomic form of hydrogen (H₂) is an exothermic reaction.

The device shown in FIG. 16 is an aerospike rocket plasma engine, which has a nozzle which may be described as the inverse of that of a conventional bell-shaped rocket nozzle. This allows for the current elevation of the atmospheric pressure to modulate the thrust cone's exhaust plume and optimizes it for operation at any altitude, ranging from sea level atmospheric pressure to the vacuum of space. The atmospheric pressure exerted on the aerospike's open exhaust nozzle automatically compensates and adjusts the rocket exhaust plume for the altitude in which the rocket is operating.

Rotating cylinders 1602 and 1608 line the outside of the aerospike nozzle shell 1603, preventing damage from excessive heat loads while converting some of the impinging plasma into electrical energy which can be recovered by a RMHG system through an electric load, as described above with regard to the previous embodiments. These rotating cylinder assemblies may be, for example, those discussed above with regard to FIGS. 10 and 14A. The aerospike nozzle surfaces can additionally be vibrated by transducer 1619. Device 1620 is a high temperature aerospike design using only transducers 1618 to maintain nozzle integrity.

During operation, the plasma torch injectors 1601 and 1604 emit high energy plasma or, alternatively, lower energy plasma flames that can be generated through a combustion process 1614. Either of these plasmas could then be additionally heated through inductively coupled induction amplifiers 1612 and 1613. The magnetic fields created by the induction coils help to keep the plasma centered, thus reducing contact with the walls to prevent damage while also reducing the temperature loss of the plasma.

The plasma then enters the rotating throat assembly formed by the intersection of the rotating discs/cylinders 1617, 1605, which are similar in function to the cylinders shown in FIGS. 2A, 2B, 3 and 10, or, alternatively, could consist of the multiple throat assembly shown in FIG. 14A. Similar to that described above with regard to FIG. 15A the thrust created by the aerospike could also be converted by a bladed turbine-like device for the production of usable rotary motion recovery. Should a hydrocarbon containing fuel be used, then a percentage of the contained carbon in its solid form can be precipitated out rather than creating carbon dioxide (CO₂), as previously described.

FIGS. 17 and 18 illustrate a rotary magnetohydrodynamic generator (RMHG) which uses a set of four motor-driven belts. Two of the belts 1701A and 1701B contain opposing north-south magnets 1702A and 1702B between the moving belts. As best shown in FIG. 18, motors 1805A, 1805B, 1805C, and 1805D drive belts 1801, 1701A, 1802 and 1701A, respectively, to rotate. Plasma torch 1807, which may be any suitable source of plasma, is energized and a working gas is introduced, resulting in plasma which is focused into the center of the four rotating belts. The magnetic fields cause the plasma's ions to be separated and then be absorbed by electrically conductive belts 1801 and 1802, which allow power to be withdrawn through electrical contacts 1803, 1804, respectively, with useful work accomplished through load 1806. Alternatively, if an increased speed of the plasma is required to produce thrust or a higher energy plasma, then a power supply 1808 can produce a DC electric potential across the plasma between moving belts 1801 and 1802, with current passing through the ionized plasma to accelerate the plasma. When the device is in operation, vibrators 1707B, 1707C, 1707D and 1707A, as shown in FIG. 17, can induce vibratory energy to the moving belts, further preventing the damaging effects of nucleation sites forming on the moving electrode surfaces. The vibrators can also be used to remove undesired vibrations in the system by generating vibrations which destructively interfere with any naturally occurring vibrations in the system to eliminate them.

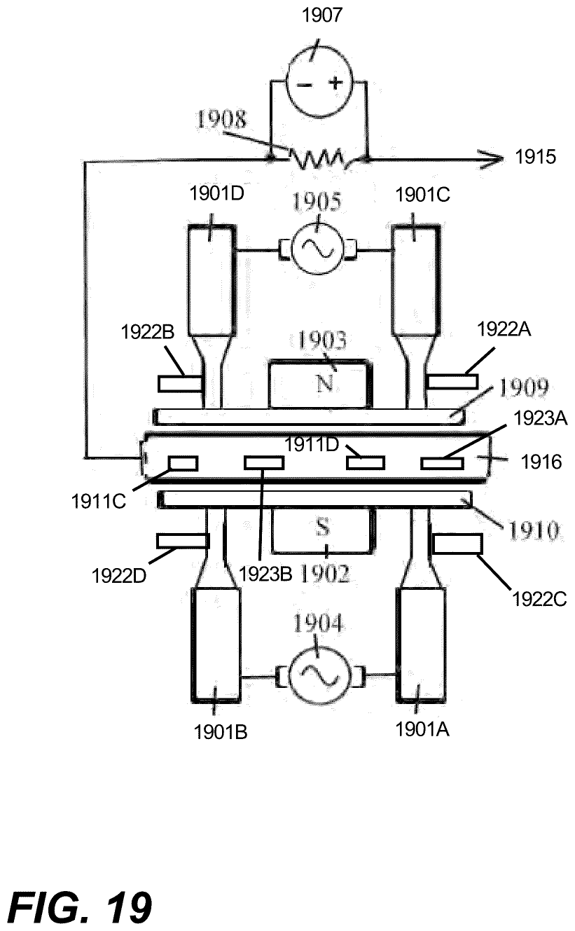

FIGS. 19 and 20 illustrate a vibrating magnetohydrodynamic generator (VMHDG). The VMHDG allows for extremely hot plasmas to pass through the interior of the generator without damaging the containment walls. Vibrating the walls prevents damage from nucleation sites forming on the surfaces, which allows for additional time for heat transfer to occur before the surfaces are thermally damaged. This method employs vibration instead of rotation (as in the previous embodiments) and allows for the use of an increased surface area to be made available for contacting the transiting plasma while also removing the mechanical complexity involved with rotating bodies.

During operation, vibrating transducers 1911A, 1911B, 1911C and 1911D vibrate electrode plates 1915 and 1916 when power supplies 1904, 1913, 1905 and 1912 are energized. The magnetic plates 1910 and 1909 and transducers 1901A, 1901B, 1901C and 190D are also put into motion when power supplies 1904, 1913, 1905 and 1912 are energized. This design contemplates the potential of an extra dimension of vibrational movement by electrode transducers 1923A, 1923B, 1923C and 1923D and magnetic transducers 1922A, 1922B, 1922C, and 1922D. This additional range of motion, if employed, further reduces the formation of thermally induced nucleation sites to a greater extent than a single dimensional motion. The plasma torch, or any other suitable source of plasma (not shown), is then initiated, creating plasma which then flows into cavity area 1912. The energized plasma then comes into contact with the magnetic fields from magnets 1902 and 1903. The plasma ions and electrons are induced by the magnetic fields to contact either of the electrode plates 1916 or 1915. The electrical potential can do useful work through connected load 1908.

The device of FIGS. 19 and 20 can also be used to increase the velocity of a conductive fluid through cavity 1912 through the introduction of an electrical potential across the two conductive electrodes energized by power supply 1907, thus producing thrust. To reduce operational noise and vibration from the vibrating transducers, the power supply can alter the stimulation frequencies of the transducers in such a manner that the vibrations cancel each other out through destructive interference. As a non-limiting example, power supply 1904 can send a signal to 1901A, allowing it to extend either the front or back section outward while, at the same time, turning off the electrical input to 1901B, creating a relative angular difference, thus creating a cancellation of the net noise and vibration while still allowing the surfaces to move rapidly in order to discharge bubbles or, in the case of plasma, preventing nucleation sites from forming on the surfaces. The other panels could be stimulated in a similar manner, allowing the entire device to be sonically neutralized.

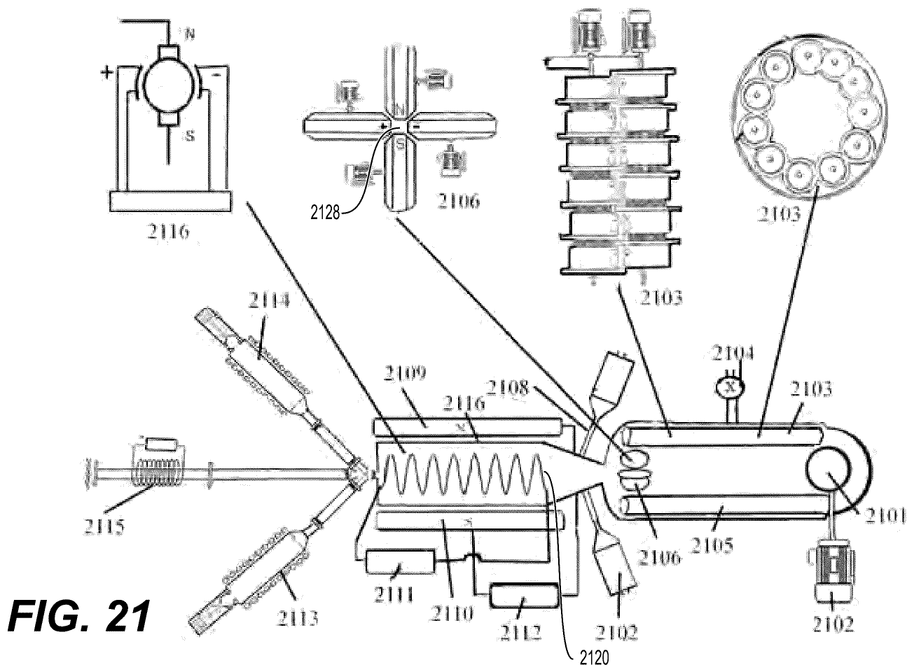

The device in FIG. 21. makes use of the Wakefield effect, which allows for higher potential temperatures to be achieved efficiently, while also allowing for increased atomic collisions in the densified plasma. It also has the capability of generating or utilizing an electron and/or proton beam with the production of associated x-ray and ultraviolet-to-visible light emissions. This is accomplished by employing plasma injectors 2114, 2113 or a proton beam, such as that produced by an accelerator, injected into the center of the plasma cloud generated between the area 2116 and the aperture of the rotating magnetic devices 2106. In addition to lasers, the Wakefield effect can be initiated by a proton beam, offering a potential method for particle acceleration. This method utilizes a high-energy proton beam which displaces electrons in a plasma, creating a region of positive charge. The displaced electrons subsequently return, generates a strong electric field known as a Wakefield. Charged particles injected into the plasma at the appropriate time can be accelerated by this Wakefield effect. Proton-driven plasma Wakefield acceleration offers several advantages, including higher energy potential and longer acceleration distances compared to electron-driven methods. This approach is supported by ongoing research, notably the AWAKE experiment at CERN. It should be understood that laser 2115 may be continuous lasers or pulse lasers and may operate at any suitable wavelength.

Wakefield acceleration is a technique for accelerating charged particles using an intense laser pulse propagating through a plasma. The laser pulse creates a Wakefield effect, which is a plasma wave that can trap and accelerate electrons to high energies over short distances. The specific type of laser spectrum used in Wakefield acceleration is not as crucial as the overall properties of the laser pulse, such as its intensity, pulse duration and wavelength. However, some laser characteristics are more favorable for efficient acceleration. Powerful electric and or magnetic fields are required for the creation of sufficiently large Wakefield events capable of eliciting strong electron acceleration. Shorter laser pulses create more defined, steeper Wakefield events, producing a higher acceleration gradient over shorter distances. Lasers in the infrared (IR) region are commonly used because they provide a good balance between all the necessary properties.

In operation, the laser beam projects through the cavity centers of induction chambers 2116 where the inductor coils, which could use the principles of stepped harmonic amplification, as shown in FIG. 13.

The speed of the laser or proton beam's accelerated electrons and other associated ions can be further amplified by the interaction from the inductor 2116. For example, a an harmonic step device, such as that of FIG. 13, could be realized in this device with in addition to introducing a harmonic effect, can be utilized to increase its ionic charge state and speed by alternating attracting and then repelling the plasma ions, electrons or protons by use of high frequency harmonic stimulation which alternates the polarity of the inductor coils. These properties are utilized and exploited by traditional cyclotrons and linear accelerators.

In a laser generated Wakefield accelerator (LWFA), extremely short laser pulses with a potential frequency greater than the general collective frequencies of the surrounding plasma are introduced by 2114, 2113. As the laser's photons travel through the plasma, electrons become separated and accelerated. This results in the creation of a wake of plasma oscillations, owing to the ponderomotive force. A ponderomotive force consists of a nonlinear force that affects charged particles in a nonhomogeneous oscillating electromagnetic field. It causes the particles to move towards the area of the weaker field strength. The plasma wave is not a resonantly driven beat wave; thus, these waves do not have to have uniformity in order to produce large-amplitude waves.

In order to produce the laser Wakefield effect, plasma is introduced into a space in front of the laser or proton beam by 2113, 2114. An intense, extremely short laser pulse from 2115 introduces high energy photons into the plasma. As this pulse propagates through the under dense plasma, the relativistic ponderomotive force associated with the laser envelope removes and accelerates electrons from the region which follow in the wake of the photons of the laser pulse, while other less excited electron and plasma ion waves form the bulk of the resulting wake. These waves are generated as a result of the electrons becoming separated by the leading edge of the laser.

In use, plasma arc torches, RF induction, microwave and/or laser can be used for the establishment of the plasma from the gases or other materials introduced before it enters into container 2116. As the twin (or more) beams generated by laser 2115 initially interacts with plasma generated by 2114 and 2113, it then enters into the induction chamber 2116. The chamber 2116 provides two magnetic assemblies 2110 and 2109 opposite of each other and perpendicularly spaced to the induction coil 2120, 2121. Coil 2121 is on the opposite side and not shown. This arrangement allows the beam to be intensified and also promotes increased particle speed which can be encouraged by the frequency of the inductive coil means or the polarity and/or frequency of magnetic assemblies 2109, 2110. In the case of electromagnets or superconducting magnets, power supply 2112 would apply a range of potential frequencies. Power unit 2111 and the inductive frequencies emanating from coil assembly 2120 create interactions with the magnetic fields of 2109, 2110 which can add energy and speed to the Wakefield accelerated particles and plasma. The chamber 2116 has the option of producing fine adjustments to potentially aid with alignment and/or could create vibrations to inhibit thermal damages to its surface by transducer means 2102.

Additional energy to the transiting beam can be added by rotating means 2106 which allows the magnetic assemblies and electrodes to be placed much closer to the high energy beam without damage. These rotating surface assemblies, 2106 and other configurations shown here in, due to their circular shape, form a funnel-like structure which first applies compression to the transiting plasma and particles upon entering gap 2128, the rotating device 2106, then as the high energy stream transits the apex point of the rotors, it then expands on the other side providing acceleration when the compression is released into the functional nozzle shape, as the particle beam and associated plasma moves to the other side of 2128. One of the key aspects of this design is the multiple energy intensification created by these rotating assemblies, which not only function to compress the plasma and particles dimensionally but at the same time able to provide potential magnetic compression, depending upon the arrangement of the intersecting rotating means, such as those shown in FIG. 12A.

If another arrangement similar to that indicated generally as 2106 is employed, then energy could also be removed from the transiting stream, removing thermal energy from the transiting stream, due to the rotating hydrodynamic generation, MHD, direct recovery of electrical energy (i.e., through magnetic field and charged particle redirection), which converts the transiting ions' and electrons' thermal energies into electricity, removes a significant portion of the potentially damaging thermal energy associated with the plasma contact.

With regards to particle accelerators this effect could be used to tune or modulate the exiting particles. While a four-disc arrangement 2106 (as discussed above with regard to FIG. 12A) has also been described above, in regard to the assembly shown in FIGS. 14A and 14B, or a two-disc rotor system 1485 (such as that of FIGS. 2B and 3) would function as well. It has been considered that six and eight rotating cylinder disc devices could also function in the desired manner. As described in FIG. 12A, a series of undulator assemblies comprised from multiple sets of the rotating assemblies 2128 has advantages over a single rotating assembly. This arrangement is shown in the accelerator shown in FIG. 14D.

The parabolic focusing system shown in FIG. 12B could also be utilized to intensify energy into the center of the beam. The devices, as has been previously described, utilize a series of 2103 internal chamber protective means to prevent harm to the containment chamber and to also allow for recovery of energy. A rotating spherical shaped energy recovery means 2101 driven by motor 2102 located at the back of the chamber could absorb and convert energy if a beam output is not desired. As is further described, this can recover rotary motion permitting 2102 to act as a generator.

This MHD device 2101 could be easily form into the spherical shape shown.

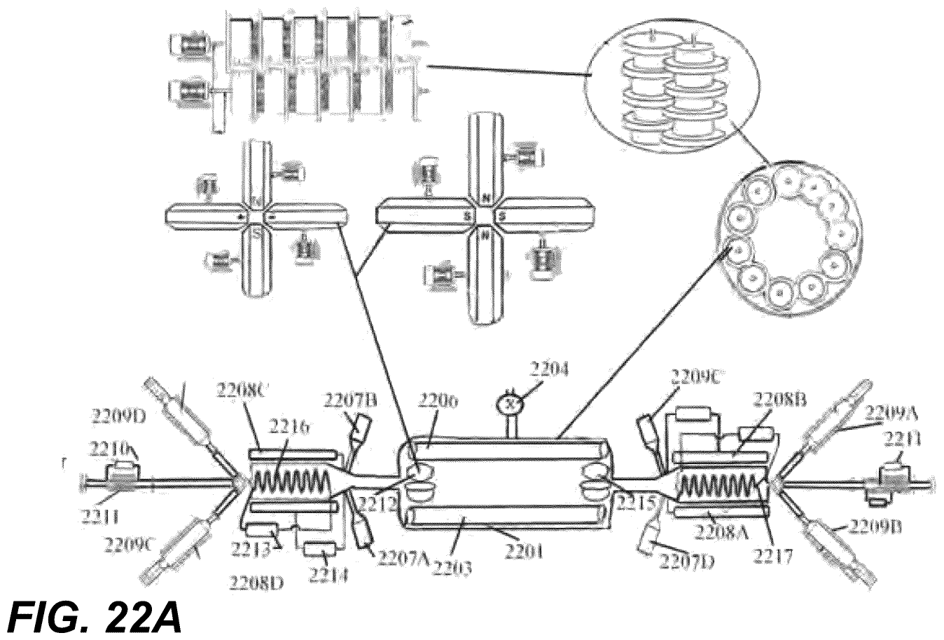

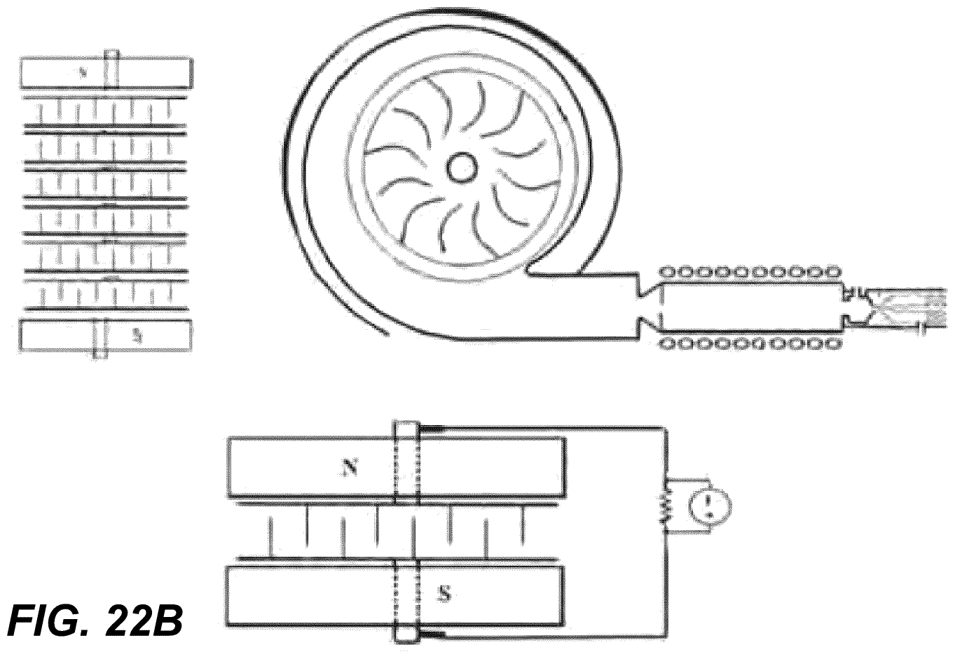

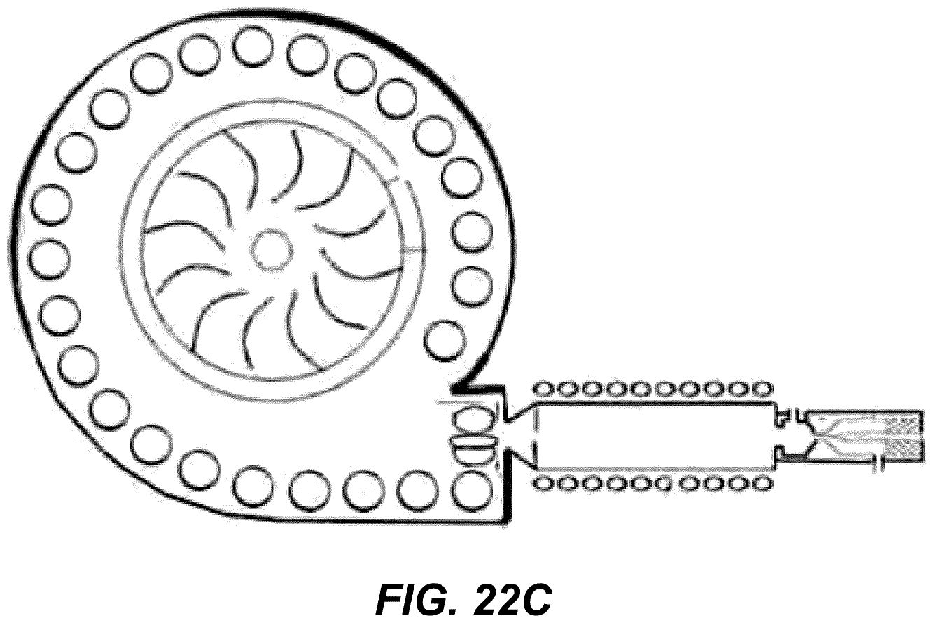

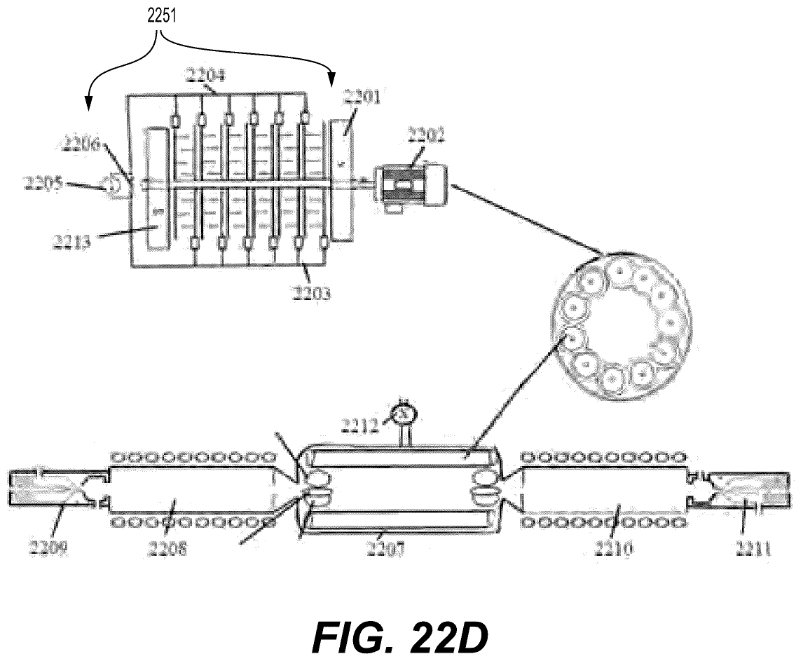

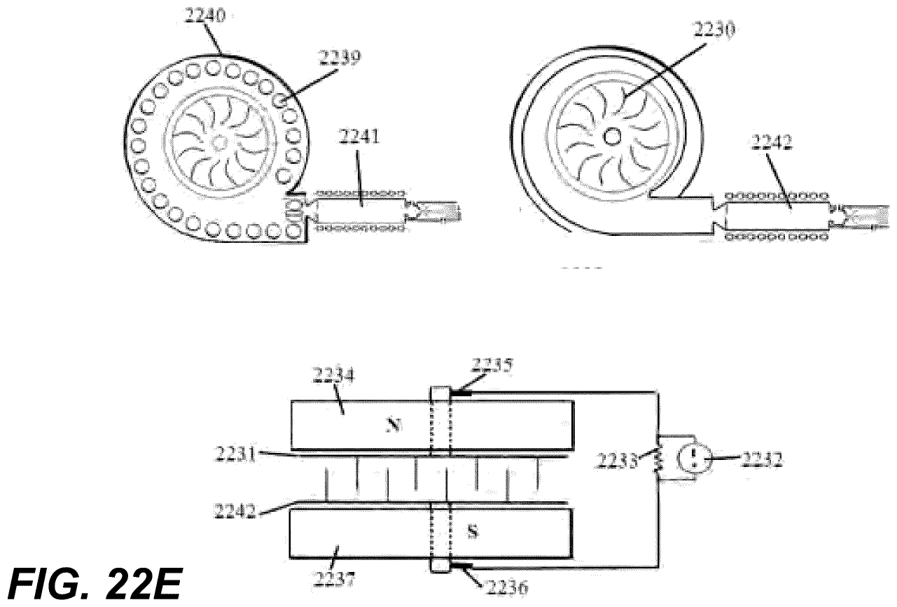

Another shape configured for this device is the turbine bladed device illustrated in FIG. 22E.

In operation, the device shown in FIG. 22E consisting of magnetic means 2234 and 2237 and electrode blade means 2231 and 2242, allows the device to recover ions and electrons from the transiting plasma and particles allowing transmission of electrical power load 2233 or conversely allows for the increase of the energy density of the transiting ionic stream from a power supply 2232. This MHD configuration allows for increased electrode area permitted by this device's use of flat electrode sections or when it's formed into a turbine shaped structure 2230. This arrangement permits a larger opening to the plasma or other particles than the other arrangements discussed here. As a result, this design has the capability of converting a greater percentage of the impacting energies into electricity. This greater conversion rate also results in an increased direct cooling effect for the rotating structure, providing additional potential protection from the thermal impact in addition to that created by its rotation as described earlier.

Also, as best illustrated in FIG. 22C is the potential for forming these vanes at angles or cupped shapes forming turbine like fan structures with the capability of additional power generation through the absorption of energy from the expanding gas flow as it passes over the electrode blades 2242, 2231. Shown is a turbine situated in a Volute or Spiral Casing design which focuses and increases the speed of the impacting gases or fluids on the centrally located turbine. As best illustrated in 22E is a Volute chamber 2240 rotating protective surfaces 2230. These are shaped to form a thermal barrier between the extremely hot gases and outer chamber walls 2240. These could consist of numerous other rotating chamber protective methods shown in FIG. 10, 14A, or a series of the assemblies shown in FIG. 22E. If this design is used it would also have the potential of converting the motion of the gases directly into rotary motion in addition to the rotary motion recovery of the central turbine 2230.

As noted, this particular arrangement lends itself to being formed into different shapes from spherical to cylindrical into a series of turbine blade assemblies.

The device shown in FIGS. 23D and 22A illustrates this arrangement of this type of device for chamber protection between the high-pressure interior of the chamber and the exit valve 2212 in 22Dd.

In operation 22Dd illustrates the use of two plasma injectors 2209 and 2211 generating a plasma stream entering into induction areas 2208 and 2210. The device described in FIG. 22D is either manually rotated by motor 2202 between two magnetic assemblies 2213 and 2201. In this arrangement the ions and electrons are deflected alternately to one or the other of the electrode vanes. If the vane assembly from 2251 are formed in an angled or cupped shape, they can function as turbine blades absorbing the impact of the expanding gases and 2202 could function as an electric generator creating power in addition to the high ion and electron directly absorbed by the MHD blades utilized by a load 2206. The parallel electrical and bush configuration shown collectively as 2204 and 2203, in FIG. 22D, transfers this energy to the load 2206. These designs show a gap between the vanes of one electrode assembly to that of the opposite polarity. This is illustrated for clarity, and an electrical insulator could be used instead removing the necessity of this gap. It should be readily apparent that this design, with its ability to recover rotary energy, could be extended to any of the other devices illustrated here.

In regards to systems previously long relegated to esoteric particle physics, these designs create the potential for these research devices to become real world electric generating devices using many of the same principles disclosed here.

Electron microscope images of carbonaceous materials produced by the systems as described herein as shown in FIGS. 23-31.

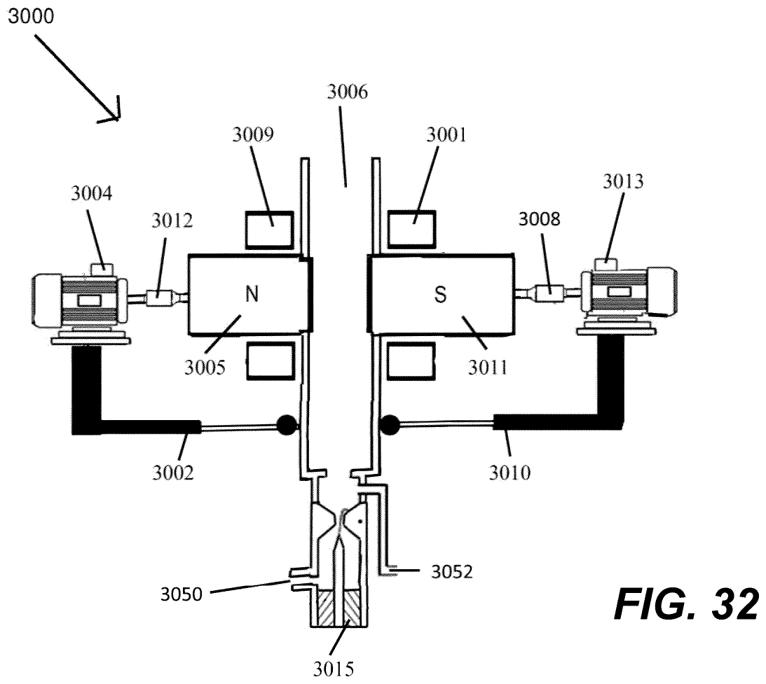

The embodiment of FIG. 32 is drawn to another variation on the rotating magnetohydrodynamic generator. Since all current static MHD devices must limit the temperature of the plasmas they utilize due to thermal, mechanical and material limitations, the true power production potential of extremely high ionic density plasma MHDs have not yet been realized. The rotating magnetohydrodynamic generator 3000 of FIG. 32 allows current materials to safely interact in an extremely high intensity plasma environment. This allows for high efficiency ionic conversion into useable electrical energy beyond what is presently available in MHD devices.

The configuration of FIG. 32 provides the advantage of additional contact surface area with the transiting plasma while also moving the majority of the equipment required for its operation outside of the plasma conduit chamber 3006. In operation, plasma emanating from torch 3015 enters chamber conduit 3006, where it comes into contact with a magnetic field generated by magnets 3001 and 3009. It should be understood that plasma torch 3015 is shown for exemplary purposes only and that any suitable plasma source may be used. It should be further understood that magnets 3001 and 3009 may be any suitable type of magnets. The magnetic field is established within the plasma conduit 3006 via cylinders 3005 and 3011 which may be composed of, as a non-limiting example, a ferrous material, such as iron.

It is noted that iron's conductivity of magnetic fields is not without limitations. Eddy currents (i.e., circular electrical currents induced within the iron by changing magnetic fields) can lead to energy losses and heating. To mitigate this, the iron used in alternating current (AC) applications is often laminated, with thin layers of iron separated by insulating material. This reduces the path for eddy currents to flow, thus minimizing losses. For these reasons, the cylinders 3005, 3011 may be constructed of laminates capable of conveying extremely strong magnetic fields generated by, as a non-limiting example, superconducting magnetic coils. Magnetic fields which are potentially powerful enough to not require an iron core material to convey them into the plasma conduit chamber 3006 are desirable, although not necessary, for the embodiment of FIG. 32.

Alternatively, cylinders 3005, 3011 may be constructed from a permanent magnetic material, such as, as a non-limiting example, an iron nitride based magnetic material. Iron nitride has emerged as an area of interest within the field of magnetism. Iron nitride compounds, which are formed by combining iron and nitrogen, exhibit unique magnetic properties that hold great potential for a variety of applications. One characteristic of iron nitride magnetic materials is their high saturation magnetization. This refers to the maximum magnetic moment that a material can achieve when exposed to a magnetic field. The high saturation magnetization of iron nitrides makes them useful in the embodiment of FIG. 32, as well as for numerous other applications, as described herein. However, iron nitrides have also been considered particularly attractive for use in magnetic recording media, where a strong magnetic signal is essential for storing and retrieving data.

In addition to their high saturation magnetization, iron nitride magnetic materials also exhibit excellent thermal stability. This means that their magnetic properties remain relatively unchanged over a wide range of temperatures. This thermal stability is crucial for applications in high temperature environments, such as in motors and generators used in power plants. This also makes their use particularly attractive for use in the present high temperature rotating magnetohydrodynamic generator. Furthermore, iron nitride magnetic materials are also highly resistant to corrosion. This makes them ideal for use in harsh environments, such as in plasma chambers, where corrosive materials are used to promote electrical conduction at lower temperatures, and also for underwater applications or in chemical processing plants. The corrosion resistance of iron nitrides also makes them a more sustainable option, since they require less frequent replacement than other magnetic materials while being composed of widely available materials.

The combination of high saturation magnetization, thermal stability, and corrosion resistance makes iron nitride magnetic materials a promising magnetic material for numerous uses. These materials will ultimately find wide utility in a growing number of applications, such as in magnetic recording media, power generation, motors, etc. Due to their high temperature resistance, these materials are of particular interest in the devices discussed herein, where they must confront the high temperature environments of the magnetohydrodynamic generator (MHG).

Iron nitride (Fe—N) magnetic materials, which can be produced in large quantities by the methods described herein, have a variety of properties, as noted above, including high saturation magnetization along with mechanical hardness. This, added to the fact they are produced from some of the most abundantly available low-cost materials and their ability to tolerate high temperature environments while maintaining their magnetic fields, makes Fe—N compounds extremely promising for a range of applications, from the aforementioned magnetic recording media to light weight generators and motors to other high-frequency power devices. However, the widespread adoption of Fe—N materials has been stalled by currently available materials' susceptibility to demagnetization and by current slow energy intensive and low volume methods of production.

Demagnetization (i.e., the loss of magnetic order within a material) is a major issue with current Fe—N compounds, particularly when current Fe—N materials are exposed to elevated temperatures or in the presence of external magnetic fields. This susceptibility stems from the inherent nature of Fe—N crystal structures manufactured by current methods, which often results in a high degree of magneto-crystalline anisotropy, a property that dictates the material's preferred direction of magnetization. High anisotropy can often lead to the formation of undesirable magnetic domains with opposing magnetizations, thus increasing the risks of the resulting iron nitride material becoming demagnetized.

Researchers have been exploring various mitigating strategies, such as through the use of dopants and with previously difficult to obtain amorphous states of iron nitride, which have emerged as possible promising avenues. The introduction of dopant atoms into the Fe—N lattice has shown potential in enhancing the magnetic stability of these materials. Dopants such as cobalt (Co), nickel (Ni) and boron (B) have been found to modify the magneto-crystalline anisotropy of Fe—N, reducing the tendency for domain formation while enhancing its resistance to demagnetization events. Dopants can also influence other crucial parameters, such as Curie temperature and coercivity, further improving the overall magnetic performance of Fe—N compounds.

Unlike crystalline materials, amorphous iron nitride lacks long-range atomic order. This lack of regular structure can serve in suppressing the formation of independent magnetic domains, leading to a significantly lower susceptibility to demagnetization. Amorphous Fe—N thin films have demonstrated thermal stability and resistance to external magnetic fields, making them attractive candidates in high-temperature and high-field applications. However, current techniques can only produce limited amounts of material and have not been considered for bulk material production.

The optimal choice of dopants and their concentrations require careful optimization to achieve the desired balance between magnetic stability and other performance parameters. The use of traditional methods for the synthesis of high-quality amorphous Fe—N with controlled compositions and thicknesses can be challenging. However, the device of FIG. 8 provides a unique method of manufacturing these materials. The device of FIG. 8 allows for production of iron nitrides with a significant level of parameter adjustability which can vary the nature of the resulting material to achieve numerous characteristics, including the ability to either favor a crystalline or more amorphous state. This method also allows for the introduction of numerous elements and dopant materials in exact ratios, thus allowing for precise adjustment of the iron nitride's overall magnetic characteristics to prevent demagnetizing events from occurring.

Other materials that can be used for the cylinder 3005, 3011 to convey the magnetic field, aside from iron and iron-based materials, are ferromagnetic materials, such as nickel and cobalt, which possess strong magnetic responses. These materials are characterized by the alignment of their atomic magnetic moments, resulting in spontaneous magnetization, even in the absence of an external magnetic field. Ferromagnetic materials find extensive use in transformers, motors, and data storage devices due to their ability to concentrate and channel magnetic fields effectively.

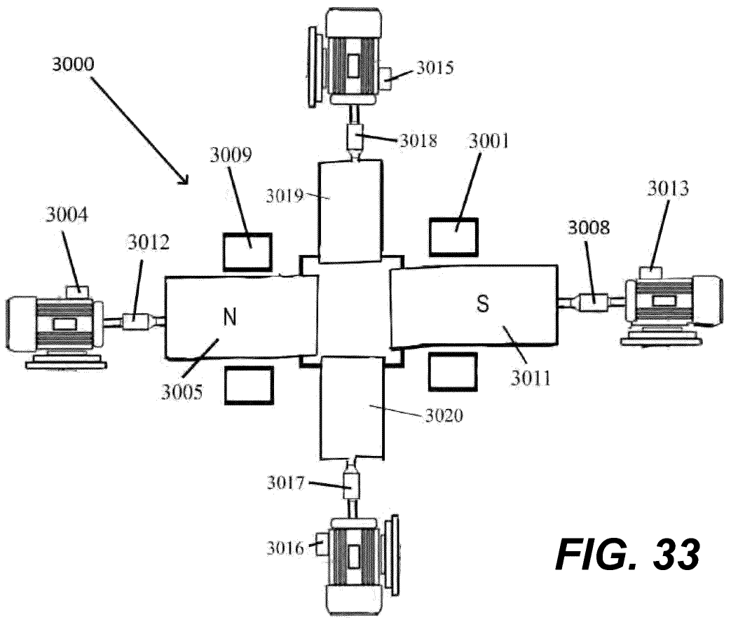

The rotating magnetohydrodynamic generator 3000 of FIGS. 32 and 33 provides for reduction of the formation of nucleation sites on the thermally exposed surfaces of cylinders 3005, 3011 by incorporating rotation and/or vibration of the magnetic cylinders 3005, 3011 and electrode cylinders 3019 and 3020, which are similar to the cylinders used in the previous embodiments, using with motors 3004, 3013, 3015 and 3016 and/or vibrational transducers 3008, 3012, 3017 and 3018. These motions serve to significantly reduce contact time between any specific region of the surface area of the magnetic or electrode cylinders to the flowing plasma. The rotation and/or vibration also interrupts the formation of nucleation damage sites, as discussed above with regard to the previous embodiments, thus preventing their spread into other areas. These actions further serve to reduce the excessive amounts of thermal energy that can be transferred to the cylinders 3005, 3011, 3019, and 3020 through thermal conduction by limiting the plasma's effective contact time with the surfaces. This can create an almost vacuum-like thermal protective zone between the plasma and the surfaces while not impeding ionic and electron flows to the surfaces of the electrode cylinders 3019 and 3020. Although a combination of vibration and rotation is most effective, it should be understood that only one of these methods may be used without departing from the spirit and scope of the present embodiment.

As the high temperature plasma traverses through conduit 3006, the magnetic cylinders 3005, 3011 will alternately attract and repel the ions and electrons in the plasma stream, depending on their charge, causing them to be directed to either the electrode cylinder 3019 or the electrode cylinder 3020, as shown in FIG. 33. This allows for an electrical potential to be realized, which may be taken advantage of to power a load by attached contact brushes, induction or the like (not shown), thus allowing useful work to be performed.

As discussed with regard to the previous embodiments, if a hydrocarbon-containing gas, such as methane, as a non-limiting example, is the originating material and introduced through pipe 3050 or pipe 3052, FIG. 32 into the plasma, the cooling effect caused by electrical recovery through the rotating magnetohydrodynamic process causes the elements to cool at an extremely fast rate, causing the carbon in the gas to precipitate out in its solid form, leaving mostly hydrogen gas, a portion of which will be in the form of monatomic hydrogen.

Despite all efforts to minimize the erosion of the electrode and magnetic cylinder surfaces by the plasma, including active cooling, some material loss from erosion will ultimately occur. This erosion can be compensated for through the movement of, as a non-limiting example, hydraulic cylinders 3002, 3010 shown in FIG. 32 respectively associated with cylinders 3005, 3011, FIG. 32 and also by a corresponding pair of hydraulic actuators (not shown) which move the electrode cylinders 3019, 3020 FIG. 33 in a similar manner. This permits fresh surface material to be introduced for contact with the plasma stream, replacing the eroded material. The hydraulic cylinders can also be used to adjust the aperture, thus focusing the plasma and altering its resulting dynamics. This ability can, if desired, pinch the plasma to generate a Monroe like effect. The Monroe effect is commonly used in the explosives industry to focus an explosive shock wave and increase the speed of the transiting wave front.

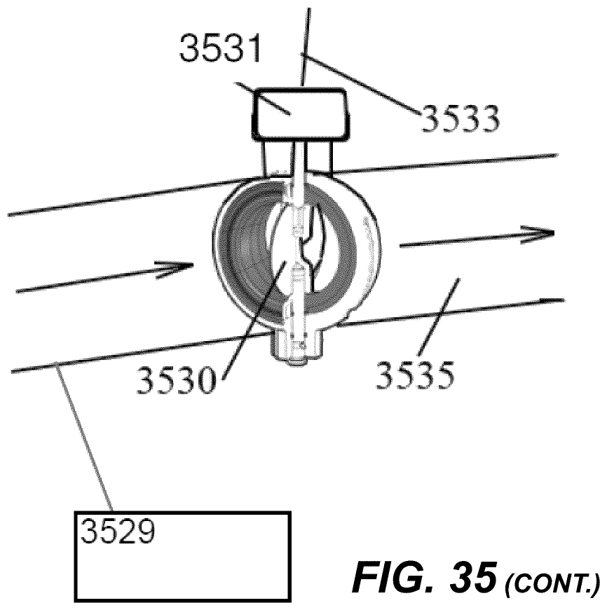

Referring to a further embodiment in FIG. 35, improvements in turbo jet and turbine engines used for other purposes, such as, for example, rotary motion output and power generation, are provided. This embodiment specifically addresses the limitations of their thermal endurance, while also allowing for novel methods for sound mitigation, the dissipation of unsafe stall conditions which improves responsiveness. These engine improvements result in increases to overall efficiency and fuel consumption, while also introducing methods for minimizing damaging shock waves and, in the case of jet engines, these improvements allow for potentially higher maximum operational speeds.

Turbine engines, including jet propulsion, are well-established technologies for powering high-speed aircraft. However, their performance is fundamentally constrained by the temperatures generated within the engine during operation. As the compressor section of the turbine speeds up, by design, the incoming air experiences compression leading to a significant rise in temperature. This thermal energy, in conjunction with the heat released during fuel combustion, can result in critical components exceeding their thermal tolerance, potentially leading to catastrophic failure.

The present device seeks to mitigate the aforementioned limitations by introducing active design features that enhance the engine's thermal management capabilities. These active control measures can also be configured to limit undesirable loud noises from the engine. Specifically, the invention proposes a novel active cooling system that effectively dissipates heat from critical components, enabling sustained operation at elevated temperatures by utilizing a method that captures and converts potentially damaging thermal energy into an electrical output which can then be used to perform other necessary functions, such as for non-limiting examples, those necessary for its operation, such as, compressing incoming gases. This serves to allow safer higher temperature operation while recovering and converting this unsafe thermal energy in a manner that allows the recovered energy to increase overall device efficiency.

In addition to concerns of overheating internal components from this required air compression, jet engines are always associated with unpleasant loud noises which also can result in higher maintenance requirements and the potential of structural damage to the engine and other components.

Shockwaves, a phenomenon arising from supersonic airflow, pose another significant challenge for turbines used for jet propulsion and affect performance at high speeds. As the aircraft approaches the sound barrier, the airflow through the engine can undergo abrupt changes in pressure and density resulting in the formation of shockwaves. These shockwaves disrupt the smooth flow of air impeding the engine's efficiency and also will generate additional heat.

When an aircraft surpasses the speed of sound, the air in front of it gets compressed rapidly. This compression inherently results in a rise in temperature. The highly compressed air within the shockwave interacts with the aircraft's surface, leading to friction. This friction further contributes to the generation of heat.

The present systems and methods address this issue by incorporating active direct cooling measures including an alternating thrust potential that interrupts the formation of shockwaves creating a fully controllable aerodynamic feature designed to mitigate the adverse effects of shockwaves. These features may include the use of an electronically controlled pulsation system, with no moving parts, produced by a turbine blade assembly which is configured to operate as a magneto hydrodynamic power generator or alternatively a thrust enhancement device. This ability allows this system to be configured to act as an electrical generator or propulsive enhancement method which would be able to react in real time when undesirable shockwaves or unwanted noises are detected. This serves to minimize disruptive shockwaves through the generation of vibrations which, while being identical, are 180° out of phase with the undesirable waves, producing an overall active sound canceling effect specifically targeted to the offending frequencies.

These same methods, under other operational requirements, can be configured to also actively cancel a percentage of undesirable noise generated by the engine's operation and its combustion processes. This is accomplished through the use of active sound mitigation techniques, by the introduction of adjustable frequencies matching some of the undesirable sound frequencies but are likewise 180° out of phase thereby producing a sound canceling effect. Instead of using electromagnetic vibrating diaphragms, loudspeakers, the system proposes the use of the variable combustion processes discussed here, to create greater sound energy events than traditional methods would normally allow without significant increases to the size of the engine.

By utilizing these methods, the disclosed engines are able to produce sound cancellation effects that also extend out through the engine's exhaust potentially being effective for the reduction or cancelation of unwanted sounds created by an aircraft traveling at supersonic velocities including the sonic booms.

Material limitations also play a crucial role in determining the maximum speed of a turbine or turbo jet engine. The extreme temperatures, pressures, and centrifugal forces encountered within the engine necessitate the use of specialized materials with exceptional thermal and mechanical properties. These materials, such as nickel Inconel and stainless-steel alloys, are expensive. These costs are further increased though the use of cutting-edge advanced metallurgy including single crystalline grown blades.

The present subject matter proposes the utilization of a direct method for the active cooling of exposed turbine blade surfaces. This active method directly and rapidly enhances the thermal integrity of the turbine blades, most particularly in the hot section. This allows the blades to withstand temperatures above what they would ordinarily be able to structurally tolerate, increasing their ability to resist deformation. The Turbine Magneto Hydrodynamic Cooling (TMC) techniques disclosed here, when employed, enable the engine to operate reliably under extreme conditions, well beyond their normal safe upper thermal operating conditions.

In addition to this protective effect, this action generates a useful electrical output which could be utilized to augment other processes required for the turbine's function, such as the compression of the incoming air or the potential reduction or elimination of the auxiliary power unit.

A compromise that turbine manufacturers have been employing is the use of non-ideal fuel air ratios to lower the internal temperature of the engine. This leads to obvious inefficiencies and reductions in their maximum capable output. Many of these inefficiencies can be mitigated through the use of these methods allowing the engines to operate at closer to ideal fuel air mixtures.

The maximum achievable compression within a turbine or turbojet engine is constrained by several factors, with a primary limitation being the turbine blades that are on the hot side of the engine. These blades are exposed to extreme temperatures from combustion gases, and even with advanced materials and cooling techniques, there are unsurpassable limits to the temperature they can withstand before structural failure occurs.

Another major limitation to the ultimate achievable compression by a turbine is due to leakage between the turbine tips and the outer casing. One aspect of the current device is a method for reducing these leakages using directed high energy sonic waves, produced by transducer 3511, mimicking the action and general profile of edge of the turbine blades projecting in the gap to the inner casing surface.

Higher compression ratios generally increase thermal efficiency in the engine cycle, but this also results in hotter combustion gases, further stressing the turbine blades. These thermal constraints have meant that higher more efficient engine temperatures along with the use of increased more ideal compression ratios have not been considered, due to the metallurgical thermal limitations of the blades the currently disclosed device describes methods where these compression pressure ratios can be considerably and safely enhanced without compromising the thermal integrity of the internal, exposed components.

To maintain safe operating temperatures, a current advanced technique employed in standard turbines, to mitigate this harmful effect, is to redirect a portion of the compressed air and divert it for blade cooling. This technique, however, besides making the already expensive blades even more challenging to produce, introduces additional costly and complex design techniques. This advanced traditional method, while being marginally effective, siphons off the air available for combustion and thrust, thus creating a trade-off between the cooling requirements of the blades and engine performance resulting in reductions to the overall net efficiency.

In most cases, the currently disclosed device eliminates or greatly reduces the requirements for these extreme and costly measures. While turbine blade limitations are a major factor, other considerations influence compression pressure. The compressor's design, including stage number and blade profiles, affects its ability to achieve high-pressure ratios without encountering stall or surge conditions. Higher compression ratios often necessitate larger, heavier compressor stages, which may not be suitable for all applications. Using the leakage sealing techniques disclosed here could allow for construction of turbines having similar or greater compression with fewer compression stages.

The type of fuel used can affect combustion temperatures and, consequently, the thermal stress on turbine blades. Through the use of these disclosed methods, the range of available fuel types they can utilize safely is greatly increased. The maximum compression pressure in a turbine or turbojet engine is a complex interplay of factors, with turbine blade limitations being a primary constraint. Ongoing research into new materials, cooling techniques, and design strategies has incrementally pushed these limits enhancing engine performance, but with higher production costs.

Without active cooling methods, such as those discussed here being employed, these traditional designs will continue to run into limitations imposed by the materials used. While not directly related to turbine function, air resistance, another factor influencing the maximum speed of a jet aircraft, becomes increasingly significant as the aircraft accelerates. The force required to overcome air resistance of the aircraft increases exponentially with speed, necessitating a corresponding increase in engine power. These proposed approaches utilizing active thermal mitigation methods also could serve to introduce a sound canceling effect to the exiting gases which could reduce the energy required to propel the aircraft, while increasing the speed and thrust of the exiting gases enabling the aircraft to achieve higher speeds with greater efficiency.

Sound waves consist of compressions (areas of high pressure) and rarefactions (areas of low pressure) that move outward from the source of the sound. This creates an inefficient situation where potential thrust is lost to the creation of sound wave noise. The energy used to create noise is energy that could otherwise contribute to thrust, especially in systems like jet engines.

By employing the sound canceling combustion processes described here, these losses will be minimized, effectively increasing the power potential to more closely match the total theoretical thrust contained in a given amount of fuel, increasing the effective engine thrust. A supersonic shockwave is a powerful disturbance that travels faster than the speed of sound. It's characterized by abrupt changes in pressure, temperature, and density, resulting in a broad range of frequencies rather than a single one.

Although shockwaves contain many frequencies, some are more dominant than others depending on the speed, shape of the object causing it, and atmospheric conditions. The sonic boom, a loud sound heard when an object breaks the sound barrier, exemplifies this complexity with its wide frequency range and characteristic “double boom” sound.

The sonic boom's pressure profile often forms an “N-wave,” representing a rapid pressure rise, a slower decline, and a quick return to normal. Each part of this N-wave contains different frequencies, with the initial rise usually having higher frequencies than the subsequent drop. These unique shockwaves are intricate phenomena containing a wide spectrum of frequencies making previous attempts at mitigating this negative effect difficult.

The use of the active sound canceling techniques discussed here, can be timed to extend out through the exhaust stream where sensor elements, after detecting sonic booms, could allow the engine control unit to create active noise cancelling, ANC, sound canceling to reduce the unwanted shockwave noise. This could allow aircraft to travel at high speeds around population centers.

While potentially being a destructive force needing to be accounted for and mitigated in the aircraft frame's design and construction, it's also a consideration for the engine design as well. While these shock waves are useful in various scientific and engineering applications, with regard to aircraft and engine design, they are mostly considered a negative factor requiring additional strengthening with the resulting weight penalty.

In a supersonic shockwave, the most destructive frequencies are the ones that match the natural frequencies of objects they hit. This causes resonance, and it can greatly intensify vibrations, if unaccommodated for in the design, with stresses that could potentially break or damage an unreinforced object.

These forces impact the outer structure of aircraft and also have to be accounted for in engine design. Often structures, such as engine cowlings, are employed to deflect the direct impact of these waves, but the engine will still receive lower intensity impacts from the reflected components of these waves which will cause problems if not accounted for usually by strengthening structural members

The exact nature of these impacts on the structure depends on its size, shape, and materials which all contribute to determining its natural frequencies. Characteristics of the shockwave are highly significant factors when considering this interplay, specifically how strong it is, its duration, and what frequencies it contains, will all effect which frequencies will have the greatest potential to cause destructive resonance.

The most obvious and generally observable impact from these waves occurs in the creation of a sonic boom. Their low frequencies (usually under 100 Hz) can shake buildings and sometimes cause damage. Supersonic aircraft have to be designed to accommodate and mitigate these shockwaves that would otherwise damage their own structure by triggering resonance. These blast waves are very strong and sudden, so they can excite lots of frequencies and have potentially damaging consequences. Engineers reduce damage from resonance by designing stronger structures, using stiffer materials, changing the shape or size, or adding dampening materials. The active measures, discussed here, have the ability to dampen and mitigate the damaging impact from shock waves on the entrance components and can additionally or alternatively be tuned to also allow for methods for the significant reduction of the engine's operational noise.

In addition, it has been considered that the methods described here could also use the jet's exhaust to produce canceling sound waves which can greatly mitigate the sonic boom which would otherwise be produced by the aircraft. Active noise cancellation (ANC) is a method for the reduction of unwanted sound by introducing a second sound specifically designed to cancel the first. It is based on the principle of destructive interference.

Sound travels as a series of pressure waves, consisting of alternating periods of compression and refraction. Many ANC systems are utilized for public address and in the recording industry. They often utilize microphones for the detection of unwanted ambient noise, which is then analyzed by a processor. The processor generates an “anti-noise” signal that is equal in amplitude, but opposite in phase to the original noise.

When these two sound waves meet, the compressions of one align with the refractions of the other, resulting in destructive interference. This effectively cancels out the noise leading to a reduction in the perceived sound level of the unwanted signal. Modern ANC systems employ digital signal processing (DSP) algorithms to analyze and adapt to the incoming noise, providing effective cancellation across a wide range of frequencies. This technology is commonly used in headphones, earbuds, and even some cars to create a quieter and more comfortable listening environment.

In the disclosed embodiment, instead of using audio speakers, interference patterns are created by varying the speed and flow of the transiting combustion byproducts across the modified, active, Magneto Hydrodynamic turbine blades presented here or could be generated through a frequency induced fuel input pressure system.

In operation, a turbine or turbojet engine is used to both power propeller and jet aircraft. Turbines are also employed for numerous other purposes including power generation. Turbines and turbo jet engines used in aircraft operate on a continuous cycle of air intake, compression, combustion, and exhaust, fundamentally similar in many aspects to its cousin, the gas turbine used for power generation and for other uses where a rotary output is required, but the turbo jet engine is designed to favor a forward thrust potential.

In the forward-facing intake opening of the turbojet, a turbo fan intake draws in large quantities of air. This air is then funneled through a series of rotating compressor blades and stationary vanes 3502, shown in FIG. 35, which compresses the incoming gases in a series of incremental stages, increasing its pressure and temperature, in a similar manner to the compression stage of a rotary output gas turbine.

This compressed air enters the combustion chamber 3508 in FIG. 35, where it mixes with a fine mist of fuel, normally kerosene, in combustion section 3508. Once the compressor is up to speed, igniters, which could utilize the plasma injectors 3525 if used, produce a cascading chemical ignition potential throughout the surrounding fuel resulting in a continuous self-sustaining flame front. This rapidly expanding front is caught between the momentum of the incoming pressurized air produced by the compression section 3502 and a less restrictive exit through the hot section rear turbine blades 3505, encouraging a positive thrust potential. These actions also produce rotation of the compression stages through the recovered energy transferred through the common connecting axle 3514, an element found in both gas turbine and the turbo jet engines.

As the hot expanding gases interact with the angled blades 3502, the blades' angle redirects the forces impacting on the blades producing rotary motion. Action that also will absorb some potential energy from the expanding wave front, while also allowing the exiting gases to produce a forward thrust potential. The rotating gas turbines' main distinction from a turbo jet engine, in many cases, is the fact that it a uses a greater number of blade sections to recover more additional rotary power, since a thrust output potential is not required. In both of these engine designs, the energy required to operate the compressor section of the engine, while necessary for operation, results in a net loss of recoverable potential thrust or rotary output horsepower.

In a gas turbine, the spinning turbine shaft, while still being required to run the compressor, is also connected to work, such as a generator, transforming this mechanical motion's energy into electrical power. However, due to the previously discussed energy requirements for the compression section, this results in the reduction of its ultimate usable power output as well.

Another consideration, as previously mentioned, are the thermal limits of the materials used in the hot sections' blades construction required for safe operation. The still-hot exhaust gases, after passing through the hot sections' turbine blades 3505 in a turbo jet engine are then expelled through a nozzle 3506 at the rear of the engine. This high-velocity exhaust generates thrust, propelling the aircraft forward. In a gas turbine, the exhaust heat can often be harnessed for additional power generation through a heat recovery steam generator (HRSG).

While both turbojet engines and gas turbines share a common core principle of converting fuel energy into mechanical energy, their applications diverge. Turbojets prioritize thrust for propulsion, while gas turbines focus on converting most of that thrust potential into rotary power.

Another serious issue that can be encountered during the operation of a turbo jet engine is called stall. The normal pressure in a turbojet engine's combustion chamber is highly variable. It depends on the engine's design and operating conditions. It has a wide variable potential (approximately ranging from 9.6 to 30.3 bar). This pressure is essential for efficient combustion and for the creation of a thrust potential. Several factors influence the pressure within the combustion chamber.

Highly impactful to the overall turbines performance is the Compressor Pressure Ratio (CPR). The compressor's ability to compress incoming air directly affects the pressure in the combustion chamber which also increases the temperature of the gases through compression. A higher compression ratio results in higher combustion pressure and its ultimate temperature.

The amount of fuel injected into the combustion chamber directly influences the air fuel ratio which is also a factor in determining combustion temperature and the ultimate energy that will be released during the combustion process influencing the engine's total pressure and overall efficiency. The temperature of the gases entering the turbine inlet is another factor that will influence the pressure in the combustion chamber. As a general rule, higher temperatures will often lead to increased combustion chamber pressures.

A compressor stall is a serious condition which can occur in a turbine or turbo jet engine when the airflow through the compressor becomes a nonlinear, disrupted stream. This can result in a sudden drop in pressure with a potentially dramatic effect on engine performance, including, in worst case scenarios, complete engine combustion-thrust failure.

A high angle of attack, exceeding the critical angle of the compressor blades, can cause airflow separation from the turbine blades potentially resulting in a stall. Engine ingestion of debris or foreign objects can damage the compressor blades, disrupt smooth airflow and can create stall conditions. Rapid changes in throttle position can also produce pressure fluctuations and can lead to stall conditions. In flight training, pilots are instructed to only advance the throttles of jet engines slowly. This, in most cases, will mitigate this particular issue, but it also interferes with the ability for fast intervention when quick action is required. Engine stalls can also occur when the engine is operated at high altitudes or in turbulent airflows. Compressor stall can have serious consequences, including a loss of engine power that can require, in extreme events, restarting the engine with the associated loss of time needed to get the engine up to power.

Stall conditions significantly reduce the engine's ability to generate thrust, potentially leading to a loss of aircraft control. The pressure fluctuations and vibrations during a stall have the potential of damaging compressor blades and other engine components. This serious condition has been extensively studied, and numerous methods have been developed to prevent it. Modern turbojet engines often are equipped with a variety of systems to prevent and mitigate compressor stall. One mechanically complex method used to mitigate this condition is the use of Variable Stator Vanes (VSVs). These adjustable vanes allow for the optimization of the airflow through the compressor, reducing the risk of stall. Bleed valves are another method for reducing or eliminating the risk of stall conditions. When a stall is detected, these valves release a portion of compressed air from the compressor section, helping to maintain stable airflow. While this can be effective, it is energy inefficient and reduces overall engine performance.

Sophisticated Engine Control Units (ECU)s, which monitor engine parameters and adjust fuel flow and other variables, are used extensively for general engine control and for the prevention of engine stall conditions. The disruption of airflow and the drop in pressure can lead to a flameout in the combustion chamber. The flame can be extinguished due to the lack of sufficient airflow and the resulting change in the fuel-air mixture. The temperature in the combustion chamber drops rapidly as the flame is extinguished. This can cause thermal shock to the combustion chamber components.

In some cases, the engine may be able to relight the flame once the stall condition is resolved, and airflow is restored. However, this depends on the severity of the stall and the engine's design. Understanding the normal pressure range in a turbojet engine's combustion chamber and the conditions that can lead to stall, is essential for ensuring safe and efficient engine operation.

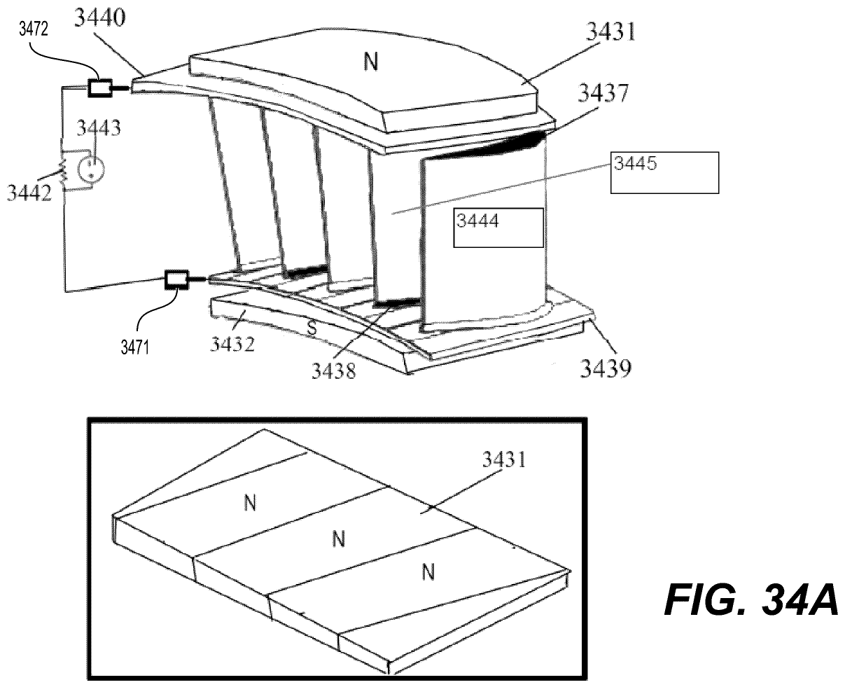

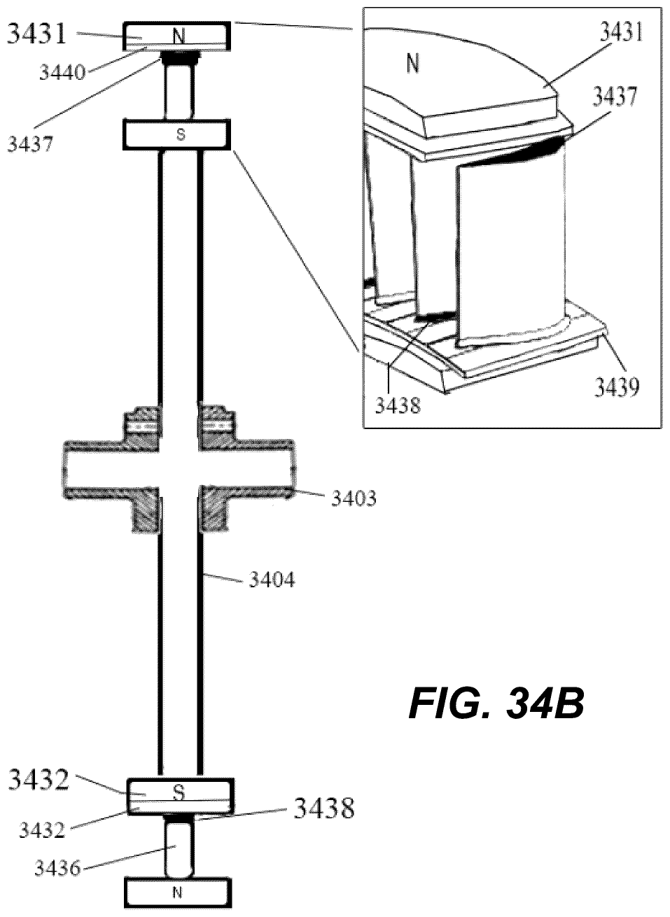

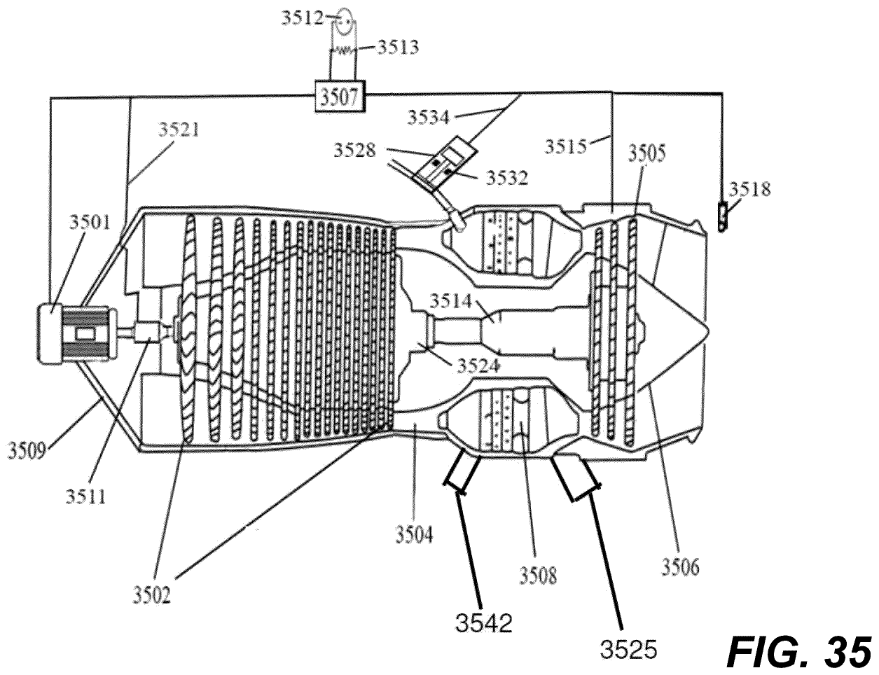

The disclosed device also uses ECU module 3507, FIG. 35, that can operate in a similar manner to traditional ECUs, but while this unit can perform the functions of a standard module, it is additionally configured to have the ability to interact actively controlling the flow of air through the turbine engine. This action also allows for the stall condition to be interrupted through the intervention of the active turbine blade assemblies shown in FIG. 34A. The potential actions from these blade assemblies can serve to either increase the speed and flow of gases through the introduction of electrical power from power supply 3512 in FIG. 35, which conducts across the ionized combustion plasma while also interacting with the polarized magnetic fields emanating from the magnet means 3431 and 3432, shown in FIGS. 34A and 34B, causing gas movement to continue. By applying a load 3442 across conductors 3439 and 3440 will cause the flow rate of gases to slow. Conversely, if power supply 3443 is utilized the flow of gas will increase. Either action or the two alternatingly combined can create a waveform in the exhaust plume. Through this active intervention, the stall condition can be minimized or eliminated by maintaining gas flow rates throughout the compressor section of the engine assembly. This also will allow for greater and more rapid control of the engine's throttle, giving greater and faster control options to the pilot.

Additionally, accelerating gas action, created by applying a voltage potential across the ionized combustion gases, also will increase the velocity of the exiting combustion gases resulting in greater thrust creating potentially higher overall speed of the aircraft when compared to a conventional turbo jet. While operating the disclosed turbojet engine in this manner alleviates stall conditions, it also has other benefits of increasing the thrust's speed. In an alternative electrical configuration of the blade, when it's connected to a load 3513, it is able to recover an electrical output from the transiting ionic gases through the magnetohydrodynamic generator effect.

The withdrawal of electrical energy produces a cooling effect for the blades 3505 allowing them to operate in the presence of extremely hot plasma without losing structural integrity. This can also result in higher combustion pressures allowing for the safe use of more robust combustion temperatures which results in overall greater efficiencies.

This electrical output can perform many required functions. It has been considered that this electrical output transferred through cable means 3515 to the engine control unit, ECU 3507, could be transferred to electrical motor/generator means 3501. By redirecting this energy in this manner, not only does it remove the potentially damaging temperatures impacting blade means 3505, but allows this energy to perform useful work while reducing some of the parasitic losses required for operation of the compressor means 3502. The device described introduces a method that, while permitting efficient high temperature operation of a turbine, also provides methods for active, rapid, real-time control of internal engine parameters including thrust.

In operation, engine startup commences when controller means 3507 withdraws electrical energy from power supply means 3512 causing motor generator means 3501 to start rotating. This rotation of the compressor means 3502 in FIG. 35, serves to increase air pressure within combustors 3508. When this pressure is high enough, fuel is added and the electrical ignition could be produced by many traditional sources including the plasma injector 3525 causing combustion and thrust to be produced impacting on the hot zone blade 3505 assembly, recovering energy which in turn powers the compressor blades through axle means 3514, as is done in current engine designs

After ignition, the turbine motor/generator means 3501 can be disengaged permitting self-sustaining operation of the engine in a similar manner to standard jet engines. The proposed device considers methods for safely operating these engines at elevated temperatures where they can realize higher levels of efficiency. These higher temperatures also allow for the development of ionization in the combustion gases permitting a Magneto Hydrodynamic Generation effect to produce an electric output. This energy is conveyed by the brush means 3471 and 3472, to a load 3513, FIG. 35. Alternatively, the engine could be configured to increase the output thrust potential by applying an electric input from power supply 3512 across the ionized combustion gases and plasma creating a high speed accelerated thrust potential.

Combustion flame temperatures normally need to be sufficiently high in order to achieve the ionization required for MHD generators to operate effectively. Typically, these temperatures are in the range where the structural integrity of many metals is reduced.

These high temperatures ensure that a significant portion of the gas molecules are ionized, creating the electrically conductive plasma necessary for the generator to function. The specific temperature requirements may vary depending on the working fluid used and the desired level of efficiency. Several methods can be employed to promote sufficient flame ionization for MHD operation at lower temperatures. Preheating the oxidizer (air or oxygen) before it enters the combustion chamber can elevate the overall flame temperature. This can help achieve the necessary ionization level even with a lower initial fuel temperature.

The current proposed device uses air compression to initially raise the inlet oxidizer or air temperature. Several methods can be employed to promote sufficient flame ionization for MHD operation at lower temperatures. These include introducing easily ionizable substances, such as alkali metals (e.g., potassium, cesium) or alkaline earth metals (e.g., barium), into the combustion mixture will significantly increase the electron density within the flame. These seed materials each have low ionization potential, making them readily ionized at lower temperatures compared to the primary fuel and oxidizer.

Optimizing the mixing of fuel and oxidizer within the combustion chamber is another method that can promote more complete combustion and a more uniform temperature distribution. This also can prevent localized relatively “cooler” spots that might otherwise hinder overall ionization.

A high-temperature plasma produced by plasma generation means 3525 in FIG. 35, can stimulate a lower-temperature surrounding gas, creating favorable conditions for magnetohydrodynamic (MHD) generation or propulsion. High-temperature ionic plasmas streams are excellent conductors of electrical energy. When a high-temperature plasma interacts with a surrounding lower-temperature gas, it can transfer energy through a number of mechanisms. The heat from the higher energy plasma can ionize the surrounding gas, increasing its electrical conductivity and conversion efficiency.

High-energy electrons in the plasma can collide with neutral atoms in the lower temperature gases, exciting their electrons to higher energy states. This can lead to a greater level of overall ionization. The higher temperature plasma will emit photons that can be absorbed by the surrounding gases, contributing to overall heating and ionization of the total transiting gas stream. Due to the excitation of the surrounding electrons, this high energy plasma can act as a seed promoting greater ionization of the surrounding gases without heating them to the same temperatures as the plasma generator's output.

The resulting increase in electrical conductivity in the surrounding gas is a crucial component for efficient MHD power generation. In an MHD generator, an electrically conductive fluid (in this case, the ionized gas) flows through a magnetic field, created by magnet means 3432 and 3431 in FIG. 34A, inducing a polarized electric current output. The higher level of conductivity of the fluid, the more efficiently the generator will convert the kinetic energy of the fluid into electrical energy that is recoverable by the turbine blade means 3444, 3445. FIG. 34A

Introducing a hot plasma stream from the plasma generator 3525 into the center the relatively cooler fuel as it enters the combustion chamber, or alternatively, introduced directly before the high temperature turbine blades 3505 allow for the ionized plasma to seed the surrounding fuel allowing more efficient operation of the MHD functions at lower temperatures. This can promote additional energy through the use of free electrons, seeding the flame front. This assists in initiating and sustaining ionization at lower temperatures, promoting greater electrical recovery while allowing more manageable relatively cooler gases to be efficiently used.

The current design proposes the use of frequency stimulation or positioning from linear actuator transducer 3511 which can also induce a repetitive vibration to the shaft 3514 and compressors 3502. These vibrations travel through the gases as they are compressed into the combustion chamber where this added physical stimulation can promote greater levels of ionization to occur at lower temperatures by providing a first level of stimulation to the transiting gases and their electrons while also inducing a sonic resonance.

Methods like the use of microwave or laser-induced ionization can create non-equilibrium plasmas where the electron temperature is much higher than the surrounding gases' temperature, plasma injectors 3525 can alternatively be configured to utilize these methods or use them in combination with other plasma generating methods. This allows for a sufficient level of ionization to be created even when the overall flame temperature is relatively low.

These methods could be used individually or in combination with other techniques to achieve the required level of ionization for MHD operation at temperatures significantly lower than the conventional 2500-3000° C. range. This can lead to improved efficiency by reducing material limitation constraints and creating broader applicability of MHD technology for aircraft and high efficiency turbine generator applications. The overall efficiency can be greatly enhanced by employing these techniques in addition to the recovery of the rotary energy through a generator, such as, motor/generator means 3501.

The disclosed devices also offer numerous methods for cancelling unwanted noise normally produced by these engines that could be used alone or in addition to the other proposed methods. It could either be used to produce a reinforcing, common, higher amplitude, canceling wave, or produce different waveforms covering a greater range of more complex noise.

Another method proposed for use in the current device are fuel modulation systems, 3530 in FIG. 35 (cont.) or 3528 in FIG. 35 for non-limiting example, for reducing unwanted noise in a turbine engine through ANC. The disclosed fuel system creates oscillations in the fuel supplying the combustion chamber by butterfly valve 3530. This results in the creation of vibrating fuel pressures at adjustable frequencies and patterns. These frequencies are translated into a sonic output when the fuel is combusted which travels with the flame front. The sonic stimulation can serve to promote greater electron mobility in the flames increasing ionization at lower temperatures while also being able to be utilized for reducing unwanted noise created by creating a series of combustion events 1800 out of phase with the offending noise producing active sound cancellation.

Sound waves consist of two elements, compressions and rarefactions. The canceling waveform could be generated as an identical one mimicking the unwanted waveform, but 180° out of phase in such a manner that the compression region of the wave, where the particles are pushed closer together, results in a higher pressure and density region, can be timed so that it will align with the rarefaction, lower pressure wave region of the noise resulting in sound cancellation of both waveforms.

Another consideration is timing. Due to the motion of the waveform, the fluid particles move in the same direction the wave is traveling. This forward motion is what transfers energy and propagates the sound. The canceling waveform has to be timed so that it encounters the noise at the correct spatial region requiring exact timing for this location in space.

There are a number of potential methods discussed here for introduction of pressure variable wave forms onto the fuel entering the combustors. These techniques could be utilized for noise cancellation effects, which could also have the added benefit of also being able to promote a higher velocity thrust potential.

One method which could be used is fuel modulation device 3528. This method uses a magnetic coil or piezoelectric transducer 3532 controlled by the ECU via 3534, for the introduction pressure wave fluctuations which can lead to a controllable sonic output via a diaphragm or piston onto the transiting fuel. This can produce micro detonation combustion events which have shown promise for increasing thrust in rocket engines An alternative fuel modulator 3529 uses a ball valve, butterfly valve or other pressure balanced valve types 3530 which can be rapidly moved by potentially a galvanometer, servo motor, electrical coil, pneumatic, piezoelectric, or other rapid motor types 3531 connected to the ECU by wire means 3533. The resulting waveform is translated into a modulated combustion event waveform that can provide active noise cancelling to the thrust output while providing initial stimulation of the transiting fluid helping later during the combustion and or plasma injection stage promoting greater ionization at lower temperatures in the transiting wave front. The frequency and that of the plasma injector could be timed to produce a beat frequency potentially amplifying their ionization effects. These methods could be used independently or coordinated with the other described systems.

All the embodiments described that utilize ionic electrical methods can, in addition to power generation, be configured to increase thrust potential. It also could be used to produce a sound cancellation effect for unwanted noise emanating from the engine. The sound sensor 3518 first senses and maps the offending sound waves and through the engine control unit 3507 which can direct electrical impulses from power source 3512 through the electrical brush means 3471 and 3472, which are showing for convenience as an inductive means could also be used to transfer electrical energy to the magnetic blade assemblies collectively referred to as 3505. This produces an alternating gas pressure output composed of higher speed and slower, lower energy waves created in the emerging exhaust thrust stream.

If these waves are configured by the ECU 3507 to be identical to, but 180° out of phase with the offending noises sensed by 3518, then these pulsations can produce an active sound cancellation effect which is capable of reducing the sound level of the undesirable targeted frequencies.

To elicit even greater cancellation effects, ECU 3507 can, in addition, apply electrical energy from the power source 3512 and apply it to one phase of the output signal, increasing gas acceleration, alternating with electrical recovery from the ionic thrust producing gases by the magnetohydrodynamic generation effect, directed from the ionized gases to the load means 3513. This recovered energy will reduce the speed of the transient gases as it transfers energy to a load 3513. This combined effect, if required, serves to greatly enhance the total amplitude of the outputs ANC creating an even greater sound deadening potential. Conceivably, both the load 3513 and power source 3512 could be combined to function as an electrical capacitor that both stores and releases electrical energy in the desired waveform.

This method does not necessarily have to consume all the electric output potential from the electrode blade means 3505, so a significant portion could be additionally utilized by the motor generator 3501, which reduces the parasitic losses from the compression stage while also serving to cool the blade assemblies 3505. This allows the hot sections blades to operate in a higher temperature, more energetically intense, plasma environment, which promotes greater electrical conversion efficiency from the transiting ionic plasma. Conversely, some of the recovered electrical energy could be used to create a pulsating higher speed thrust potential, while allowing a portion to be recovered and utilized by the motor means 3501 or for any other desired purpose.

The transducer means 3511 shown in FIG. 35 is capable of producing a slight forward and backward movement of the common axle means 3514. This stimulation puts in motion the compressor means 3502 and the hot section turbine blades 3505. This vibrational energy could be recovered and balanced by a spring or pneumatic means which could be incorporated into 3524.

If slip-joint 3524 is installed, then this motion can be confined to just the compressor section which would allow for these pressure wave pulsations to be mostly confined to the compression section allowing different waveforms to be generated and used in the combustion area.

This slight back-and-forth movement produced by transducer 3511 would normally cancel each other out, but when combined with the momentum created by the directional gas flow established from the energy created by rotating compression blade assembly 3502 these combined motions serve to create a directional force. This allows the vibrations generated by transducer 3511 to produce fluid momentum resulting in higher potential fluid compression in the combustion section 3502. These combined forces can overcome some of the normal gas compression losses encountered in standard turbines.

Gas turbine engines experience various gas compression losses that affect their overall efficiency and performance. These losses primarily occur within the compressor section, where air is compressed to high pressures before entering the combustion chamber. These include aerodynamic losses arising from the interaction of air with the compressor blades and internal surfaces. Additionally, this includes losses created by friction between the air and the blade surfaces, as well as the formation of wakes and boundary layers. By vibrating the blades, losses due to friction are reduced as contact time with the transiting gases are reduced and lower pressure zones along the blade are also produced. Tip leakage losses, another cause of turbo compressor inefficiencies, occur when air leaks through the clearance between the blade tips and the outer casing, reducing compression efficiency.

Secondary flow losses caused by complex flow patterns, including vortices and separation within the compressor passages, also absorb potential energy. Vibrating the compressor blades further serves to disrupt the formation of vortices, minimizing these potential losses.

These vibrations introduced by transducer means 3511 combined with the rotational motion of the turbine serve to greatly reduce compressor section gas leakage by projecting outward a directed sonic resistive wave barrier emanating from the angled turbine blade tips across the gap towards the outer casing. This action serves to scrub areas that otherwise normally would result in gas leakages, scavenging the inner surfaces between the blade tips and the turbine's casing. Since this resistive sonic barrier is shaped like the blade tip and is rotating, it forms an inward directed force mimicking the action of the turbine blade. This action serves to reduce leaks that normally occur in this gap. This will promote higher compression in the combustion zone with increases to the systems' overall thermal efficiency and to the engine's ultimate thrust potential or rotational recovery. The pressures in the combustion area can be monitored by the transducer means 3515 producing information concerning pressures and the frequency pattern in the combustion chamber creating feedback to the ECU 3507.

The sound frequencies generated by 3511 can also play a role in augmenting the active noise cancelling ability of the engine. The ECU 3507, after receiving the signal pattern of the concerning noise from sensor 3518, generates an out of phase, but otherwise identical canceling frequency pattern to target the noise. This noise canceling source can function independently or in conjunction with the previously described active magnetic ionic method and fuel modulation methods. Magneto hydrodynamic generation (MHDG) used by the hot section turbine blades 3505, for either increasing the amplitude of the combined noise canceling signal or could be directed to intercede with a wider range of other frequencies generated by combustion and the engines functions.

These ANC generated canceling frequencies, if the aircraft is traveling fast enough to create a sonic boom, could be configured to match the boom's sonic frequencies, but 180 degrees out of phase and timed to extend out of the engine outlet nozzle. This will then allow the sonic canceling effect to actively reduce or eliminate the boom.

This same series of motions produced by the vibrating means 3511 combined with the rotation of the compressor blades serve to spread out over a wider non-repeating area from an otherwise focused impacting shock wave entering the turbine's compressor intake from both direct and reflected shock waves limiting potential damage.

In addition to this effect, the shockwave's damaging impacts can be significantly reduced through the use of the active sound cancellation methods used on the hot turbine blade section which could be additionally employed for use in the compression section. Once potentially damaging shock waves are detected by a sensor means, not shown, a matching frequency pattern could be produced from the transducer 3511 that's identical, but 180 degrees out of phase to the impacting shock wave's frequency. The potential use of a slip join and or energy recovery 3524 would also allow for the cancellation frequency of the compressor blades to be different than that of the hot section blades 3505. This would allow the engine to counteract vibrations and noise created from different sources.

The illustrations in FIG. 34A show a close-up view of the construction of the hot section turbine blade electrode assemblies. Electrical insulator 3437 allows for a mechanical connection to conductive metal ring 3440, but prevents electrical conduction, while allowing an electric connection to ring plate 3439. The blade electric insulator 3438 prevents electrical connection to metallic ring 3439 while creating an electrical connection to metallic ring 3440.

The magnets 3431 and 3432 interact with the ionized gases passing through the gap between the blades causing the ions and electrons to diverge. Both of these magnetic means are magnetized at an angle that is identical to the blade angle. This permits the magnetic fields to exist in perpendicular arrangement to the turbine electrode blades, increasing the efficiency when compared to a parallel magnetic field arrangement.

These fields sort out the ionized gases, allowing the ions and electrons to become separated. This allows for an electrical recovery which can be conveyed from the blades to either plate 3440 or 3439 creating the potential for useful electric energy to be used by a load 3513. Alternatively, a power supply 3512 can apply electric current to the moving rotors via brushes 3443 and 3442 allowing for a polarized electric current to be conducted through the ionized gases from the facing blade surfaces. This electrical conduction inside of a magnetic field produces a directional thrust potential which accelerates the exiting gases allowing for increases of the aircraft speed beyond that of what a standard turbo jet engine would normally be capable of.

FIG. 34B shows a cross-sectional view of the hot section turbine blade assembly. In the illustrated device, for simplicity, permanent magnets are shown consisting of other opposite facing 3431 and 3432, however these magnets could consist of electromagnets or superconducting magnets. If the simplicity of permanent magnets is desired, then iron nitride magnetic materials could be considered as more ideal due to their high temperature magnetic capabilities.

The discussion has so far only related to DC electrical output, but by producing an alternating magnetic field with an electromagnet assembly, an alternating current output could be produced as well. The pulsating thrust, useful for noise reduction and for other uses discussed here, could also be accomplished through the pulsations of electromagnets in the described device.

The illustrated design in FIG. 34B shows the magnetic assemblies attached to the blades and will rotate with the blades as a single unit. While this is functional and practical, it is shown to simplify the illustration, however, it has been considered that these magnetic assemblies could be separate and attached to stationary structures of the engine and would have the advantage of reducing the weight while increasing the responsiveness of the rotor blade assembly.

Another advantage of the current design is to reduce carbon dioxide emissions if a hydrocarbon fuel is used, similar in function to many of the methods described throughout this document. If combustion processes are used, then the high temperature flame plasma can, when in an electrical power generation mode, cause some carbon in the hydrocarbon to precipitate out in the form of solid carbon before it otherwise is able to recombine with oxygen forming CO₂ pollution.

While these processes can be more ideally and more completely done in an inert gas or vacuum environment, these same methods can produce significant amounts of solid carbon in an otherwise oxidizing environment of the combustion.

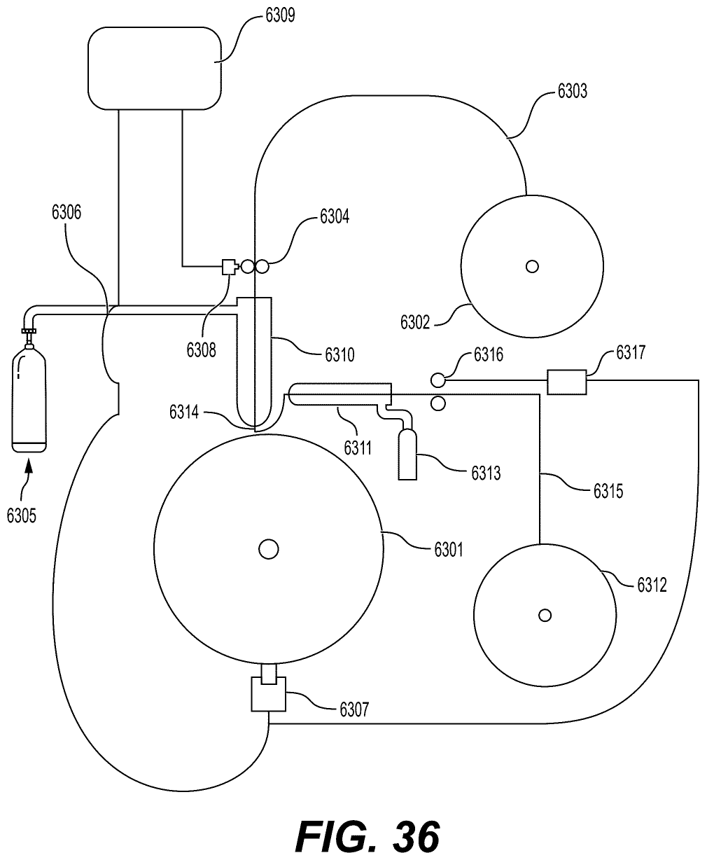

The present disclosure represents an advancement in the field of turbine engine technology. By addressing the limitations imposed by high temperatures, shockwaves, and material constraints, the invention enables the jet to efficiently achieve higher potential speeds with greater efficiency while maintaining operational safety, with reduced noise and reliability. The disclosed design includes features and materials that allow for a new generation of high-performance, fuel efficient, quieter jet aircraft and turbine generators. Referring to FIG. 36, this represents a method of inducing gases and other materials into a molecular or alloy mixture.

The use of wires at a controllable speed for the purpose of infusing gases and other elements, or compounds, alloying them into the structure of the output material has been previously disclosed in FIG. 8.

The process shown here can use a rotating element 6301 as described/shown in FIG. 1, 9A, 9B or dual rotating as shown in FIG. 2A, 2B, or 3, and generate a plasma state through the creation of an arc between wire means 6303 and the rotating cylinder 6301.

A single rotating means similar to FIG. 1 is shown for simplified clarity of the drawing. In FIG. 2A, the wire would extend into the cavity area 28 where it would contact one of the spinning surfaces establishing an arc. In FIG. 2B wire would enter into the gap 222 to establish an arc. In FIG. 3, the wire would be introduced through gap 263 where it would establish an arc. In FIGS. 9A and 9B, an electrically conducting wire would be introduced through 116 where it would establish an electric arc.

In most of these devices described, an electrical output may be generated by the previously described MHD process. This process may also have the ability to increase the rate of thermal energy reduction, as well as, increase the resistance of the rotating means to damage from the plasma's contact.

These processes would be ideally performed in a chamber as previously shown where the pressure could be adjusted from a near vacuum state to higher pressures above that of sea level atmospheric pressure.

As has been noted before, an increase in chamber pressure generally favors an increased ratio of gas and/or infusion of other materials into a combined state output.

This, with the additional control over the rotational speed of 6301, the power level induced from power supply 6309, the rate of wire feed controlled by motor 6308, the type of gases introduced from tanks 6305, 6313, as well as the gases within the chamber vessel creates significant parameter flexibility. This may allow for different types of alloying, and alloy ratios to occur as well as the ability to infuse gases, creating a gas infused, alloyed material, or molecular bonding.

The term wire has been used herein to indicate any materials or group of materials which could be formed having a flexible wire-like structure alone or with other binding elements which would then be converted into a plasma state upon entering the arc zone 6314.

In operation, rotating means 6301, which could consist of a variety of materials, but preferably those with better heat conduction, such as by non-limiting example, copper, or diamond to include doped diamond materials to allow for electrical conductivity, would be set into motion by a motor means not shown. The device works over a wide range of rotational speeds, with faster speeds generally resulting in less susceptibility to material build up on the rotating means and generally a more amorphous state of the output material, but this is highly variable depending upon the materials used and other parameter adjustments. Speeds up to 100,000 or more RPM have been considered as well as lower speeds down to 1 rpm depending on material output characteristics sought. Power supply 6309 is then energized, providing power through the wire feed 6304 completing its circuit to the power supply through brush means 6307. As the wire approaches the rotating means 6301, an electric arc is produced in zone 6314. This arc converts the wire material 6303 and gases into a plasma state in the presence of a surrounding gas where it's able to mix with gas, gases or other materials present in the electrically conductive wire. The wire is fed from spool means 6302. The rate that this wire is fed can be controlled by varying the speed of motor 6308 which regulates the speed of the wire feed mechanism 6304. This mechanism connects the transiting wire 6303 with electrical energy, either DC, DC pulse, AC, or rf. The polarity, if a DC current is employed, can either be positive or negative with regards to the spinning means 6301.

When the plasma consisting of the feed wire and the introduced gases, or other materials from 6305, comes into contact with the spinning means 6301, the material is condensed rapidly and mostly flung off to be collected later at the bottom of the chamber. Due to the extremely rapid cooling of the plasma, the resulting molecularly bonded mixture or alloy output material does not have time for the mixed elements or gases introduced in their plasma state to fully evolve out of the resulting material. This allows for unique combinations of materials that would otherwise not be possible by other means to be able to combine.

One material of interest, previously discussed and described in FIG. 8, is iron nitride. This can be produced in different variations and ratios of nitrogen and iron, but one of great interest is Fe₁₆N₂. This material has the potential of producing extremely strong permanent magnets without the need for rare earth materials.

This material has the potential of lowering the cost of powerful permanent magnets due to its structure which uses two of the most abundant materials on the earth. Furthermore, it has the potential of producing magnetic field lines stronger than the best permanent magnet candidates available, mostly the neodymium variety. It also has the ability to maintain its magnetic properties and intensity in temperatures far exceeding those of neodymium magnets.

This material has been found to only occur in small quantities naturally and its commercial production has been extremely difficult and limited by most methods currently used. The disclosed device has the potential of producing large quantities of this material, quickly and at a far lower processing cost.

This method may produce a large percentage of the iron nitride output in the physical form of small spherical balls FIG. 31A before further processing occurs. Early indications show that this shape has many other potential attributes and is able to help it maintain magnetic stability over a greater range of conditions and temperatures than current methods. It has also been considered that the co-implanting of elements like chromium (Cr) and aluminum (Al) along with nitrogen have potential to increase the thermal stability of the iron nitride phases, compared to pure iron infused only with nitrogen, and could be used, in addition to its natural stability, by the disclosed methods.

Having greater control over the nitrogen content of the iron nitride material and the nitrogen implanting atmosphere is desirable and can be finely controlled by the many adjustable parameters discussed.

The use of N₂ and H₂ mixtures instead of pure N₂ may help promote formation of specific, stable phases like γ′—Fe₄N, while also potentially influencing factors like its growth rate potential and film uniformity of traditional processes.

High nitrogen activity is often desirable in the production of nitrogen rich iron mixture at atmospheric pressure or lower pressures.

While these elements and materials may be utilized by the described device, this device may have far greater control regarding nitrogen infusion due to its ability to rapidly cool, quickly freezing the iron nitrogen plasma mixture, as previously stated. The operation can be started in the chamber under increased pressure as well, which tends to favor greater gaseous integration.

The device described also anticipates the desirability of having a second, third, or fourth element which could be incorporated into the material output.

In operation an additional second or more wire, introduced by, such as for example 6315, of the same or different material composition, may be introduced through plasma torch 6311 and enter into arc plasma zone 6314.

As previously disclosed, regarding the operation of torch 6310, another gas supply 6313 introduces gas, gases, or gas containing entrained materials, as described in FIG. 8, which surround the wire 6315. The wire is introduced into the plasma zone 6314 by wire speed controller motor/wheel means 6316 originating from reel 6312, once power supply 6317 and rotating means 6301 have been initiated.

This results in the induction of wire 6303, 6315 into a combined plasma state which are then super cooled and condensed from the plasma state resulting in combined material output from the device, assuming the 2 or more wires are of a different material composition.

Power supply 6317 could provide, DC, pulsed DC, AC or RF output of either polarity to brush means 6307.

Should a DC current be used and if the wire is negative, then approximately 70% of the heat would develop in the rotating element. This is termed DCEN, direct current electrode negative, wire electrode negative. Conversely if the wire is positive, then approximately 70% would develop in the wire and 30% in the rotating means, termed DCEP, direct current electrode positive, or wire electrode positive.

These settings have a potentially significant effect on the operation of the device and its output material. In various embodiments, both conditions could be desirable.

With DCEN, the wire material heats faster while the rotating means stays relatively cooler. Generally, this will promote higher ionic density and mobility in the plasma. It will generally promote a greater percentage of wire material and gaseous content to be introduced into the output material.

By reversing the polarity to DCEP, however, depending on the alloy mixture or molecular composition desirable, this polarity configuration may encourage greater combined material integration depending on the characteristics of the input materials and the nature of the desired output. This lends these devices additional flexibility regarding parameter control and output composition.

Also, by changing the feed rate of wire advancing unit 6316 in relationship with that of 6304, as well as the energy supplied by 6317 to that of 6309, different ratios of the resulting output material can be encouraged.

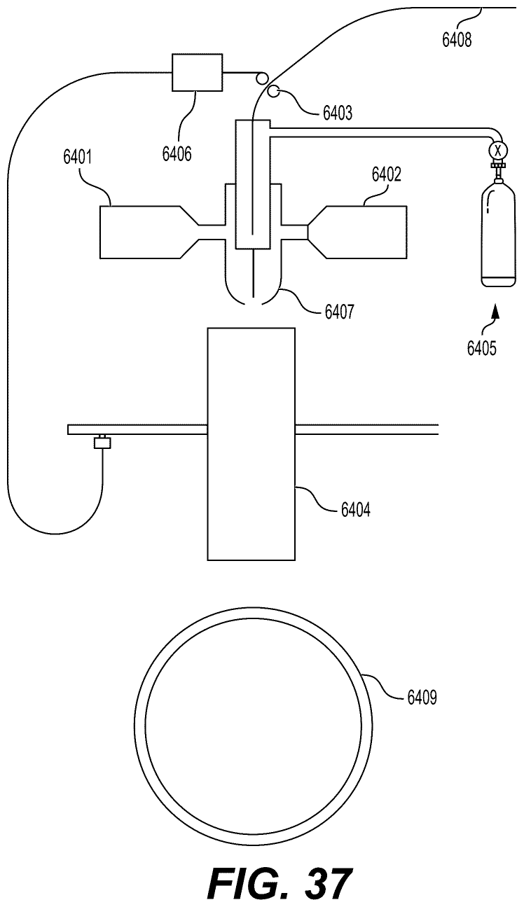

Referring to FIG. 37, a method of changing the position of the contact area of the plasma created in FIG. 36 is illustrated. The method illustrated may be performed in any of the other devices previously shown and could be accomplished in relationship to the surface of the rotating means 6404.

In operation rotating means 6404 is put in motion then gas supply 6405 is open.

Power supply 6406 is energized while wire feeder 6403 advances the wire 6408.

When in close enough proximity to the rotating means 6404 an arc is initiated between the wire 6408 and means 6404 with the resulting material output as discussed in in FIG. 36 and elsewhere.

Transducer means 6401 and 6402 may then alter the impact area of the plasma's contact on 6404 to any area of its surface. This reduces potential damage to beyond just one area to include potentially the complete surface of 6404 reducing damage and limiting material buildup on it surface from the condensing plasma.

Furthermore, this can lead to the potential of depositing patterns in the surface to a removable collar 6409 surrounding 6406. This could also allow for electronic circuits, by non-limiting example, to be deposited by the different materials, alloys and entrained gases created in FIG. 36 and elsewhere in this disclosure. These materials, alloys and gases can extensively in real time be changed and altered in their nature by the processes described in FIG. 36 and throughout this disclosure. The case of semiconducting circuitry could allow for the introduction of dopants and other elements to be introduced on the surface of a potential 6404 substrate.

The illustration in FIG. 37 also provides a side view of FIG. 36, detailing the functionality of linear actuators 6401 and 6402. These actuators are designed to move the head 6407 across the surface of the rotating component 6404. This movement ensures that various areas on the surface are exposed to the electric arc formed between the wire means 6408 and the rotating component 6404, thereby minimizing potential damage to any single spot on the rotating component. Additionally, these linear actuators can operate in a vibration mode, similar to other devices discussed. This vibration, combined with the rotation of cylinder 6404, further prevents surface damage to 6404 and inhibits the adhesion of elements from wire 6408 to the rotating surfaces.

During operation, gas supply 6405 is activated, directing a gas flow around the wire means 6408 and through the nozzle of 6407. This flow impacts and shields the electric arc formation area from contact with other gases. While this process can occur in an open environment, it is typically more practical within a chamber, such as the one shown in FIG. 1, where internal pressures can range from near-vacuum to above atmospheric. Utilizing higher pressure environments generally promotes a greater incorporation of the shield gas into the material supplied by wire means 6408. Pressures exceeding 1,000 bars have been considered, as well as the possibility of this operation taking place with a cryogenic gas in the arc zone.

Once the gas flow is established, the power supply 6406 can be energized, transmitting either AC, DC, or RF between the advancement rollers 6403 and the axle of the rotating component 6404. Upon activation, an arc forms between 6408 and the rotating component, generating plasma that contains elements from both the materials in 6408 and the environmental gases introduced by 6405.

Due to the rotation of 6404 and the linear movements, including possible vibration, created by 6401 and 6402, most of the combined plasma materials condense rapidly and fall into a container, rather than adhering to the rotating component. A significant portion of the resulting material will be an alloy formed between the materials of 6408 and the introduced gases from 6405.

The described device is also capable of creating patterns on a conductive substrate 6409, which is placed on top of the rotating component 6404. For this function, the power supply can be cycled on and off as needed, depending on the desired pattern. This action may create and eliminate the arc formation, allowing for the initiation and termination of a potential deposition line formed on 6409 at any point in its rotation.

The linear actuators 6402 and 6401 can then reposition the deposition head 6407 to lay a pattern in a different area or to connect existing lines. When performing this task, a slower rotational speed may be considered to help ensure that a percentage of the deposition materials remain deposited and adhered to the surface of 6409, instead of falling into the cavity below.

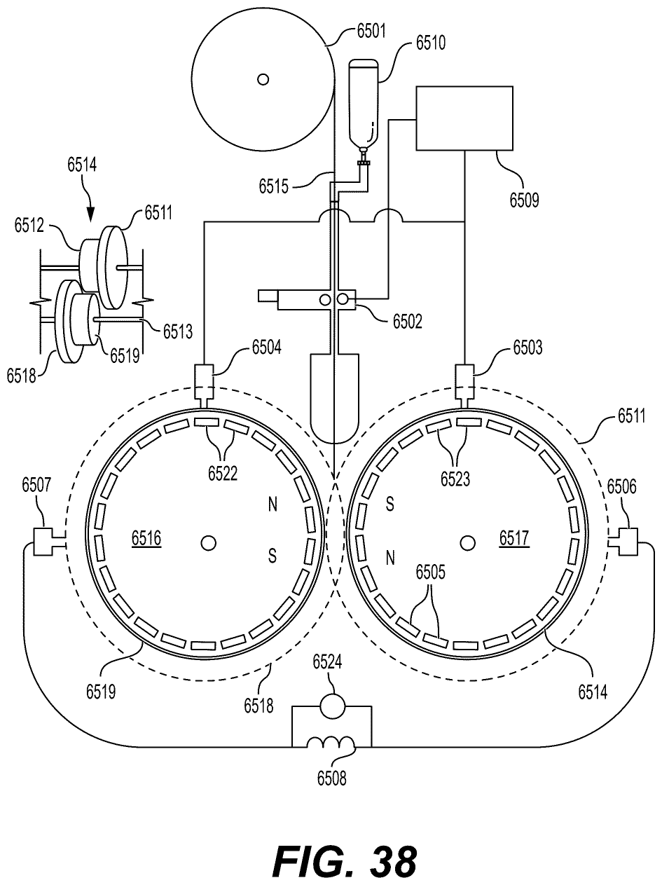

FIG. 38 illustrates an embodiment of the system in FIG. 36 wherein a method that integrates the wire-feed direct arc device (shown in FIGS. 36 and 37) is illustrated with the various magnetohydrodynamic (MHD) devices depicted throughout this document, including FIGS. 2A, 2B, 3, 9A, 9B, 18, and 20. This combined approach allows for the recovery of a portion of the energy needed to create the plasma arc, or, alternatively, it provides a means to introduce additional energy into the arc field.

In operation, gas cylinder 6510 is opened, introducing gas into the area surrounding the wire means 6515. Once this gas field is established and the rotating assemblies 6516 and 6517 are put in motion, the power supply 6509 can be energized. This creates an electrical contact with the wire via wire advancement means 6502. This action brings the wire end into close contact between the rotating surfaces 6512 and 6519, where the energized wire means is able to create an arc between the wire and surfaces 6519 and 6512. The arc creates a plasma consisting of the surrounding gas and material from the wire means. This commingling is enhanced by the potential high frequency vibratory motion introduced by the transducers.

In this plasma state, the ions and electrons are either attracted or repelled perpendicular to flange assemblies 6511 and 6518 due to the opposing polar magnetic fields generated by magnetic assemblies 6522 and 6523. These electrical charges are then conveyed to flanges 6511 and 6518 through brush assemblies 6506 and 6507, where recovered electrical energy can perform useful work via 6508. Alternatively, if additional energy is required to intensify the plasma, a power supply 6524 can introduce electrical energy through the same means, thereby intensifying the plasma. It may also be desirable to have electrical insulators 6514 and 6519 located between the flange and the conductive rotating magnetic elements 6522 and 6523.

Once these conditions are met and an arc is formed, it can be sustained by continuously metering additional wire material from spool 6501 using wire feed 6502. The rapid cooling effects on the plasma, caused by direct energy removal through the MHD process and physical contact with the rotating means 6516 and 6517, result in rapid cooling of the plasma. This causes the now condensed material to not be able to outgas extensively and promote the introduced elements remaining in a commingled state with the wire material, both of which were previously in a plasma state. This material, in solid form, then drops to the bottom of the chamber where the assembly is located, from which it can be removed for further use or processing.

Similar methods are described in FIG. 8, where it has been considered that this commingled material can consist of many different elements. Likewise, as shown in FIG. 37, two or more wires can be combined into a common plasma, creating the potential for forming other alloys in the MHD device of FIG. 38. Among the many materials considered in FIG. 8, iron nitride magnetic materials, including Fe₁₆N₂, can be rapidly and efficiently created by these devices. This material has the potential to create magnetic fields ten times stronger than existing rare-earth magnets, and it can maintain magnetic field strength at temperatures far exceeding those of existing magnets.

Tetrataenite is a naturally occurring iron-nickel alloy with a unique crystal structure found primarily in meteorites. It is characterized by its ordered structure of iron (Fe) and nickel (Ni) atoms, with an approximate equi-atomic composition of FeNi. While traditionally found in meteorites due to slow cooling, recent research has explored methods of creating it on Earth using iron-nickel alloys with phosphorus. Tetrataenite is essentially an ordered Fe—Ni alloy, meaning the iron and nickel atoms are arranged in a specific non-random pattern within its crystal structure. It has a tetragonal crystal structure which is a distortion of the face-centered cubic (fcc) structure of taenite (another Fe—Ni mineral). This ordered structure is crucial for its magnetic properties.

Tetrataenite is both a rare and powerful magnetic material that forms in meteorites during their very slow cooling process, taking thousands or even millions of years to develop its ordered structure in the vacuum of outer space.

Recent research has demonstrated the possibility of creating tetrataenite on Earth by adding phosphorus (and sometimes carbon) to an iron-nickel alloy during casting, significantly accelerating the formation process. Tetrataenite ordered structure gives it exceptional magnetic properties, particularly high magnetic hardness (resistance to demagnetization changes). This makes it a potential candidate for high-performance permanent magnets. This material can be produced by the device shown in FIG. 36 by installing an iron wire in spool 6302 and a nickel wire in 6312. When both elements advance into the arc/plasma zone over the rotating conductor 6301 this can result in the production of Tetrataenite as an alloy in the plasma zone formed between the two wires. It is also possible with this method to introduce nitrogen, as has previously been discussed, for iron nitride materials into the resulting alloy. Normally this material is produced in a 50/50 ratio of iron and nickel, but this process allows different percentages to be easily formed, as well as the incorporation of phosphorus introduced in the form of phosphine gas from either cylinder 6313 or 6305 which has been shown to promote development of this material.

While the primary components are iron and nickel, other elements like cobalt, copper, and phosphorus can be present as impurities in tetrataenite and may have important contributions to its magnetic properties and has been shown to assist in its terrestrial production.

It is to be understood that the system for plasma dissociation of hydrocarbons is not limited to the specific embodiments described above, but encompasses any and all embodiments within the scope of the generic language of the following claims enabled by the embodiments described herein, or otherwise shown in the drawings or described above in terms sufficient to enable one of ordinary skill in the art to make and use the claimed subject matter.

1. A system for plasma dissociation of hydrocarbons, comprising:
a chamber having a plasma inlet;
a plasma source for projecting a plasma through the plasma inlet into an interior of the chamber;
a rotating member mounted in the interior of the chamber; and
means for driving rotation of the rotating member such that the plasma impinges on a surface of the rotating member while the rotating member is rotating to form a solid material,
whereby the solid material falls from the rotating member while it is rotating and is collected on an interior floor surface of the chamber.

2. The system for plasma dissociation of hydrocarbons as recited in claim 1, further comprising a source of a hydrocarbon gas in communication with the plasma source, the plasma being formed from the hydrocarbon gas, wherein the solid material is a carbon-containing material.

3. The system for plasma dissociation of hydrocarbons as recited in claim 2, further comprising a source of a carrier gas in communication with the plasma source, the carrier gas mixing with the hydrocarbon gas.

4. The system for plasma dissociation of hydrocarbons as recited in claim 1, wherein the chamber has a gas outlet formed therethrough for retrieval of gaseous products following formation of the solid material from the plasma.

5. The system for plasma dissociation of hydrocarbons as recited in claim 1, wherein the rotating member is hollow.

6. The system for plasma dissociation of hydrocarbons as recited in claim 5, wherein the rotating member is coupled to at least one hollow axle, the at least one hollow axle being in fluid communication with an interior of the rotating member such that a heat exchange fluid selectively flows through the at least one hollow axle and the rotating member.

7. A system for plasma dissociation of hydrocarbons, comprising:
a chamber having a plasma inlet;
a plasma source for projecting a plasma through the plasma inlet into an interior of the chamber;
first and second rotating members mounted in the interior of the chamber such that the plasma is projected in a region between respective surfaces of the first and second rotating members, wherein the first and second rotating members are spaced apart from one another along a first direction, and wherein the plasma is projected there between along a second direction which is perpendicular to the first direction;
means for generating a magnetic field in the region between the respective surfaces of the first and second rotating members, wherein the magnetic field is aligned along a third direction which is perpendicular to the first and second directions;
means for driving rotation of the first and second rotating members such that positive ions of the plasma impinge on the surface of the first rotating member while the first rotating member is rotating to form a solid material, and such that electrons of the plasma impinge on the surface of the second rotating member,
whereby the solid material falls from the first rotating member while it is rotating and is collected on an interior floor surface of the chamber.

8. The system for plasma dissociation of hydrocarbons as recited in claim 7, further comprising a source of a hydrocarbon gas in communication with the plasma source, the plasma being formed from the hydrocarbon gas, wherein the solid material is a carbon-containing material.

9. The system for plasma dissociation of hydrocarbons as recited in claim 8, further comprising a source of a carrier gas in communication with the plasma source, the carrier gas mixing with the hydrocarbon gas.

10. The system for plasma dissociation of hydrocarbons as recited in claim 7, wherein the chamber has a gas outlet formed therethrough for retrieval of gaseous products following formation of the solid material from the plasma.

11. The system for plasma dissociation of hydrocarbons as recited in claim 7, wherein the first and second rotating members are each electrically connected to an electrical load.

12. A method of removing carbon from a material using the system of claim 1, the method comprising:
closing all valves of the chamber;
turning on a vacuum pump and opening a valve to the vacuum pump to begin evacuation of the chamber;
closing the valve to the vacuum pump after the chamber is fully evacuated;
adding a first material into the chamber of the system;
energizing the motor to spin the rotating member;
energizing the plasma inlet;
adding working gases into the plasma inlet using a mixing valve;
generating high temperature plasma from the material;
contacting the rotating member with the high temperature plasma, wherein the high temperature plasmas is cooled on impact with the rotating member; and
obtaining a solid and a gas, wherein the solid falls to a bottom of the chamber and the gas rises to the top of the chamber.

13. The method of claim 12, further comprising combining the carbon from the materials with additional materials.

14. The method of claim 13, wherein the additional materials are selected from a group consisting of metals, elements, hydrocarbons, and gas.

15. The method of claim 14, wherein the gas is selected from a group consisting of an inert gas and a reactive gas.

16. The method of claim 15, wherein the inert gas is selected from a group consisting of argon and nitrogen.

17. The method of claim 15, wherein the reactive gas is hydrogen.

18. The method of claim 12, wherein the gas is ammonia gas.

19. The method of claim 12, wherein the solid is iron nitride.

20. A method of manufacturing iron nitride using the system of claim 7, the method comprising:
closing all valves of the chamber;
turning on a vacuum pump and opening the valve to the vacuum pump to begin evacuation of the chamber;
closing the valve to the vacuum pump after the chamber is fully evacuated;
adding a feed gas into the chamber of the system;
energizing the motors of each of the first rotating member and second rotating member to spin the first and second rotating members;
generating a magnetic field between each of the first rotating member and the second rotating member;
energizing the plasma inlet;
adding working gases into the plasma inlet using the mixing valve;
generating high temperature plasma from the working gases;
contacting the first rotating member with the high temperature plasma, wherein the high temperature plasmas is cooled on impact with the first rotating member; and
obtaining a solid and a gas, wherein the solid falls to a bottom of the chamber and the gas rises to the top of the chamber.
